(19) United States
(12) Patent Application Publication
(10) Pub. No.: US 2010/0051546 A1
(43) Pub. Date: Mar. 4, 2010

(54) WATER TREATMENT SYSTEMS AND METHODS

(75) Inventors: Diem Xuan Vuong, San Clemente, CA (US); Michael Motherway, Tustin, CA (US); Curtis Roth, Tustin, CA (US); Tom Pankratz, League City, TX (US)

Correspondence Address: KNOBBE MARTENS OLSON & BEAR LLP, 2040 MAIN STREET, FOURTEENTH FLOOR, IRVINE, CA, 92614, US

(73) Assignee: DXV Water Technologies, LLC, Tustin, CA (US)

(21) Appl. No.: 12/497,598

(22) Filed: Jul. 3, 2009

Related U.S. Application Data
(60) Provisional application No. 61/083,880, filed on Jul. 25, 2008.
(60) Provisional application No. 61/083,447, filed on Jul. 24, 2008.
(60) Provisional application No. 61/078,282, filed on Jul. 3, 2008.
(60) Provisional application No. 61/089,858, filed on Aug. 18, 2008.

(51) Int. Cl. C02F 1/44; C02F 1/00

(52) U.S. Cl. 210/637; 210/170.05; 210/124

(57) ABSTRACT

A water treatment and conveyance system includes a plurality of substantially planar membrane elements arranged in a stack. Adjacent membrane elements in the stack are spaced apart from one another by element spacers. The element spacers have one or more openings that are in fluid communication with the permeate sides of adjacent membrane elements. The openings are sealed off from the source water sides of the membrane elements by one or more sealing members. The openings in the element spacers cooperate to define a conduit for the filtered permeate. Methods for treating water and conveying treated water are also provided.

### CROSS-REFERENCE TO RELATED APPLICATIONS

This application claims the benefit under 35 U.S.C. §119(e) of U.S. Provisional Application No. 61/089,858, filed Aug. 18, 2008 and entitled WATER TREATMENT APPARATUS; U.S. Provisional Application No. 61/083,880, filed Jul. 25, 2008 and entitled FILTRATION SYSTEM; U.S. Provisional Application No. 61/083,447, filed Jul. 24, 2008 and entitled WATER TREATMENT APPARATUS; and U.S. Provisional Application No. 61/078,282, filed Jul. 3, 2008 and entitled MOBILE FILTRATION SYSTEM. The disclosures of each of the above-referenced applications are hereby expressly incorporated by reference in their entireties.

### FIELD OF THE INVENTION

Systems and methods for removing salts, sulfates, and other unwanted constituents from seawater, and for the purification of surface and groundwater, are provided. The systems utilize the hydrostatic pressure of a natural or induced water column to filter water through a reverse osmosis, nanofiltration or other membrane, whereby a certain desired water quality is obtained.

### BACKGROUND OF THE INVENTION

More than 97% of water on earth is seawater; three fourths of the remaining water is locked in glacier ice; and less than 1% is in aquifers, lakes and rivers that can be used for agriculture, industrial, sanitary and human consumption. As water in aquifers, lakes and rivers is a renewable resource, this small fraction of the Earth's water is continually re-used. It is the rate of this reuse that has stressed conventional water resources.

In the last century, these water sources became stressed as growing population and pollution limited the availability of easy-to-access freshwater. Recently localized water shortages required the development of desalination plants which make potable water from salty ocean water. The conventional desalination process includes three major steps: pre-treatment; desalination; and post-treatment. In the pre-treatment step, seawater is brought from the ocean to the site of desalination, and then conditioned according to the desalination process to be employed. Water is typically taken from shallow, near-shore areas that contain suspended (e.g., organic or inorganic) material that must be filtered out prior to the desalting process. In the desalination step, a method such as Multistage Flash Distillation (MSF), Multi-effect Distillation (MED), Electro Dialysis (ED), or Reverse Osmosis (RO) is employed to remove salts from the water. The desalination processes typically require substantial amounts of energy in various forms (e.g., mechanical, electrical, etc.), and the disposal of the concentrated brine generated by the process can be a significant environmental concern. In the post-treatment step, product water of the desalination process is conditioned according to its ultimate use.

Reverse Osmosis is a membrane process that acts as a molecular filter to remove 95 to 99% of dissolved salts and inorganic molecules, as well as organic molecules. Osmosis is the natural process which occurs when water or another solvent spontaneously flows from a less-concentrated solution, through a semi-permeable membrane, and into a more concentrated solution. In Reverse Osmosis the natural osmotic forces are overcome by applying an external pressure to the concentrated solution (feed). Thus the flow of water is reversed and desalinated water (permeate) is removed from the feed solution, leaving a more concentrated salt solution (brine). Product water quality can be further improved by adding a second pass of membranes, whereby product water from the first pass is fed to the second pass. In a reverse osmosis process as is typically commercially employed, pretreated seawater is pressurized to between 850 and 1,200 pounds per square inch (psi) (5,861 to 8,274 kPa) in a vessel housing, e.g., a spiral-wound reverse osmosis membrane. Seawater contacts a first surface of the membrane, and through application of pressure, potable water penetrates the membrane and is collected at the opposite side. The concentrated brine generated in the process, having a salt concentration up to about twice that of seawater, is disposed back into the ocean.

### SUMMARY OF THE INVENTION

In a first aspect, a water treatment and conveyance system is provided. The system comprises a plurality of substantially planar membrane elements, each membrane element extending generally in a first direction, the plurality of membrane elements generally aligned in a second direction normal to the first direction, each membrane element having a source water side and a permeate side, the source water side configured to be submerged to a depth in a body of water to be treated and exposed to a hydrostatic pressure characteristic of the body of water at the submerged depth, the permeate side configured to be exposed to atmospheric pressure when the source water side is submerged; a plurality of element spacers, the element spacers being generally aligned with one another, each element spacer configured to maintain a spacing between a pair of adjacent membrane elements, each element spacer having a first opening in fluid communication with the permeate sides of the adjacent membrane elements, wherein the plurality of element spacers defines a permeate conduit; and a plurality of sealing members, each sealing member configured to seal the first openings of the element spacers from the source water sides of the adjacent membrane elements. In an embodiment of the first aspect, each membrane element comprises a pair of substantially planar membranes and a permeate spacer disposed between the membranes. In an embodiment of the first aspect, the permeate conduit extends generally in the second direction. In an embodiment of the first aspect, the permeate conduit extends through the plurality of membrane elements. In an embodiment of the first aspect, the permeate conduit is spaced apart from the plurality of membrane elements. In an embodiment of the first aspect, the system further comprises a compression member configured to maintain the sealing members in a compressed state. In an embodiment of the first aspect, the compression member comprises at least one rod extending in the second direction. In an embodiment of the first aspect, the rod extends through the plurality of element spacers. In an embodiment of the first aspect, the rod is spaced apart from the permeate conduit. In an embodiment of the first aspect, the compression member comprises an epoxy. In an embodiment of the first aspect, the system further comprises a collection tube extending through the permeate conduit, wherein the collection tube is configured to receive and convey permeate. In an embodiment of the first aspect, the collection tube comprises a plurality of openings configured to receive permeate from the permeate conduit. In an embodiment of the first aspect, the openings are slits. In an embodiment of the first aspect, the openings are holes. In an embodiment of the first aspect, the collection tube is configured to apply a compressive force to the plurality of element spacers. In an embodiment of the first aspect, the collection tube has at least one threaded region. In an embodiment of the first aspect, the system further comprises a nut configured to cooperate with the threaded region of the collection tube to apply a compressive force to the plurality of element spacers. In an embodiment of the first aspect, each of the element spacers includes at least one abutment configured to maintain a minimal spacing from an adjacent element spacer.

In a second aspect, a water treatment system is provided. The system comprises means for filtering source water to produce product water, the filtering means having a source water side and a product water side, the filtering means comprising a series of substantially planar membrane elements arranged in parallel. The system also comprises means for maintaining a spacing between adjacent membrane elements, wherein at least a first portion of the spacing means is configured for exposure to the source water side, and wherein at least a second portion of the spacing means is configured for exposure to the product water side. The system further comprises means for conveying product water, the conveying means extending through the filtering means in a direction normal to the membrane elements. In an embodiment of the second aspect, the spacing means defines the conveying means.

In a third aspect, a method of treating and conveying water is provided. The method comprises providing the water treatment and conveyance system according to the first aspect, submerging the water treatment and conveyance system in the body of water to the submerged depth, and conveying permeate through the permeate conduit.

In a fourth aspect, a method of manufacturing the water treatment and conveyance system according to the first aspect is provided. The method comprises providing a first membrane element, positioning a first element spacer on the first membrane element with the first opening of the first element spacer in fluid communication with the permeate side of the first membrane element, positioning a second membrane element on the first element spacer in general alignment with the first membrane element, with the first opening of the first element spacer in fluid communication with the permeate side of the second membrane element, and positioning a second element spacer on the second membrane element in general alignment with the first element spacer with the first opening of the second element spacer in fluid communication with the permeate side of the second membrane element.

In a fifth aspect, a method for producing product water from a sulfate-containing body of water is provided. The method comprises submerging a first membrane module to a submerged depth in a sulfate-containing body of water, the first membrane module comprising a plurality of substantially planar polyamide nanofiltration membrane elements, each membrane element extending generally vertically and having a first side and a second side, the first sides of two adjacent membrane elements being sufficiently spaced apart to prevent surface tension from inhibiting substantially free flow of feed water between the elements, the second sides being in fluid communication with a collector, wherein the first sides are exposed to the source water at a first pressure characteristic of the submerged depth. The method also comprises exposing the collector to a second pressure, wherein the second pressure is sufficient to induce permeate to cross from the first side to the second side without requiring a mechanical device to influence the first pressure, and collecting permeate of a reduced sulfate concentration in the collector. In an embodiment of the fourth aspect, the second pressure is characteristic of atmospheric pressure at a surface of the body of water or at an elevation higher than the surface of the body of water. In an embodiment of the fourth aspect, each membrane element comprises a pair of substantially planar polyamide nanofiltration membranes spaced apart by a permeate spacer. In an embodiment of the fourth aspect, the first membrane module is configured to be submerged to a depth of from about 100 feet to about 400 feet. In an embodiment of the fourth aspect, the first membrane module is configured to be submerged to a depth of from about 650 feet to about 900 feet. In an embodiment of the fourth aspect, the method further comprises passing the permeate of a reduced sulfate concentration through a second membrane module, the second membrane module comprising at least one nanofiltration membrane module. In an embodiment of the fourth aspect, the method further comprises passing the permeate of a reduced sulfate concentration through a second membrane module, the second membrane module comprising at least one reverse osmosis membrane module. In an embodiment of the fourth aspect, the body of water is a body of saltwater. In an embodiment of the fourth aspect, the body of water is a body of brackish water. In an embodiment of the fourth aspect, the method further comprises conveying the permeate of a reduced sulfate concentration to an injection system of an offshore oil production system.

In a sixth aspect, a mobile filtration system includes a pressure vessel for holding water to be treated, and a plurality of substantially planar and generally parallel membrane units disposed inside the pressure vessel, each membrane unit having a raw water side and a permeate side, the membrane units being spaced apart from one another by a distance sufficient to allow substantially free flow of water between the membrane units, wherein the permeate side is configured for exposure to atmospheric pressure, and wherein the raw water side is configured for exposure to a vessel pressure sufficient to drive a filtration process from the raw water side to the permeate side. In an embodiment of the fifth aspect, the vessel pressure is from about 20 psi to about 100 psi.

### BRIEF DESCRIPTION OF THE DRAWINGS

FIG. 1 provides a diagram (not to scale) of a water treatment module tethered to the floor of a body of water.

FIG. 2 provides a diagram (not to scale) of a water treatment module adapted for use in temporary installations.

FIG. 3 provides a diagram (not to scale) of a water purification module suspended from a floating platform.

FIG. 4 provides a diagram (not to scale) of a water purification module adapted for use with large-scale applications or for those users desiring more access to the membrane modules.

FIG. 5 provides a plan view (not to scale) of a water purification membrane module utilizing vertically aligned membranes in a box configuration.

FIG. 6 depicts the component layers of a spiral-wound element in a conventional reverse osmosis membrane module, prior to being rolled.

FIGS. 7A and 7B shows a cutaway view of a reverse osmosis membrane module having twelve layers of membrane wrapped around a permeate tube.

FIG. 8 shows a cross section of a membrane element from a conventional reverse osmosis unit (prior to being rolled).

FIG. 9A shows a perspective view (not to scale) of a membrane cartridge according to an embodiment.

FIGS. 9B through 9H illustrate steps in a process for making a membrane cartridge.

FIG. 10 depicts schematically the process of reverse osmosis filtration and the natural downward motion of generated brine.

FIGS. 11A through 11C schematically depict various systems for transporting water collected offshore to shore.

FIG. 12 shows a basic diagram (not to scale) of a DEMWAX™ water filtration membrane cartridge in cross section, illustrating saltwater spacers and shown with the permeate side of the membrane elements in fluid communication with a collection system. The saltwater spacers are plastic ‘balls’ arrayed in a checkerboard pattern and connected with strong plastic fibers. The spacers obviate the need for a lattice box to separate the membranes.

FIG. 13 depicts corrugated woven plastic fibers suitable for use as saltwater or source water spacers.

FIG. 14 shows a basic diagram (not to scale) of a permeate water collector channel for use with the DEMWAX™ water treatment systems disclosed herein.

FIG. 15A shows a basic diagram (not to scale) of a module with multiple cartridges containing multiple membrane elements and a collector channel for use with the DEMWAX™ water treatment systems disclosed herein.

FIG. 15B shows a basic diagram (not to scale) of a module with multiple cartridges containing multiple membrane elements and a collector channel for use with the DEMWAX™ water treatment systems disclosed herein.

FIG. 15C shows a basic diagram (not to scale) of an exemplary DEMWAX™ water treatment module with multiple cartridges containing multiple membrane elements fluidly connected to a collection system.

FIG. 16 shows a side view of a collection frame with the placement of membrane cartridges illustrated in dashed lines.

FIG. 17A shows a cutaway perspective view (not to scale) of a membrane module with a membrane cartridge and a portion of the collection system removed to better illustrate portions of the collection system.

FIG. 17B shows a perspective view (not to scale) of a membrane module with a collection framework supporting four sets of cartridges.

FIG. 18 shows a basic diagram (not to scale) depicting a top view of a DEMWAX™ water filtration plant, showing submerged membrane modules suspended from an offshore platform.

FIG. 19 shows a basic diagram (not to scale) depicting a top view of submerged DEMWAX™ water filtration modules in an array suspended from a platform and arranged in parallel and serial configurations.

FIG. 20 shows a plan view of a plant with multiple arrays of DEMWAX™ water filtration modules.

FIG. 21 shows a side view of a buoy array system of DEMWAX™ water filtration modules.

FIG. 22 provides a diagram of a DEMWAX™ water filtration cartridge adapted for use with groundwater applications.

FIGS. 23A and 23B illustrate a cylindrical DEMWAX™ water filtration cartridge.

FIGS. 24A and 24B illustrate a cylindrical DEMWAX™ water filtration cartridge.

FIG. 25 is a perspective view of a membrane cartridge with an attached rigid frame, according to an embodiment.

FIG. 26 is a side view of a membrane cartridge attached to a collection channel, according to an embodiment.

FIG. 27 is a perspective view of a collector element, according to an embodiment.

FIG. 28 is a cutaway top view of a water filtration cartridge and center channel, according to an embodiment.

FIG. 29 is a cutaway top view of a water filtration cartridge and center channel, according to an embodiment.

FIG. 30 is a cutaway top view of a water filtration cartridge and center channel, according to an embodiment.

FIG. 31 is a perspective diagram illustrating an arrangement of membrane elements having permeate conduits extending through the elements.

FIG. 32A is a cross-sectional view illustrating another arrangement of membrane elements having permeate conduits extending through the elements.

FIG. 32B is a close-up view better illustrating a portion of FIG. 32A.

FIG. 33 is a perspective diagram illustrating another arrangement of membrane elements with permeate conduit assemblies attached to a stack of membrane elements.

FIG. 34 is a cross-sectional diagram of a bundle of umbilicals, according to an embodiment.

FIG. 35 is an exploded perspective view of an exemplary disassembled membrane element.

FIG. 36 is a top view of one embodiment of a membrane cartridge.

FIG. 37 is a perspective view of a collecting tube with an attached membrane element.

FIG. 38 is a top-view of one embodiment of a collecting tube and a membrane element.

FIG. 39 is a perspective view of one embodiment of a membrane cartridge.

FIG. 40 is a top view of one embodiment of a membrane cartridge.

FIG. 41A shows a top view of an exemplary membrane cartridge.

FIGS. 41B and 41C show top views of various embodiments of membrane modules.

FIG. 42A is a top view of one embodiment of a membrane cartridge.

FIG. 42B is a top view of an exemplary membrane module.

FIG. 42C is a top view of a portion of an exemplary membrane cartridge.

FIG. 43A is a top view of an exemplary membrane cartridge.

FIG. 43B is a top view of an exemplary membrane module.

FIG. 43C is a top view of a portion of an exemplary membrane cartridge.

FIG. 44A is a perspective view of an exemplary collection tube.

FIG. 44B is a perspective view of an exemplary collection tube.

FIG. 45 is a schematic diagram illustrating a mobile treatment system according to a preferred embodiment.

FIG. 46 is a schematic diagram better illustrating the configuration of membrane units in the embodiment shown in FIG. 45.

FIG. 47A is a schematic diagram illustrating an alternative configuration of membrane units in a pressure vessel, according to another embodiment.

FIG. 47B is a diagram illustrating membrane units woven around supports and attached to collection tubes, according to an embodiment.

FIG. 47C is a diagram illustrating a membrane unit attached to a collection tube.

FIG. 48 is a schematic diagram illustrating a filtration system according to a further embodiment.

FIG. 49 is a perspective diagram illustrating an arrangement of membrane elements with gasketed spacers including a tee shaped top for hanging the elements on a frame, according to a further embodiment.

FIG. 50 is a perspective diagram illustrating a cartridge of multiple membrane elements supported on a frame, according to a still further embodiment.

FIG. 51A is a plan view of a gasketed spacer, configured in accordance with an embodiment.

FIG. 51B is a cross-sectional view of the gasketed spacer of FIG. 51A, taken through line B-B.

FIG. 51C is a cross-sectional view of the gasketed spacer of FIG. 51A, taken through line C-C.

FIG. 52 is a plan view of a membrane element, configured in accordance with an embodiment and shown with the gasketed spacer of FIG. 51 positioned on the element.

FIG. 53 is a top view of a membrane cartridge comprising a series of membrane elements spaced apart by gasketed spacers, in accordance with an embodiment.

FIG. 54 is a perspective view of the membrane cartridge illustrated in FIG. 53.

FIG. 55A is a plan view of a gasketed spacer, configured in accordance with an embodiment.

FIG. 55B is a side of the gasketed spacer of FIG. 55A.

FIG. 55C is a perspective view of the gasketed spacer of FIG. 55A.

### DETAILED DESCRIPTION OF THE PREFERRED EMBODIMENT

The following description and examples illustrate preferred embodiments of the present invention in detail. Those of skill in the art will recognize that there are numerous variations and modifications of this invention that are encompassed by its scope. Accordingly, the description of a preferred embodiment should not be deemed to limit the scope of the present invention.

Conventional reverse osmosis desalination plants expose reverse osmosis membranes to high-pressure saltwater. This pressure forces water through the membrane while preventing (or impeding) passage of ions, selected molecules, and particulates therethrough. Desalination processes are typically operated at a high pressure, and thus have a high energy demand. Various desalination systems are described in U.S. Pat. Nos. 3,060,119 (Carpenter); 3,456,802 (Cole); 4,770,775 (Lopez); 5,229,005 (Fok); 5,366,635 (Watkins); and 6,656,352 (Bosley); and U.S. Patent Application No. 2004/0108272 (Bosley); the disclosures of each of which are hereby incorporated by reference in their entireties.

Systems are provided for treating water, e.g., purifying, filtering and/or desalinating water. The systems involve exposure of one or more membranes, such as nanofiltration (NF) or reverse osmosis (RO) membranes, to the hydrostatic pressure of a natural or induced water column, for example, high-pressure water in the depths of the sea. The membrane is submerged to a depth where the pressure is sufficient to overcome the sum of the osmotic pressure of the feed water (or raw water) that exists on the first side of the membrane and the transmembrane pressure loss of the membrane itself. For seawater or other water containing higher amounts of dissolved salts, transmembrane pressure losses are typically much smaller than the osmotic pressure. Thus, in some applications, osmotic pressure is a more significant driver than transmembrane pressure losses in determining the required pressure (and thus, the required depth). In treatment of fresh surface water or water containing lower amounts of dissolved salts, osmotic pressures tend to be lower, and the transmembrane pressure losses become a more significant factor in determining the required pressure (and thus, the required depth). Typically, systems adapted for desalinating seawater require greater pressures, and thus greater depths, than do systems for treating freshwater.

The systems of preferred embodiments utilize membrane modules of various configurations. In a preferred configuration, the membrane module employs a membrane system wherein two parallel membrane sheets are held apart by permeate spacers, and wherein the volume between the membrane sheets is enclosed. Permeate water passes through the membranes and into the enclosed volume, where it is collected. Particularly preferred embodiments employ rigid separators to maintain spacing between the membranes on the low pressure (permeate) side; however, any suitable permeate spacer configuration (e.g., spacers having some degree of flexibility or deformability) can be employed which is capable of maintaining a separation of the two membrane sheets. The spacers can have any suitable shape, form, or structure capable of maintaining a separation between membrane sheets, e.g., square, rectangular, or polygonal cross section (solid or at least partially hollow), circular cross section, I-beams, and the like. Spacers can be employed to maintain a separation between membrane sheets in the space in which permeate is collected (permeate spacers), and spacers can maintain a separation between membrane sheets in the area exposed to raw or untreated water (e.g., raw water spacers). Alternatively, configurations can be employed that do not utilize raw water spacers. Instead, separation is provided by the structure (for example, by structure applying tension to membranes) that holds the membranes in place, e.g., the supporting frame. Separation can also be provided by, e.g., a series of spaced expanded plastic media (e.g., spheres), corrugated woven plastic fibers, porous monoliths, nonwoven fibrous sheets, or the like. Similarly, the spacer can be fabricated from any suitable material. Suitable materials can include rigid polymers, ceramics, stainless steel, composites, polymer coated metal, and the like. As discussed above, spacers or other structures providing spacing are employed within the space between the two membrane surfaces where permeate is collected (e.g., permeate spacers), or between membrane surfaces exposed to raw water (e.g., raw water spacers).

Alternatively, one or more spiral-wound membrane units can be employed in a loosely rolled configuration wherein gravity or water currents can move higher density concentrate through the configuration and away from the membrane surfaces. The membrane elements can alternatively be arrayed in various other configurations (planar, spiral, curved, corrugated, etc.) which maximize surface exposure and minimize space requirements. In a preferred configuration, these elements are arrayed vertically, spaced slightly, and are lowered to depth. In seawater applications, the hydrostatic pressure of the ocean forces water through the membrane, and a gathering system collects the treated water and pumps it to the surface, to shore, or to any other desired location. If a spiral-wound configuration is employed, the membranes are preferably spaced farther apart than in a conventional reverse osmosis system, e.g., about 0.25 inches or more (about 6 millimeters or more), and the configuration is preferably in an “open” module (that is, configured to expose the membranes directly to the ambient source water and allow substantially uninhibited flow of source water past the membranes). Such a configuration facilitates the flow of feed water past the membranes, and especially facilitates the ability of gravity to draw down the higher density concentrate generated at the surface of the membrane by the filtration process. While an open configuration is typically preferred, in certain embodiments a configuration other than an open configuration can be desirable.

The systems of preferred embodiments offer the advantage of eliminating the need to pressurize the feed or raw water by lowering the membranes into seawater at depths of from about 194 meters to about 307 meters or more. Conventional land-based reverse osmosis processes typically require tremendous amounts of energy to generate this pressure. Preferably, the depth employed in the systems of preferred embodiments using reverse osmosis membranes is from about 247 meters to about 274 meters, when it is desired to produce potable water from seawater of average salinity (e.g., water from the Pacific Ocean having a salinity of about 35,000 mg/liter); most preferably the depth is about 259 meters. Of course, systems using reverse osmosis membranes can also be deployed at shallower depths. If reduced salinity water (e.g., brackish water suitable for irrigation, industrial cooling use, or the like) is desired, the preferred depth for systems using nanofiltration membranes is from about 113 meters to about 247 meters or more. Preferably, the depth is from about 152 meters to about 213 meters to produce brackish water from seawater of average salinity (e.g., water from the Pacific Ocean having a salinity of about 35,000 ppm or mg/L). Of course, systems using nanofiltration membranes can also be deployed at greater depths than 213 meters; such systems can be deployed at the same depths as those employing reverse osmosis membranes.

The preferred depth can depend on a variety of factors, including but not limited to membrane chemistry, membrane spacing, ambient currents, salinity of the seawater (or dissolved ion content of the feed water), salinity of the permeate (or dissolved ion content of the permeate), and the like. At depth, the seawater in contact with the membranes is naturally at a continual high pressure. Other advantages of the systems of preferred embodiments are that they do not require high pressure pipes, water intake systems, water pre-treatment systems, or brine disposal systems. The systems of preferred embodiments can also be deployed at even shallower depths. For example, embodiments can be deployed in shallow ocean waters for use in desalination pretreatment systems or ocean water intake systems. Having no high-velocity intake, such systems advantageously avoid harming sea life. Selected systems of preferred embodiments are preferably configured such that saltwater does not come into contact with any interior metallic components, dramatically mitigating the corrosive effects of selected dissolved ions that affect conventional reverse osmosis systems. The systems are preferably configured to be employed in the open ocean, thus not requiring significant land area near the shore as in conventional land-based reverse osmosis systems. While it is generally preferred to operate the systems of preferred embodiments at depths of 247 meters to about 274 meters, systems can advantageously be configured for operation at shallower depths. For example, systems including microfiltration, ultrafiltration, or nanofiltration membranes can be positioned in surface waters and reservoirs at much shallower depths and configured to filter out bacteria, viruses, organics, and inorganics from a freshwater source. Most preferably, surface water treatment systems employ nanofiltration membranes. The membranes of such systems can be positioned at a depth of about 6 meters to 61 meters, or at any other appropriate depth, depending upon the total dissolved solids to be removed, the desired intake velocity, and the desired quality of the product water. Systems including microfiltration, ultrafiltration, or reverse osmosis membranes can also be adapted to produce purified water from a contaminated water supply and can be configured for placement in ground wells.

The membrane modules of certain preferred embodiments are employed to separate unwanted constituents from the feed water and transfer the product water thus generated to an underwater collection system including a pump. This collection system can act as a tank holding enough permeate to buffer the variability of membrane production and pump speed. The pumps can be of any suitable form, including submersible pumps, dry well pumps, or the like. The collection system is connected to at least two pipes, tubes, passageways or other flow directing means, one through which permeate water is directed to the surface, shore, or other desire location; and one of which isolates (or protects) the membranes from the pump operation (e.g., a ‘breathing tube’). The pressure surge in the system caused by turning the pump on or off can be relieved by the breathing tube emptying or filling rather than by suddenly increasing or decreasing the pressure differential across the membranes. Without a breathing tube, the stress on the membrane unit due to pump cycling (e.g., for system maintenance) can decrease membrane life or cause other mechanical wear. While it is particularly preferred to employ a breathing tube to expose the permeate holding tank to atmospheric pressure, and thereby allow the flow of permeate water through the membrane when exposed to pressure at depth, other means of applying a reduced pressure to the permeate side of the membranes can also be employed to drive the filtration process. A single breathing tube or multiple breathing tubes can be employed. Likewise, multiple flow directing means can advantageously be employed (e.g., multiple pipes to send permeate water to a single location or to different locations, etc.) The breathing tube(s) are preferably configured to avoid sonic effects observed for extremely rapid flow of air through the breathing tube(s) when the pumps are started or stopped.

Collection systems for use in ocean applications are configured to gather or accumulate the permeate and convey it to the ocean surface or some other desired location (a submerged location, underground or surface storage tanks on shore, or the like). Such collection systems are preferably buoyant and tethered to the ocean floor to avoid the effects of surface storms and visual impact; however, other configurations can also be advantageously employed. For example, a surface platform (floating or fixed) can be situated in the ocean, and the membrane modules can be suspended from it. Ocean currents are preferably taken into account in suspending the module. The current applies a force against the suspended module, displacing it to the side. As in a pendulum, as the module is displaced to the side, it is forced closer to the surface. If currents are relatively constant, the module can be suspended from a line that is longer than the preferred module depth, with the result that the force of the current will push the module to the side and up to the preferred depth. These same considerations apply, in reverse, for buoyant modules which are tethered to the floor of a body of water. Thus, in certain embodiments, the length of the line can be adjusted to compensate for changes in current (e.g., a current sensor can be employed, along with a winch) such that the module is maintained at the preferred depth. Alternatively, the module can be situated at a depth such that current displacement does not result in the module rising above the preferred depth.

The systems of preferred embodiments can employ conventional ocean platform technology. For example, a concrete hulled floating platform can be employed to support a power module for power generation (e.g., a generator, a transformer, etc.), fuel storage, maintenance spares storage, and other infrastructure to run the system. As potable water demand on land is not uniform throughout the day, a continuous production process preferably employs a storage system. When demand is low, as a supplement to onshore storage, the platform can employ a floating tank made of a flexible material, such as HYPERLON™, that expands and contracts as the tank fills and empties. Such storage systems are suspended in the ocean, and thus do not require heavy construction work as is required in onshore water tanks or tanks situated near shore land.

The potable or reduced ion content water generated by the system is preferably transported to shore by taking advantage of the near identical pressures inside and outside of a pipeline. For example, in selected embodiments an underwater floating, flexible pipe made of HYPERLON™ or other suitable materials can be employed. Such pipes are preferably suspended beneath the ocean surface, e.g., at about 100 feet below the surface, or along the ocean floor. The depth of the pipe is preferably such that it will not interfere with any surface traffic. If no surface traffic is present at the system location, then it can be advantageous to employ a pipe at the surface of the ocean. While flexible pipe is advantageously employed, rigid pipe, a cement flow channel, or other tube or passageway configurations can be employed.

Desalination plants often add certain chemicals (e.g., chlorine, fluorine, algaecides, antifoams, biocides, boiler water chemicals, coagulants, corrosion inhibitors, disinfectants, flocculants, neutralizing agents, oxidants, oxygen scavengers, pH conditioners, resin cleaners, scale inhibitors, and the like) to the desalinated water, depending on local regulations. This activity can take place on shore as the water is being delivered to the distribution system or at any other suitable place in the system.

### DEMWAX™ Water Filtration System

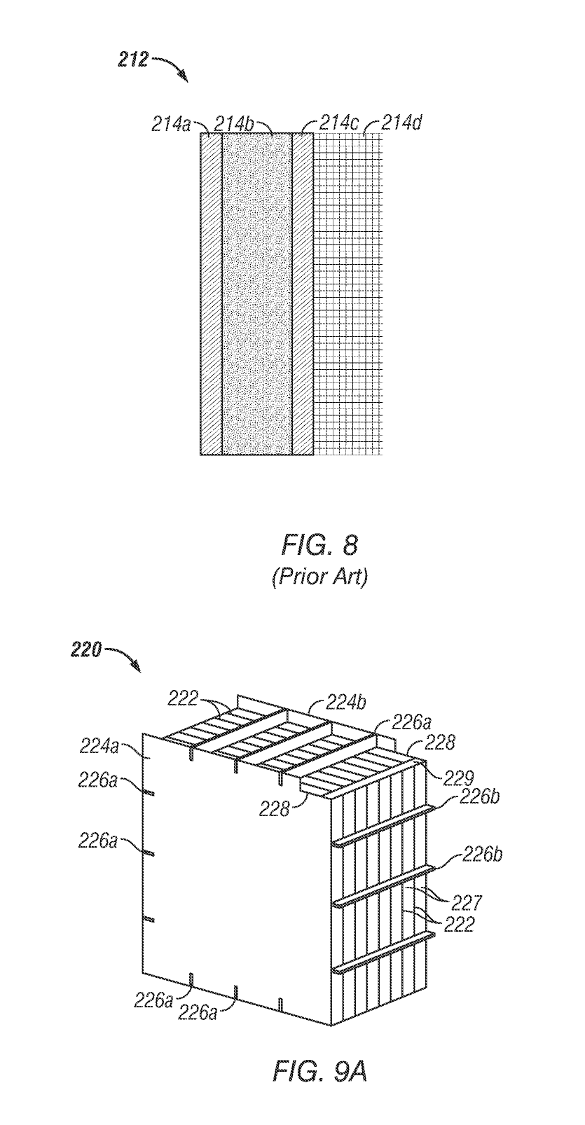

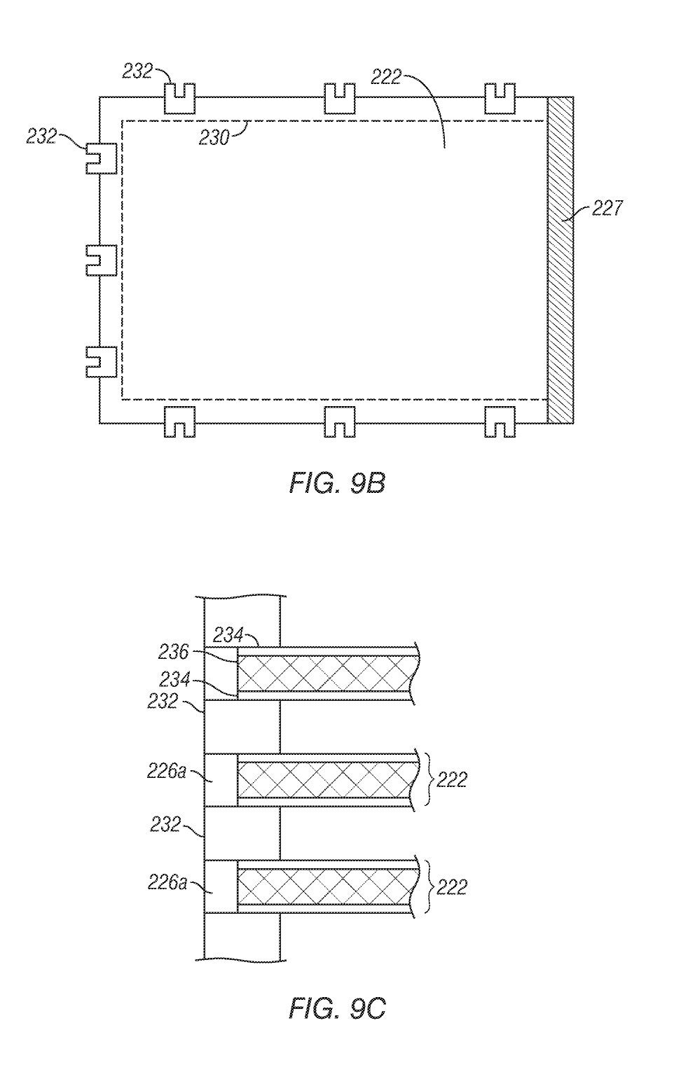

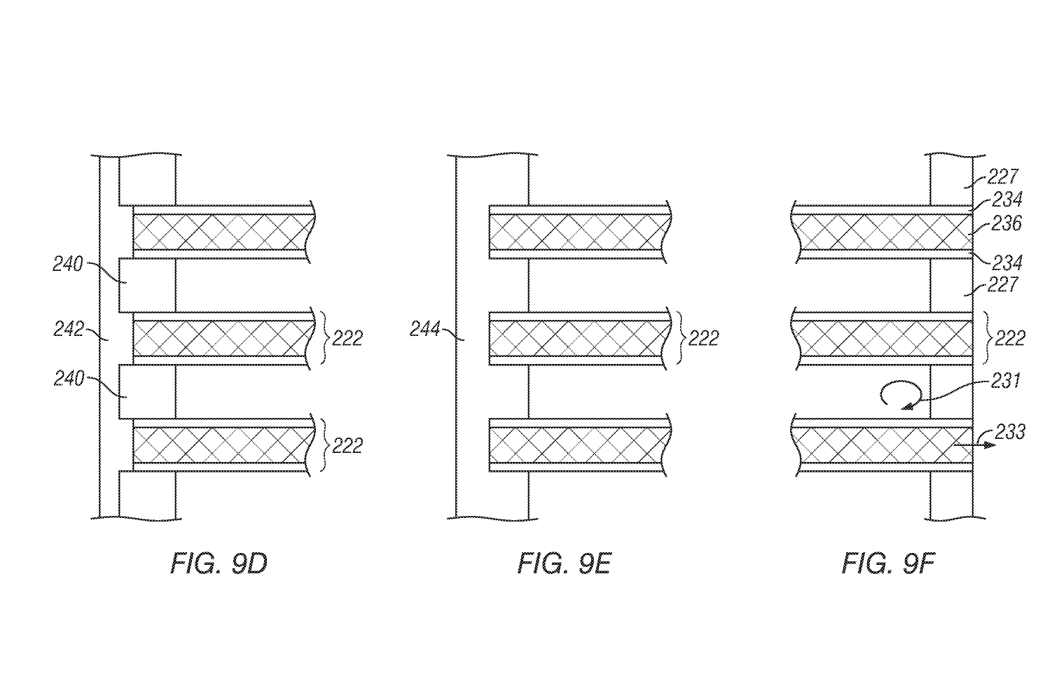

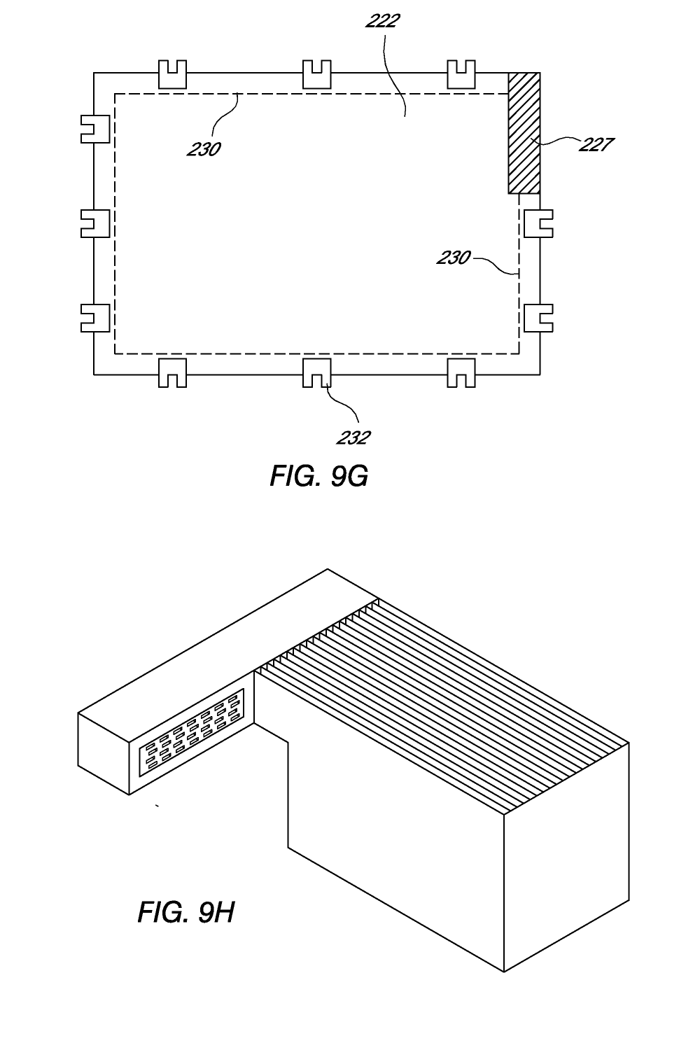

A diagram of a DEMWAX™ water filtration system of a preferred embodiment is shown in FIG. 1. Tethered to an anchor 100 on the ocean floor are elements of a DEMWAX™ water filtration system, including membrane modules 102 and a collection channel 104. The membrane modules 102 can include one or more membrane cartridges, for example as described below in connection with FIG. 9C. These and other elements of the system are preferably configured to be nearly neutrally buoyant so that floats or weights can be added depending upon the application to hold the modules at a desired depth. A breathing tube 106 can extend between the collection channel 104 and a buoy 108 floating on the surface of the ocean to expose the collection channel to atmospheric pressure. Alternatively, the breathing tube 106 can follow the permeate pipe 112 to the shore. A pump 110 pumps the permeate from the collection channel 104 to shore through the pipe 112. The pump 110 can be placed within the collection channel or adjacent to it 104, as illustrated in the figure, or can be installed at or near the shore in fluid communication with the pipe 112. The pump 110 is preferably at about the same depth as the membranes so that the backpressure does not stop the reverse osmosis process. If the pump 110 is at a depth of less than 850 feet, it may need to provide negative pressure to the membranes in order to permit the reverse osmosis process to proceed. One or more permeate storage tanks 114 can optionally be disposed within the system, for example, as part of or extending from the collection channel 104, to provide extra storage. Such extra storage can be used advantageously to buffer variations in pump speed. The storage tanks 114 can include sensors (not shown) configured to sense the volume of permeate stored in the tanks 114 and regulate the operation of the pump 110 accordingly.

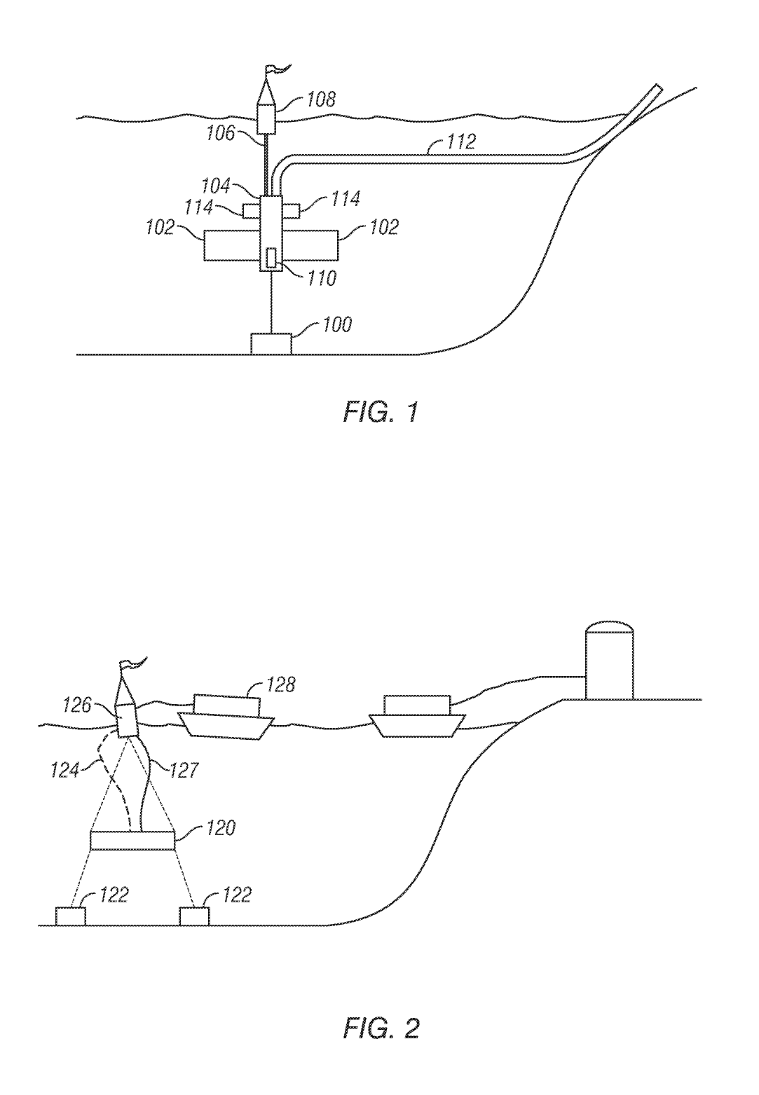

FIG. 2 illustrates another embodiment of a DEMWAX™ water filtration system which is especially well suited for temporary (non-permanent) applications. A DEMWAX™ water filtration module 120 is tethered to one or more anchors 122 on the sea floor. The module 120 includes at least one membrane cartridge and a collection channel. The membrane module is exposed to the hydrostatic pressure of the ocean at depth, and the collection channel is exposed to atmospheric pressure via a breathing tube 124 which extends to a buoy 126 floating on the surface of the water. Permeate is collected in the module 120 and pumped through a permeate pipe 127 to a mobile storage vessel 128, near the buoy 126, for transport to shore. Systems such as this one can be deployed rapidly in emergency situations, for example, close to areas experiencing water supply contamination or shortages.

FIG. 3 illustrates an alternative configuration of a DEMWAX™ water filtration system. Membrane modules 132 are suspended below a floating platform 130. In the system depicted, the modules 132 produce the freshwater which is deposited into a holding tank or tanks 134 containing submersible pumps, dry well pumps, or the like 136. The interior of the holding tank 134 is maintained at atmospheric pressure, by virtue of a breathing tube 138 that extends between the holding tank 134 and the floating platform 130. The product water can be pumped to the surface 140 and then into a flexible storage tank 142. Although illustrated with the storage tank 142 floating on the seaward side of the platform 130, the storage tank can also be situated in any other appropriate configuration, for example on the landward side of the platform 130 or suspended below the surface 140 of the water. The product water is then pumped to shore through a pipe 144 for final treatment and distribution. Power generation equipment 146 can be provided in the floating platform 130 and configured to provide power to the other components of the illustrated system. A pump 148 can also be provided to move water to shore from storage. Components such as suspension cables, power cables, tethers and anchors are not depicted in FIG. 3, but can be desirably employed in systems such as the one depicted.

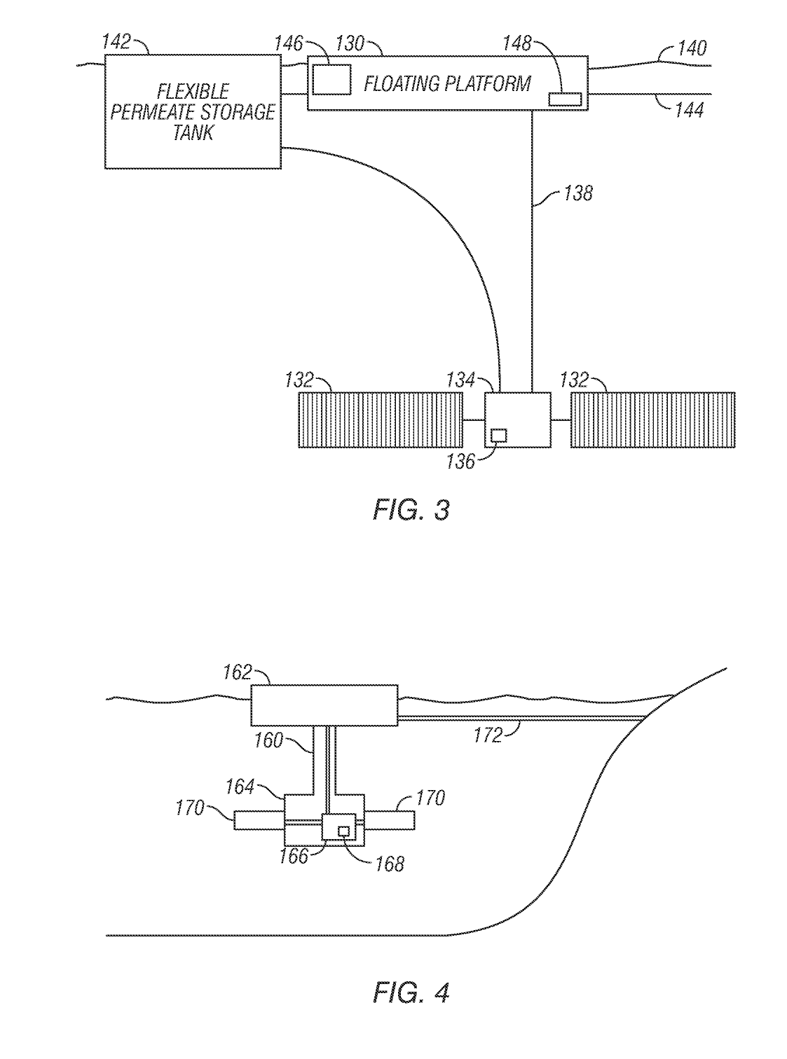

FIG. 4 illustrates another alternative configuration of a DEMWAX™ water filtration system, in which a column 160 is suspended from a floating platform 162. The column 160 can be configured to provide access to a lower chamber 164. The chamber 164 can be configured to house various components of the DEMWAX™ water filtration system, such as pumps, valves, electrical panels, instrumentation equipment, and other ancillary equipment 168. The chamber 164 can be sized large enough to allow workers to access the chamber to maintain equipment. Membrane modules 170 can be arrayed outside the chamber 164, exposed to the surrounding feed water, but with permeate portions in fluid communication with the collection channels and system 166. The collection system 166 can be exposed to the interior of the chamber 164, which, in turn, can be exposed to atmospheric pressure via the column 160. By such a configuration, the chamber 164 itself can function as a “breathing tube” for the collection system 166. A separate breathing tube can also follow the outside of the column to the surface. The collection system 166 can be fluidly connected to a pipe 172 configured to transport product water to storage or to shore. Systems of preferred embodiments such as these are particularly advantageous for large applications, and can employ larger membrane cartridges, larger membrane modules, and/or larger arrays of membrane modules than other embodiments. Such systems advantageously offer additional flexibility in choice of pumps, as well as ease of access to pumps and other equipment for maintenance purposes. In this application, other type of pumps than submersible can be used. The column 160 and chamber 164 can comprise of a structurally strong, stable and corrosion material such as concrete, so that the system can remain less affected by waves or ocean currents. Such a system may, but need not, be tethered to the ocean floor as described above in connection with FIG. 1.

Although the descriptions above make particular reference to ocean applications, similarly configured systems—both free-floating and anchored—can be utilized with embodiments configured for freshwater or surface water applications as well.

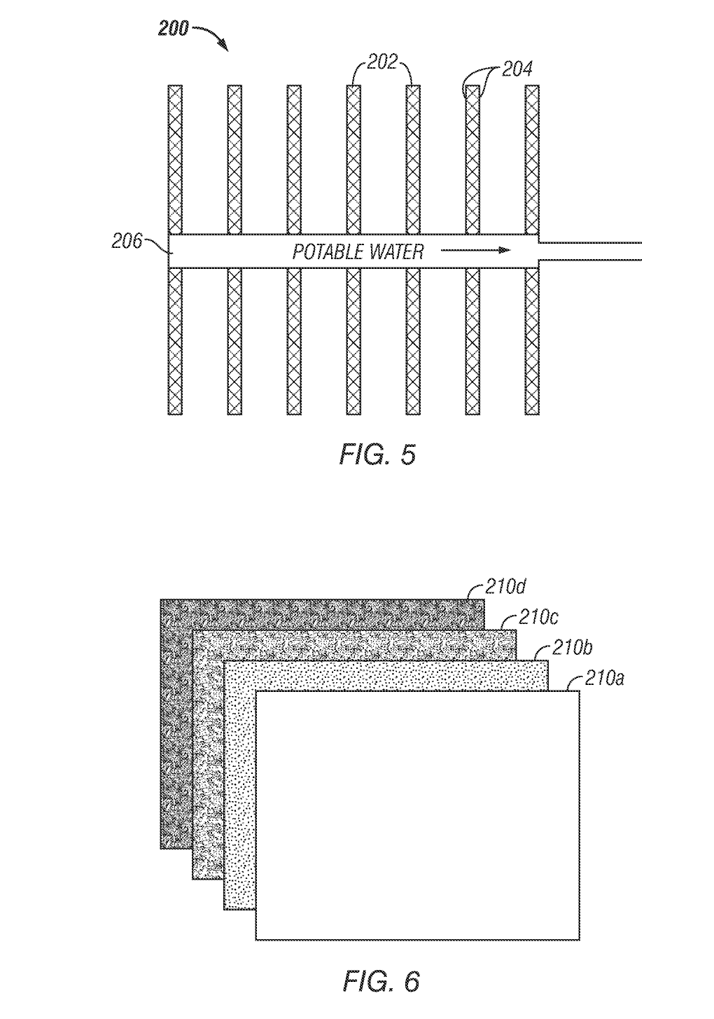

One configuration of a DEMWAX™ water filtration membrane module 200 utilizes vertically aligned membrane cartridges composed of membrane units or elements 202 in a box configuration. A simplified cross section of one such module is shown in FIG. 5. The membrane elements 202 are preferably spaced close together, but not so close that surface tension substantially impairs the ability of gravity to draw down the higher density seawater generated at the membrane surfaces 204 by the filtration process. The minimum spacing to avoid significant surface tension effects can depend upon various factors, including membrane chemistry, but is generally about 1 mm or more, preferably about 2 mm or more, more preferably from about 2 mm to about 25 mm, and most preferably from about 5 mm to about 10 mm. In certain embodiments, a spacing less than 1 mm can be acceptable or even desirable. Likewise, in certain embodiments a spacing of more than 25 mm can be acceptable or even desirable. It is generally preferred to minimize the spacing so as to maximize the membrane surface area per footprint of the installation.

FIG. 5 is not to scale and exaggerates the distances between the membranes for illustrative purposes. The diagram shows a total of seven membrane elements 202 on either side of a collection channel 206; however, in preferred embodiments a larger number of elements can be employed, depending upon the amount of water to be generated or other factors. In preferred embodiments of the seawater DEMWAX™ water filtration system, the module typically contains hundreds of these elements spaced about ¼ of an inch (about 6 millimeters) from one another. Spacing between membrane elements depends on several factors including (but not limited to) total dissolved solids in the feed water; height of the membranes and velocity of the ambient currents. In surface or freshwater applications, a spacing of about ⅛ of an inch (about 3 millimeters) between membrane elements can be desirably employed.

In systems of preferred embodiments, membrane modules and/or cartridges can be vertically arrayed or arrayed in any other suitable configuration, e.g., tilted off vertical, or horizontal if ocean currents are present. In certain embodiments, the modules can converge at a rigid casing where the freshwater flows from the membrane modules to collector channels. To provide efficient operation of such reverse osmosis systems, the surface area of the membrane that is exposed to high pressure saltwater is preferably maximized per unit of footprint area, e.g., by placing the membrane elements extremely close together in a parallel ‘fin’ configuration (e.g., similar to the ‘fins’ in a radiator or heat exchanger).

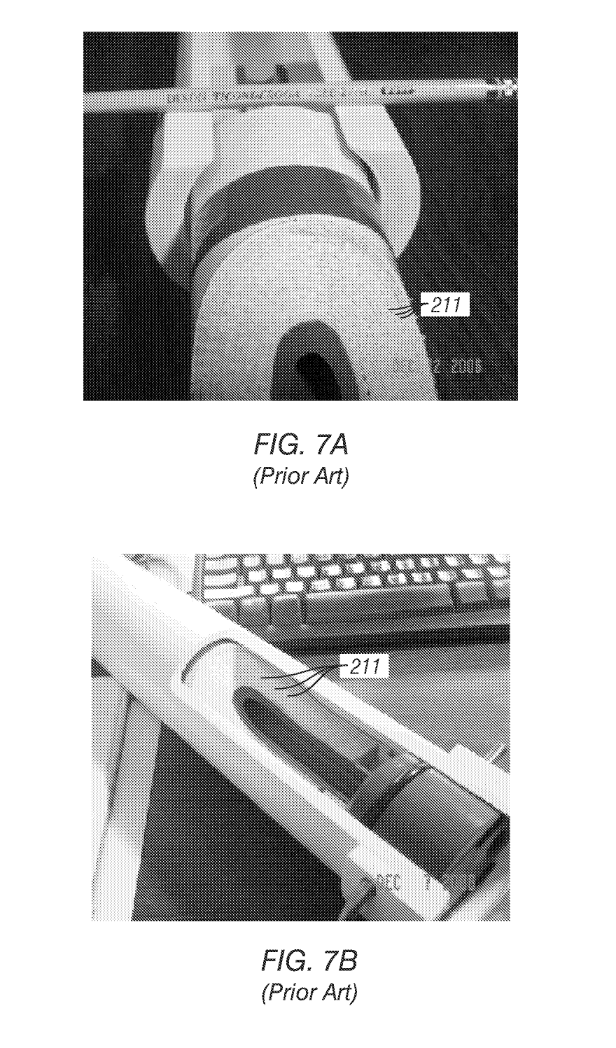

Alternatively, a configuration of the membrane modules of selected preferred embodiments can be similar to that of conventional reverse osmosis membrane modules. For example, depicted in FIG. 6 are four rectangular sheets 210(a) through 210(d). The four sheets that make up the reverse osmosis membrane element depicted in FIG. 6 include: a polyamide membrane 210(a); a permeate spacer 210(b) (e.g., to separate the two membrane sheets 210(a) and 210(c) so freshwater can flow between them); a second poly-amide membrane 210(c); and a raw water spacer 210(d) (e.g., to separate the membrane elements from one another so that raw saltwater can flow between them). FIG. 6 shows these sheets prior to being joined, rolled and inserted into a pressure vessel. The spacers 210(b) and 210(d) are porous to allow the water to flow therethrough. The raw water flows to the entire membrane surface and the permeate flows to the collection system. Typical dimensions of the sheets that can advantageously be employed are about three feet (0.91 meters) or three feet four inches (1 meter) by eight feet (2.44 meters); however, any suitable dimensions can be employed. It can be preferred to employ membrane sheets of a width and/or length as available from the membrane manufacturer; however, any suitable size can be employed. Sheets larger in one dimension can be obtained by bonding together narrower lengths using techniques as are known in the art, or can be manufactured in any desired dimension. It is generally preferred to employ a unitary sheet, as such sheets generally exhibit greater structural integrity than those prepared from smaller sheets joined together at a seam. Likewise, when a membrane is fabricated into a flat sandwich configuration, it can be desirable to fold the membrane (or any other sheet component employed in the system) to form one side of the sandwich, thus minimizing the number of seals and/or bonds and thereby increasing structural integrity of the system, unless the fold imparts a weakening of the membrane's properties. Prior to being rolled, three sides of these sheets (two membrane sheets and the permeate spacer) are sealed. The fourth side is left open and joined to the permeate pipe so that the product water can be moved to the collection system. Any suitable sealing method can be employed (e.g., lamination, adhesive, crimping, heat sealing, etc.). The dimensions of these elements in a conventional spiral-wound module are presented in FIGS. 7A and 7B. The photographs show cutaways of a reverse osmosis membrane module having twelve layers 211 of membrane wrapped around a permeate tube. In the radius of about one-half of an inch (12.7 millimeters), there are twelve layers of the four sheets described above in connection with FIG. 6. The flow space between membranes in such conventional systems is typically very small, but the pressures employed are high, allowing a large membrane surface area to be fit into a small space. In the membrane cartridges of preferred embodiments, the spacing between the membrane elements is not small as in conventional reverse osmosis systems such that surface tension substantially affects the flow of feed water between the membrane elements. Instead, the spacing is large enough that the volume of feed water flowing between the membrane elements is sufficient to maintain osmotic pressure in the space between the membranes, but small enough to fit a large membrane surface area into a relatively small volume.

FIG. 8 shows a cross section of a membrane element 212 from a conventional reverse osmosis unit (prior to being rolled). In preferred embodiments, rather than winding membranes around a collection device, the membranes 214(a), 214(c) and permeate spacer 214(b) are arrayed vertically, such that the raw water spacer 214(d) can be replaced with an actual space, although in certain embodiments a polymer or other spacer sheet can be employed.

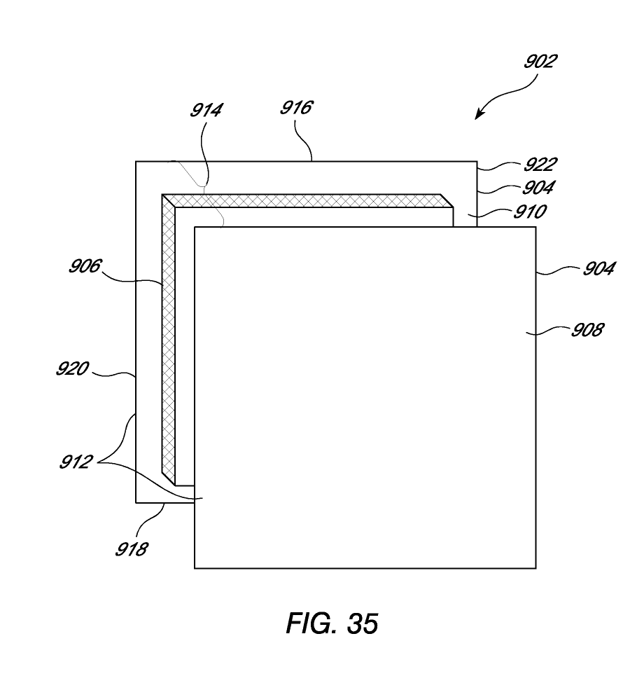

FIG. 35 is an exploded perspective view of one embodiment of membrane element 902 of a water purification unit disclosed herein. As shown, the membrane element includes two membrane sheets 904 and a permeate spacer 906 disposed between the membrane sheets 904. The membrane sheets 904 have an outside face 908 and an inside face 910. The outside faces 908 of the membrane sheets 904 are in contact with the water to be treated, or source water, and define an outside face 912 of the membrane element 902. The inside faces 910 of the membrane sheets 904 and the permeate spacer 906 define the inside face 914 of the membrane element, where treated water, or permeate, is collected.

In some embodiments, the membrane sheets 904 of the membrane element can be sealed or affixed to a component of a membrane module (not shown) to form a water-tight seal. The membrane sheets 904 of the membrane element 902 can be attached (e.g., sealed or affixed) to a component of the membrane module (for example as discussed below) using any suitable sealing method, e.g., lamination, adhesive, crimping, heat sealing, etc., thereby exposing the inside face 914 of the membrane element 902 to the surface of the membrane module component to which the side is attached. The portions of the membrane elements 902 that are not attached to a component from a membrane module can be sealed so that the inner face 914 of the membrane element 902 is not exposed to the water to be treated, or source water. Likewise, the watertight seal of the portions of the membrane sheets 904 of the membrane element 902 to the component of the membrane module prevents non-processed or source water from entering into the inside face 914 of the membrane element 902.

By way of example, in some embodiments, the sides of the membrane elements 902 can be attached to components of a membrane module as described herein, including but not limited to various collector elements, frameworks, collection channels, collector pipes, collection tubes, structural supports, and structural support tubes, reinforcing members, columns, other membrane elements, or the like, or any other component of a membrane module disclosed herein. Preferably, at least one side of the membrane element 902 is attached to a collection tube, collector channel, or, collector pipes such that the inside face 914 of the membrane element 902 is in fluid connection with the collection tube or collector channel.

In the embodiment shown in FIG. 35, the membrane element 902 has a top side 916, a bottom side 918, a front side 920, and a rear side 922, defined by the shape of the membrane sheets. It will be appreciated, however, that the membrane element can be in any shape.

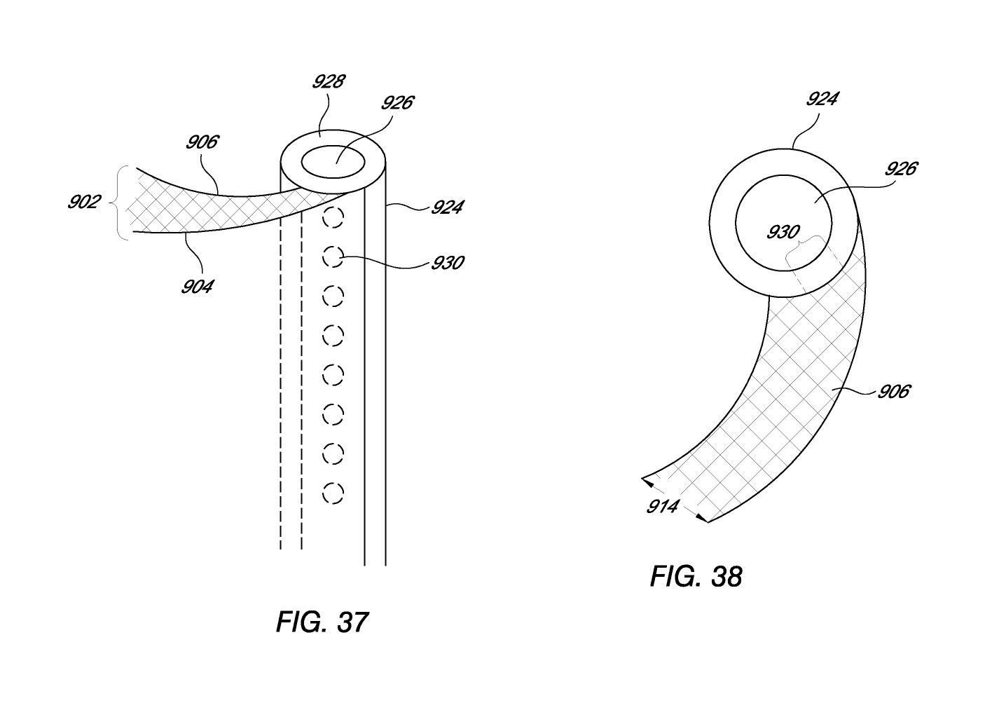

Referring to FIGS. 37 and 38, in some embodiments, the membrane element 902 can be attached to a collection tube 924 that has an inner channel 926, and which is in fluid connection with one or more collection channels (not shown). The membrane element 902 can be attached by any means known to those skilled in the art appropriate for the intended purpose, e.g., with adhesive or epoxy, much in same fashion as existing spiral wound membrane technology. When attached, the inside face 914 of the membrane element 902, including the permeate spacer 906, abuts and is in contact with a portion of the wall 928 of the collection tube 924 which has perforations or holes 930, thereby permitting permeate to pass into the inner channel 926. It will be appreciated, however, that the sheets 904 of the membrane element 902 can be attached such that the portion of the wall 928 of the collector tube 924 that is in contact with the inside face 914 of the membrane element 902 does not contain openings, perforations 930, or the like.

### Membrane Cartridge

FIG. 9A shows a perspective view of a membrane cartridge 220 configured according to a preferred embodiment. The cartridge 220 includes one or more membrane elements 222 disposed substantially within a casing comprising two side walls 224(a), 224(b). The side walls 224(a), 224(b) can provide vertical support for the membrane cartridge 220 and can protect the sides of the membrane elements 222. The side walls 224 can be made from any appropriate material, including but not limited to, plastic, metal, fiberglass, or the like, or any combination thereof. In some embodiments, the side walls 224 can be made from a sealed honeycomb structure, structural foam, or the like, to provide positive buoyancy to offset the weight of the membrane cartridge 220 in the water. In some embodiments, the honeycomb structure can also be reinforced, for example, on the surface that is not exposed to the membrane elements 222, with cross members or the like.

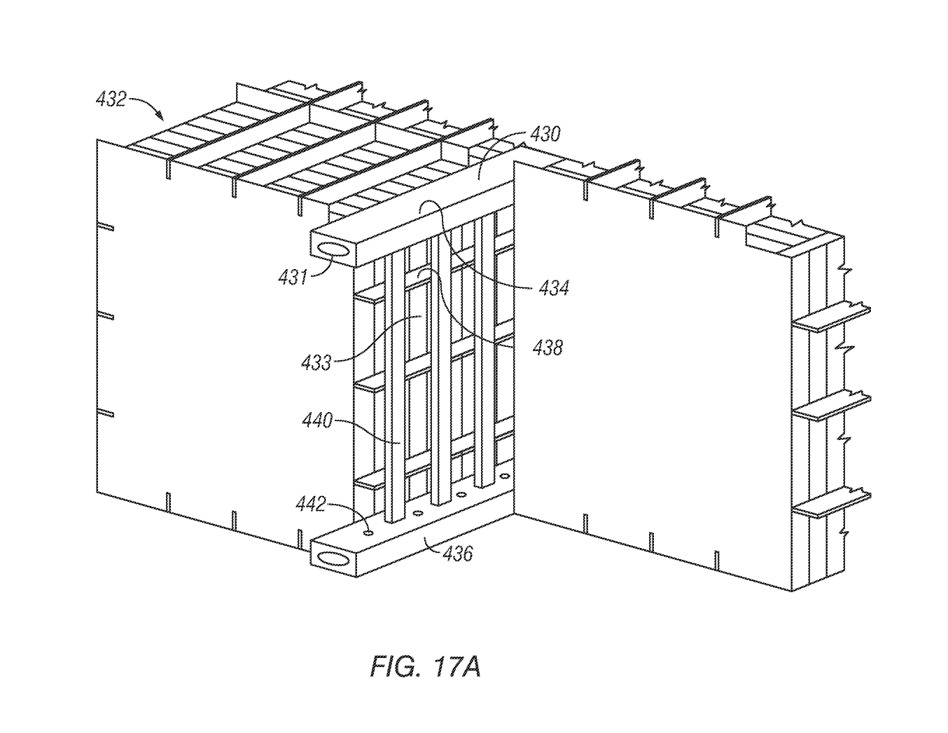

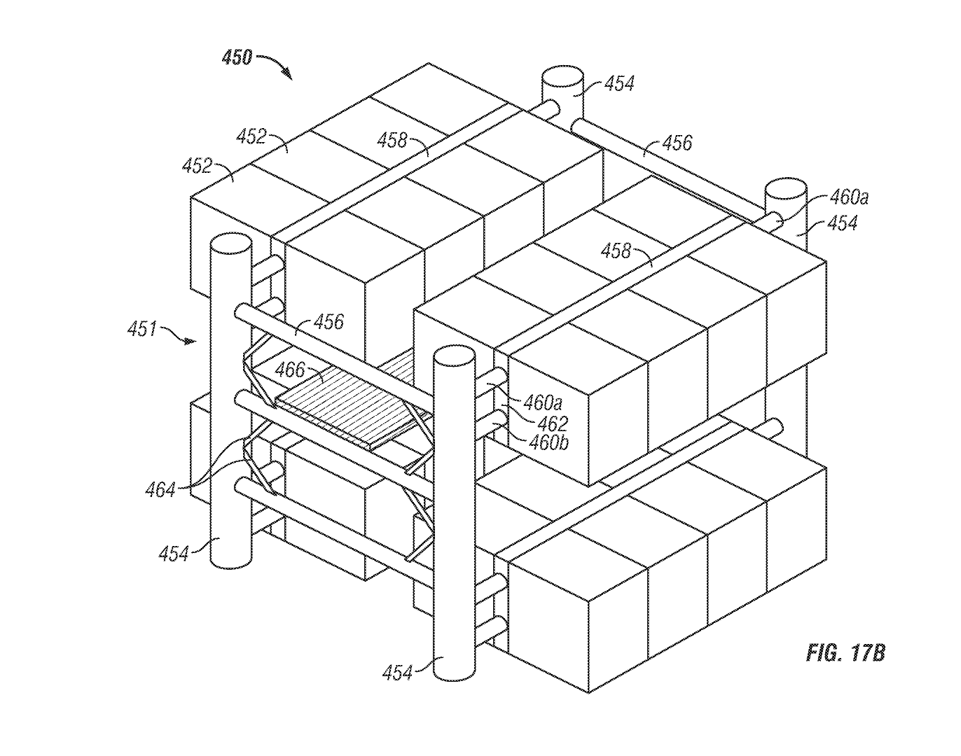

In the embodiment shown in FIG. 9A, one or more rigid dowels 226(a) extend between the side walls 224 at the top, bottom, and rear of the cartridge 220 to maintain the spacing of the side walls 224 and to provide structural support to the cartridge 220. One or more rigid dowels 226(b) extend between the side walls 224 at the front of the cartridge 220 to perform this same function, as well as to provide space for permeate to flow through the front of the cartridge 220 (see, e.g., the discussion of FIG. 17A, below). The dowels 226(a), 226(b) are shown extending to the side walls 224; however, other configurations are possible. The dowels 226(a), 226(b) can also be configured to maintain the spacing between the membrane elements 222, although separate spacing means can also be provided to perform this function. At the front end of the cartridge 220, the membrane elements 222 are separated by one or more sealing spacers 227 extending from the top ends of the membrane elements 222 to the bottom ends of the elements 222. Together, the sealing spacers 227 form a front wall 229 of the cartridge 220. The sealing spacers 227 are configured to provide a watertight seal separating the source water flowing between the membrane elements 222 from the permeate flowing through the membrane elements 222 and into the collection system at the front end of the cartridge 220. The side walls 224(a), 224(b) can each include one or more notches 228 or other features configured to mate with a corresponding structure of the collection system, to facilitate collection of permeate through the front ends of the membrane units 222. The membrane cartridge 220 can be configured to withstand the hydrostatic pressure to which it will be exposed during operation, and can comprise materials suitable for the particular application. The diagram shows a total of seven membrane elements 222 in the cartridge 220; however, in preferred embodiments a larger or smaller number of elements can be employed, depending upon the amount of water to be generated, the desired spacing between the membranes, or other factors. FIG. 9A is not to scale and exaggerates the distances between the membrane units 222 for illustrative purposes (for example, a membrane cartridge of one preferred embodiment can be one meter tall with spacing between the membrane elements just 6 millimeters).

The membrane cartridges 220 can be manufactured in many different ways. By way of example, FIGS. 9B through 9H illustrate steps in the process of manufacturing a membrane cartridge 220. First, a number of membrane units or elements 222 can be prepared. Each membrane element 222 comprises two membranes 234 spaced apart by a permeate spacer sheet 236. The top, bottom, and rear edges of each membrane element 222 are sealed, as indicated by the dotted line 230 in FIG. 9B, leaving the front edge (the right side of FIG. 9B) of the membrane element 222 open. The sealing of the edges can be accomplished using adhesive, crimping methods, heat sealing or any other suitable method capable of forming a seal that can withstand the pressure differential between the inside and outside of the membrane element. One or more spacers 232 are then attached around the edges of the membrane element 222. The spacers 232 can extend beyond the perimeter of the membrane element 222, as shown in FIG. 9B, or can abut the perimeter. The spacers 232 can optionally include one or more notches, grooves, or openings configured to receive a dowel extending through a series of elements 222. Of course, the spacers 232 can have any other configuration suitable for their intended purpose. At the front end of the membrane element 222, a sealing spacer 227 is attached which extends along the full height (as shown in FIG. 9B) or partial height (as shown in FIG. 9G) of the element 222. The spacers 232 and the sealing spacer 227 can be attached or otherwise coupled to the membrane element 222 using adhesive or any other suitable means. Once the spacers 232 and sealing spacers 227 are attached, another membrane element 222 is attached to the spacers 232 and the sealing spacer 227. The process is repeated until a cartridge is constructed having the desired number of membrane elements 222.

FIGS. 9C through 9E show various configurations of spacers in a stack of membrane elements 222. FIG. 9C shows a cross section of a stack of membrane elements 222 which are spaced apart by spacers 232. The spacers 232 extend beyond the edges of the membrane elements 222 to wrap around a continuous dowel 238 which spans the series of membrane elements 222 in the cartridge. Together, the spacers 232 and dowel 238 form a reinforcement structure which spans the series of membrane elements 222 and which can serve as a structural component of the membrane cartridge (see, e.g., dowels 226(a) in FIG. 9A). FIG. 9D shows an alternative embodiment, in which spacers 240 extend beyond the edges of the membrane elements 222. The spacers 240 can be grooved or notched to receive a dowel 242 spanning the series of membrane elements 222, with the dowel 242 fitting into the grooves in the spacers 240. The dowel 242 can comprise, for example, a polymeric material, composite, or metal. FIG. 9E shows a still further embodiment, including a comb-like dowel 244 configured to closely receive each membrane unit 222. In such a configuration, the spacing of the membrane units 222 is maintained by the teeth of the dowel 244, without requiring additional spacers. To manufacture a cartridge of this configuration, a series of membrane units 222 can be inserted into each space between the teeth of the dowel 244. Adhesive or other suitable engagement means can be optionally provided in these spaces to ensure appropriate engagement of the dowel 244 with the units 222. In addition, although illustrated with spacers 232 extending into the area between the membranes 234, embodiments can also employ spacers which do not do so. For example, embodiments can include membrane elements which are sealed (at the top, rear, and bottom edges) by sealing members that extend beyond the membrane area. In such embodiments, the spacers can be disposed between those portions of the sealing members that extend beyond the membrane area, rather than between the membranes themselves.

The front wall 229 of the membrane cartridge 220 is illustrated in further detail in FIG. 9F. As shown in the figure, the sealing spacers 227 are disposed in between each membrane unit 222. The sealing spacers 227 extend along the length of the membrane units 222 (see FIG. 9B) and are configured to separate the source water flowing in between the membrane units 222, as indicated by arrow 231, from the permeate flowing through the permeate spacers 236 and into the collection channel, as indicated by arrow 233. The sealing spacers 227 do not substantially interfere with the flow of permeate between the membrane elements 222. The sealing spacers 227 can be adhered to the membrane sheets 234 using adhesive or any other suitable method.

FIG. 9G illustrates a step in the formation of a membrane cartridge according to an alternative embodiment, in which membrane elements 222 are stacked with sealing spacers 227 that extend along only part of the height of the elements 222. FIG. 9H shows such a membrane cartridge with the sealing spacers 227 connected to a smaller collection channel.

In some embodiments, the front wall 229 of the membrane cartridge 220 can be made by alternating sealing spacers 227 and membrane elements 222. As an alternative to using sealing spacers, the space between the membrane elements 222 can be sealed by potting the area between the membrane elements 222 at the open ends of the elements with a suitable potting material, such as epoxy, polyurethane, plastic, or other appropriate potting material known to those skilled in the art, in order to form a continuous wall. Potting methods and compounds are known to those skilled in the art, and are described, for example, in U.S. Pat. No. 6,974,544, herein incorporated by reference in its entirety. For example, in some embodiments, a rack can be used to hang membrane elements 222 at a desired spacing. The open end (to form the front wall 229) can be placed in a form and the potting material poured into the form and allowed to dry, for example, under a vacuum, to ensure the even distribution of potting material and the absence of air bubbles. The thickness of the wall created by the potting material will vary depending on the potting material used and the pressure differential particular to the specific application. In some embodiments, the wall can be approximately 0.5″, 0.6″, 0.75″ 1″, 2″, 5″, 6″, 7″, 8″, 9, 10″, or more. Reinforcement can also be added to the potting material during forming. Following the potting procedure, the potted structure can be machined using methods known to those skilled in the art, in order to expose the permeate side of the membrane elements 222, while retaining the water tight seal between membrane elements 222.

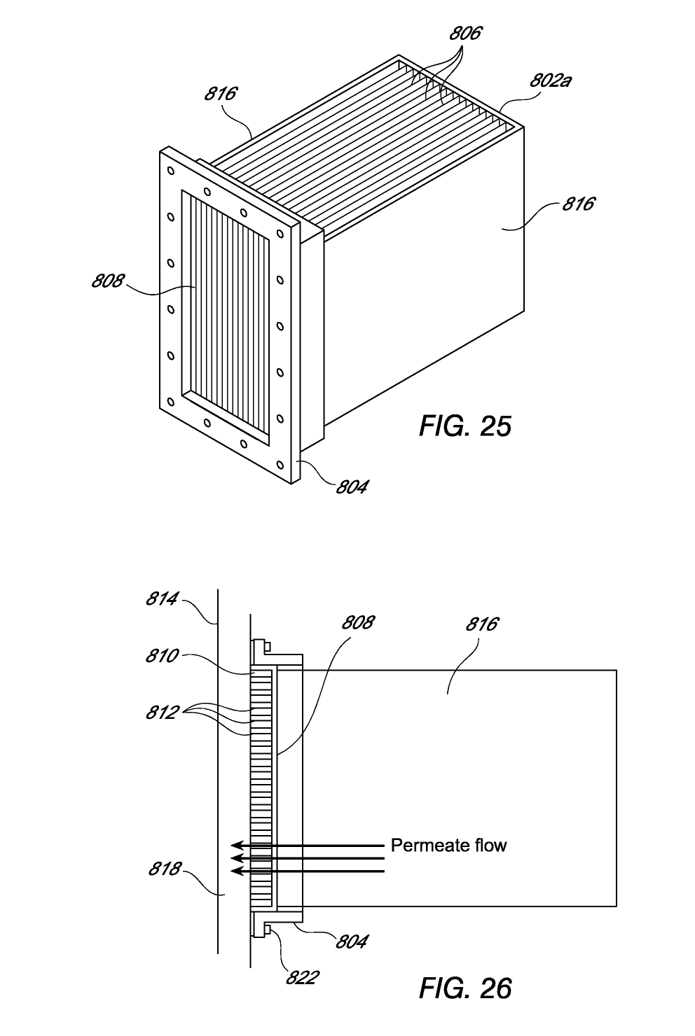

FIG. 25 shows one embodiment whereby a membrane cartridge 802a can be attached to a collection channel (not shown). A potted, machined membrane cartridge comprising membrane elements 806 and side walls 816 can be attached to and reinforced by a rigid frame 804. The rigid frame 804 ensures that a flexible potting material disposed between the membrane elements 806 and comprising the front wall 808 maintains its shape under the pressure differential. The rigid frame 804 can be made from any suitable material, including but not limited to plastic, fiberglass, metal, or the like. Accordingly, in some embodiments, a flexible potting material is used such that under pressure, the flexible material provides a seal between the membrane cartridge 802a, the rigid frame 804, and the collection system, which may comprise, for example, a collection plate 810a with slits 812 or holes as shown in FIG. 26. The rigid frame 804 can be bolted, screwed, glued, or otherwise attached to a collection plate 810a, or the like, as shown in FIG. 26. In some embodiments, a gasket, o-ring or the like can be used to provide a seal between the rigid frame 804 and the collection channel 814. For example, as shown in FIG. 25, in some embodiments, the front wall 808 can be set back from the front side of the rigid frame 804, for example, by 0.25″, 0.5″, 0.75″, 1″, 1.5″, 2.0″, or by any other suitable distance. In some embodiments, the inset of the front wall 808 is such that it enables the collection plate 810a to rest flush against the front wall 808 when it is connected to the collection channel 814 (see FIG. 26).

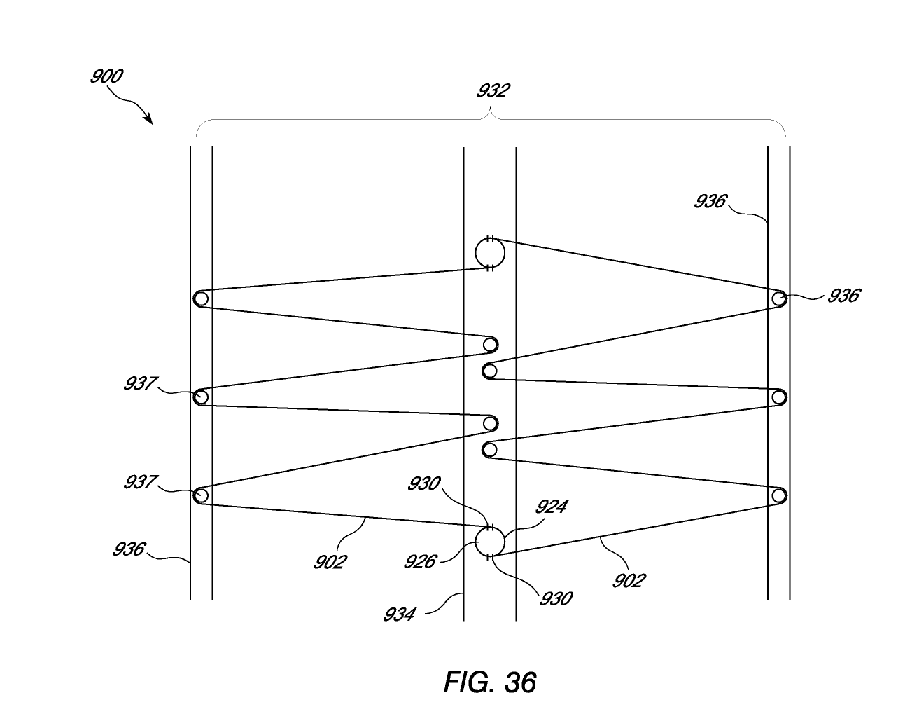

Alternative embodiments to the “stacked” membrane cartridges described above are depicted in FIGS. 36-44. Referring to FIG. 36, membrane elements 902 can be sealingly attached to collection tubes 924, for example as described above and illustrated in FIGS. 37 and 38, and can be weaved through a collection framework 932 comprising one or more collection channels 934 and one or more structural supports 936. The “weaved” configuration advantageously enables the module to be made more compact, by providing more surface area of the membrane element to be exposed to the source water. The length of each membrane element 902 is dictated by the capacity of the permeate spacer 906. The more capacity available in the permeate spacer 906, the longer the membrane element 902 can be.

In the embodiment shown in FIG. 36, the collection channel 934 and the structural supports 936 are parallel to each other, however, the skilled artisan will appreciate that the collection channel 934 and structural supports 936 can be in other configurations relative to each other. The collection tubes 924 can be located on, and normal to, and in fluid communication with the collection channel 934. The skilled artisan will appreciate that although the collector tubes 924 and structural tube supports 937 are shown in FIGS. 36-44 as having a cylindrical shape, the collector tubes 924 and structural support tubes 937 can be any other shape suited for the purposes described herein. Structural tube supports 937 can be located on and normal to the structural supports 936 and/or can be located on and normal to, the collection channel 934.

The membrane elements 902 can be attached to the collection tube 924 to form a watertight seal, such that the inside face 914 of the membrane elements 902 contacts the collection tube, as described above. In some embodiments, the outside face 912 of the membrane elements 902 can be wrapped around the structural tube supports 937 and/or the collector tubes 924.

Each of the membrane elements 902 shown in FIG. 36 is attached to two collection tubes 924. The skilled artisan will appreciate, however, that a membrane cartridge can be configured, for example, such that a membrane element 902 is attached to a single collection tube 924, for example, at one side 916, or one region of the membrane element 902. Further, as shown in the embodiment depicted in FIG. 36, more than one membrane element 902 can be attached to a single collection tube 924. The outside face 912 of the membrane element 902 can be wrapped around structural support tubes 937, which hold the membrane element 902 taut. The structural support tubes 937 and collection tubes 924 provide structural support to the membrane elements 902 and hold the membrane elements 902 taut.

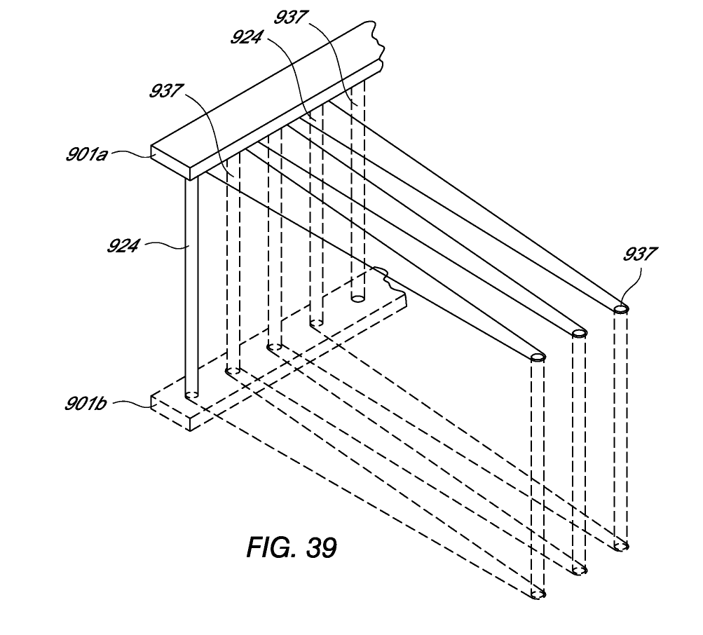

FIG. 39 is a perspective view of one embodiment of a membrane cartridge 900, wherein the membrane elements 902 are weaved through a collection framework 932 comprising collection tubes 924 and structural support tubes 937. In the embodiment shown in FIG. 39, the collection framework 932 of the membrane cartridge 900 comprises a top and bottom portion 901(a), 901(b) of collection channel 934. Structural support tubes 937 and collector tubes 924 are disposed between and attached to the top and bottom portions 901(a), 901(b) of collection channel 934. Structural support tubes 937 can also be located and attached to, different components of the structural framework 932, such as, for example, a structural support 936 (not shown).

As discussed at below, the structural support tubes 937 and the collector tubes 924 can be any of size, material, or shape that can withstand the environment in which the membrane module is placed, can support the weight of the membrane element 902 and the membrane cartridge 900, do not damage the membrane element 902, and maintain the integrity of the processed water, or permeate.

The membrane element 902 is woven through the structural framework by attaching a region of the membrane element 902 to a collector tube 924, wrapping the outside face 912 of the membrane element 902 around the structural support tubes 937, and attaching a second region of the membrane element to a different collector tube 924. As discussed above, the outside face 912 of membrane element 902 can be wrapped around one or several structural support tubes 937 and/or can be attached, as described above, to a structural support tube 937. It will be appreciated that in some embodiments, the membrane elements 902 are not attached to or wrapped around structural support tubes 937. However, at least one region of a membrane element 902 of a membrane cartridge must be attached to, and in fluid connection with, at least one collection tube 924 or collection channel 934, in order that permeate can enter into the collection channel(s) 934.

Wrapping or attaching of the membrane element to the structural support tube 937 or collector tube 924 should not impede the flow of fluid from the permeate spacer 906 to the collector tubes 924 in a manner that diminishes the performance of the membrane cartridge 900. Care should thus be taken, when wrapping the membrane element 902 around the structural support tube 937, to not harm the membrane element 902 or diminish the flow capacity of the permeate spacer 906. The collector tube 924 is sized to allow adequate flow of permeate from the membrane elements 902.

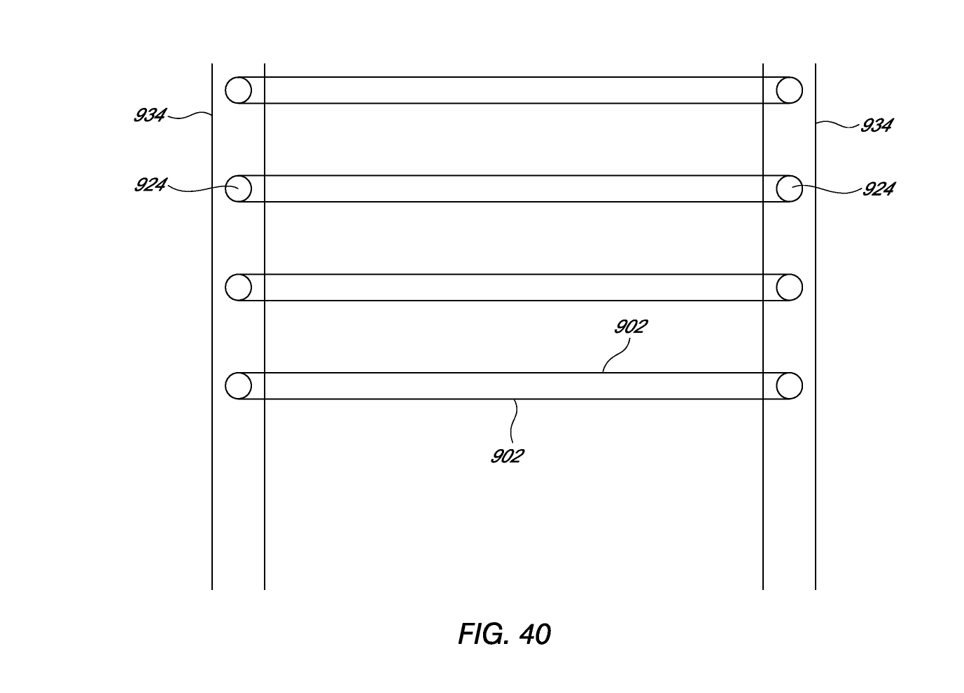

FIG. 40 shows a top view of a membrane cartridge comprising two collection channels 934 that are arranged parallel to each other. Collector tubes 924 are attached to and in fluid connection with the collector channels 934. As shown in FIG. 40, each collector tube 924 is attached to two different membrane elements 902. The collector tubes 924 hold the membrane elements 902 taut.

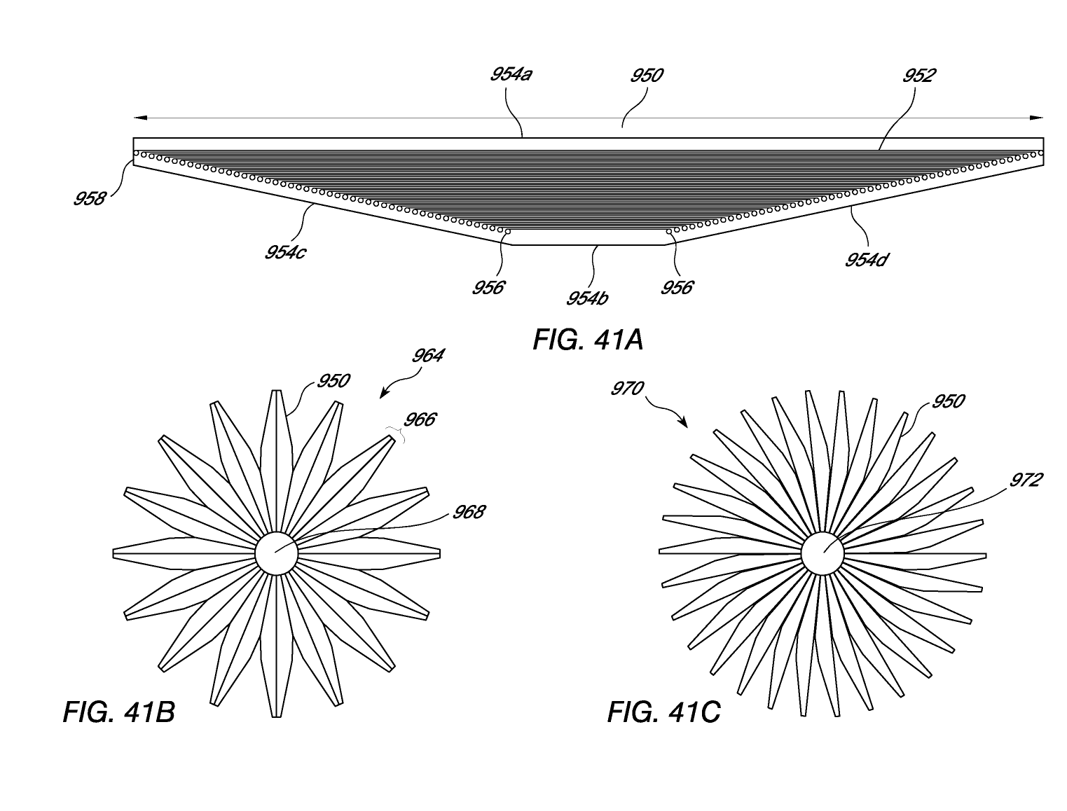

FIG. 41A shows a top view of one embodiment of a membrane cartridge 950 with membrane elements 952 attached to collection tubes 956 as described above. In the embodiment shown, the membrane cartridge 950 is wedge-shaped, such that the shape from the top view is a trapezoid with two parallel sides 954(a), 954(b), and two sides of equal length 954(c), 954(d) between the parallel sides.

The collection tubes 956 are vertically aligned between a top collector channel (not shown) and a bottom collector channel 958, which run along the perimeter of the wedge-shaped membrane cartridge 950, and which is in fluid connection with collection piping 960 (see FIG. 41B). In the embodiment shown in FIG. 41A, the membrane cartridge comprises an equal number of collector tubes attached to each of the two sides of the collector channel. The skilled artisan will appreciate, however, that the sides of the membrane element 900 can be shaped differently, and that the collection tubes can be configured in a different arrangement than shown.

A plurality of membrane elements 952 are attached at two sides and held taut by two different collector tubes 956 on the different sides 954(c), 954(d) of the membrane element 952, to form a membrane array. The collector tubes 956 and collector channels 958 serve the dual purposes of channeling permeate from the membrane array and providing structural support to the membrane array and the membrane cartridge. The collector tubes 956 and the collector channels 958 should be of a size, shape, and material capable of withstanding the environment in which they are placed as well as fulfilling the dual functions of providing structure and channeling permeate.

As shown in FIGS. 41B and 41C, several wedge-shaped membrane cartridges 950 can be arranged in different patterns to create a membrane module. The embodiment shown in FIG. 41A is membrane module 964 comprising several petals 966 arranged radially around a common center point 968. Each petal 966 comprises two wedge-shaped membrane cartridges 950 arranged such that the longer, parallel sides of the trapezoid shapes of two membrane cartridges 950 form a common boundary. The embodiment shown in FIG. 41C is a membrane module 970 that comprises several wedge-shaped membrane cartridges arranged radially around a common center point 972. Each cartridge 950 is arranged such that the longer parallel side of one membrane cartridge forms a common boundary with one of the two sides that are not parallel.

In some embodiments, one or more pumps can be located at the common center point to facilitate the transport of permeate away from the membrane module, toward a permeate collection pipe, storage tank, or the like. The collection pipe can be in fluid connection with collector channels and pumps. Such systems can be designed with the goal of maintaining or promoting circulation between the membrane elements, as well as other environmental considerations.

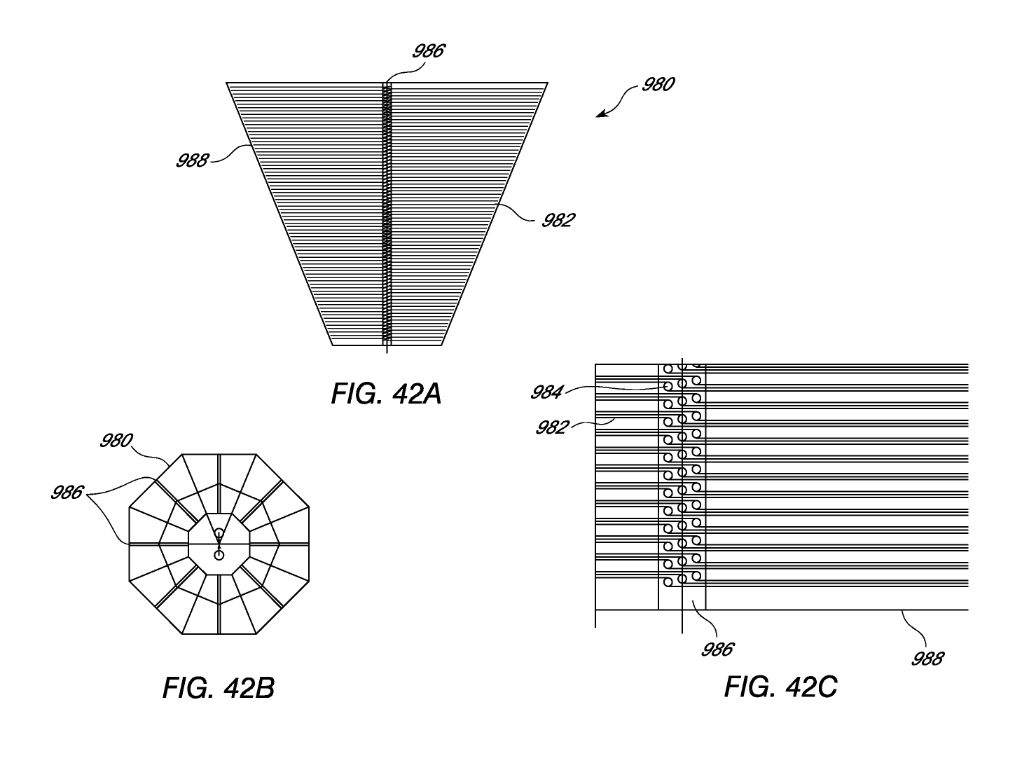

FIG. 42A illustrates an embodiment of a wedge-shaped membrane cartridge 980 with membrane elements 982 attached to collection tubes 984, for example as described above. In the embodiment shown, the membrane cartridge 980 is wedge-shaped, such that the shape from the top view is a trapezoid with two parallel sides and two sides of equal length between the parallel sides. In contrast to the configuration of the membrane cartridge shown in FIG. 41A, the embodiment shown in FIG. 42A has a collector channel 986 that runs perpendicular to and between the sides, down the center of the wedge shape, rather than along the perimeter of the membrane cartridge. In the embodiment shown, the top collector channel is located at the midpoint between the sides of the membrane element 980. The membrane cartridge 980 can also have a bottom collector channel (not shown). The membrane cartridge 980 can be encased in a frame 988 or other casing, in order to provide structural support and maintain the integrity of the shape and components of the membrane cartridge 980.

The membrane cartridge 980 also includes a plurality of collector tubes extending normal to, and fluidly connected to, the collector channels 986. The membrane cartridge also includes a plurality of structural supports that run along the length of sides of the membrane elements 982, and which are parallel to the collector tubes. The membrane elements can be attached to and in fluid connection with collector tubes, as described herein. In some embodiments, the membrane elements wrap around the structural support tube and are attached at two sides to adjacent collector tubes. In some embodiments, the membrane elements are attached at one side to a collector tube, and at a second side, to a structural support tube.

FIG. 42B depicts an exemplary arrangement of collection tubes positioned along the centrally-positioned collection channel shown in FIG. 42A. Each collector tube has two membrane elements attached that extend out to opposite sides of the membrane cartridge. One skilled in the art will recognize that numerous configurations of collector tubes and membrane elements fall within the scope of the present disclosure.

The collector tubes and collector channels serve the dual purposes of channeling permeate from the membrane array and providing structural support to the membrane array and the membrane cartridge. The collector tubes and the collector channels should be of a size, shape, and materials that are capable of withstanding the environment in which they are placed as well as fulfilling the dual functions of these components. In some embodiments, the membrane cartridge includes an external frame or casing, made of an appropriate material, to provide support to the membrane cartridge structure.

FIG. 42C depicts an embodiment of a membrane module created using the membrane cartridge 980 from FIG. 42A. The membrane module is formed by locating several membrane cartridges radially around a common center point, with each cartridge 980 positioned the same distance from that center point. The cartridges are arranged such that the sides of adjacent cartridges form a common boundary. In some embodiments, pumps can be located at the common center point to facilitate the transport of permeate away from the membrane module to a permeate collection piping, a storage tank, or the like. The collection pipe can be in fluid connection with the collector channels and the pumps.

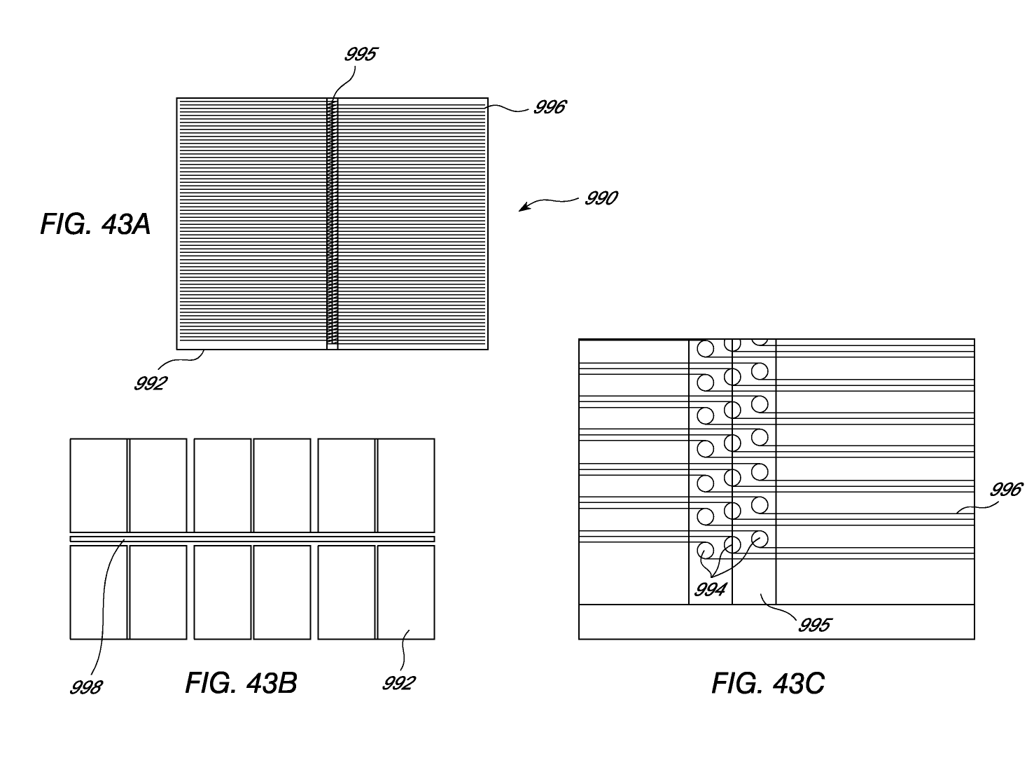

FIG. 43A illustrates an embodiment of a rectangularly-shaped membrane cartridge 990 comprising an external frame 992 with parallel sides. The embodiment shown has a top collector channel and a bottom collector channel (not shown) that are centrally located between parallel sides. One or more vertically positioned collector tubes 994 are disposed between, and fluidly connected to, the top and bottom collector channels 995 (see, for example, FIG. 43A). One or more structural supports can be positioned along the length of the parallel sides. One or more membrane elements 996 can be attached in fluid connection with the collection tubes 994. The membrane elements 996 can also be either attached to or wrapped around structural support tubes or held taut by the collector tubes 994 and structural supports. In some embodiments, the membrane elements 996 wrap around the structural support tube(s) and are attached at two sides to adjacent collector tubes 994. In some embodiments, the membrane elements are attached at one side to a collector tube 994, and at a second side to a structural support tube. In some embodiments, the membrane cartridge includes an external frame or casing 992, made of an appropriate material, to provide support to the membrane cartridge structure.

FIG. 43B depicts an embodiment of a membrane module created comprising a plurality of membrane cartridges 990 as shown in FIG. 43A. In the embodiment shown in FIG. 43B, the membrane module is created by positioning a plurality of membrane cartridges 990 along either side of a collection pipe 998. The collection pipe 998 is in fluid connection with the collector channels 995.

FIG. 43C depicts an exemplary arrangement of collection tubes 994 positioned along the centrally-positioned collection channel 995 shown in FIG. 43A. Each collector tube 994 has two membrane elements 996 attached that extend out to opposite sides of the membrane cartridge 990. One skilled in the art will recognize that numerous configurations of collector tubes 994 and membrane elements 996 fall within the scope of the present disclosure.

### Structural Support Tube and Collection Tube

As discussed above, collector tubes and structural tubes can provide the membrane element with structural support and be designed to withstand the environment and to support the weight and size of the membrane element. Additionally, the collector tubes and structural tubes can be configured to maintain the separation between permeate and source water.

In some embodiments, the structural support tube and collector tube can be made of a material and in a manner which allows the membrane element to be attached to the tube surface, in order to form a watertight seal. As discussed above, in some embodiments, membrane elements can be wrapped around, rather than sealed/attached to structural tubes, or collector tubes. In embodiments wherein the membrane elements are wrapped around the tubes, the shape and size of the tubes and material from which the tubes are constructed are preferably such that the membrane element is not unduly stressed or damaged by being wrapped around the tube(s).

In some embodiments, a portion of the structural tubes and/or collector tubes can be inserted through the outside face and into the inside face of the membrane element. In such embodiments the support tube or collector tube can be designed to fit within the membrane element without negatively impacting the function of the membrane element, and would be sealed to the membrane element around the insertion point.

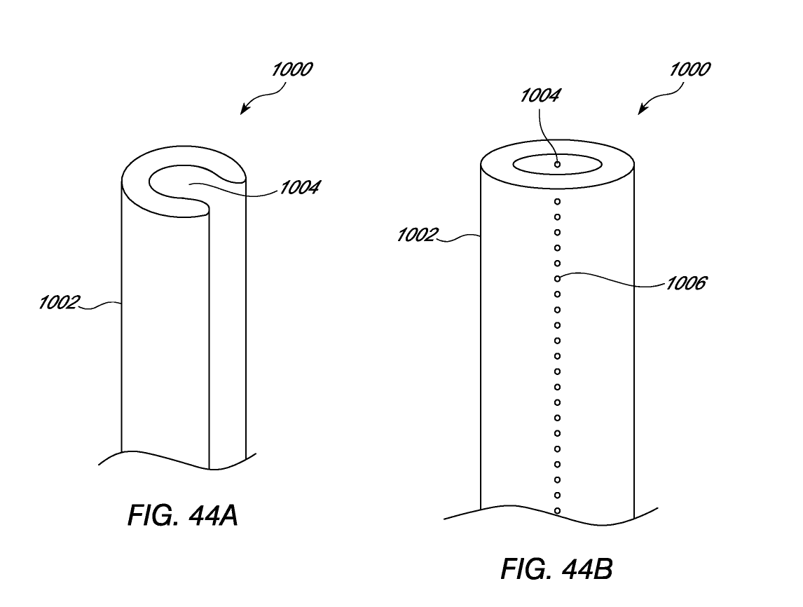

As illustrated in FIG. 44A and FIG. 44B a collector tube 1000 comprises an outer wall 1002 and an inner channel 1004. The collector tube 1000 can be any shape and made of any material appropriate for its purpose, e.g., plastics, epoxy, metal, etc.

The collector tube 1000 is configured to collect and channel permeate from a membrane element to a collection channel. As shown in FIG. 44B, the collector tube 1000 can comprise openings such as perforations, slits, or holes 1006 which allow permeate to pass from the membrane element through the outer wall 1002 into the hollow center/inner channel 1004 of the collector tube 1000.

In the embodiment shown in 44A, the collector tube 1000 is a c-shaped channel and allows permeate to pass from a membrane element into a collection channel. It will be apparent to one skilled in the art that the present invention is not limited to these embodiments but rather encompasses any size and configuration of collector tubes 1000 capable of allowing the flow of fluid from a membrane element to a collection channel.

The footprints of the systems of preferred embodiments are a function of desired capacity, membrane height and the space between membrane elements. For seawater applications, assuming that the membrane elements are spaced at ¼ of an inch (6.35 millimeters), and the membranes are 40 inches (1 meter) tall, for every 1,000 square feet (93 square meters) of membrane cartridge footprint area, the system can produce about 400,000 gallons per day (about 1.6 million liters per day), assuming a flux rate of about 1.5 gpfd (about 61 liters per square meter of membrane per day). Membrane modules can be stacked at depth to further reduce the footprint. If the membrane systems are deployed in an area where water currents are significant, the modules can be more closely stacked than in those areas where water currents are minimal, as the significant currents will facilitate mixing and moving of the concentrate exiting from the top module, thereby equalizing the salinity with ambient seawater within a short distance below the top module. In the absence of significant currents, it can be desirable to provide a system for facilitating mixing and moving seawater across the membranes, e.g., bubblers, jets, or the like.

Any suitable membrane configuration can be employed in the systems of preferred embodiments. For example, one such configuration employs a central collector with membrane units or cartridges adjoining the collector from either side. Another configuration employs membrane units in concentric circles with radial collectors moving the potable water to the central collector.

### Depth of Membrane Modules

In the seawater applications, the membrane modules of preferred embodiments are preferably submerged to depths sufficient to produce desired permeate water by ambient pressure of the seawater against the membrane without application of additional pressure. Such depths are typically of at least about 194 meters, preferably at least about 259 meters. However, depending on the application, the systems of preferred embodiments can be deployed at other depths. The 259 meters depth is preferred for seawater reverse osmosis to produce potable water from seawater of average salinity (e.g., about 35,000 mg/L). If a level of brackishness is permissible (e.g., for water used for irrigation or industrial processes), a shallower depth can be employed. For example, production of brackish water suitable for irrigating agriculture can be achieved with certain membranes submerged to a depth of from about 100 meters to about 247 meters. An acceptable level of brackishness can be selected by selecting the type (e.g., chemistry) of membrane and the depth of the membrane module depending upon the salinity of the ambient seawater. Systems of preferred embodiments utilizing nanofiltration membranes, for example, can be deployed in the ocean at about 43 meters of depth to screen out about 20% of the salinity of the feed water, and also to remove calcium and many other unwanted constituents. Such systems can be employed as offshore pre-treatment systems for onshore desalination plants, expanding the capacity of existing plants and reducing maintenance as well as overall energy requirements by about 50% as compared to standard onshore reverse osmosis plants. Systems of preferred embodiments utilizing ultrafiltration (UF) and/or microfiltration (MF) membranes can also be employed in connection with conventional desalination plants or industrial applications that are not proximate to oceans or other bodies of water of greater depths. Systems of preferred embodiments can be configured for use with industrial applications where the presence of calcium or other undesirable constituents present problems (e.g., corrosion or scale buildup), such as power plant cooling applications. Suitable RO and NF membranes for use with preferred embodiments are available commercially from Dow Water Solutions, Midland, Mich., and from Wongjin Chemical of South Korea (formerly Saehan Industries, Inc.).

In certain embodiments, systems can be configured for deployment at shallower depths. For example, embodiments can be deployed in shallow ocean waters (for example, at a depth of about 7 meters) and used as low-velocity ocean water intake systems, for example to produce cooling water for an onshore power plant. Such low-velocity intake systems advantageously avoid harming sea life. Such systems can also employ filter fabrics or screens in place of less porous membranes.

In addition, systems of preferred embodiments employing microfiltration, ultrafiltration, or nanofiltration membranes can be positioned in surface waters and reservoirs at depths as shallow as 6 meters and can be configured to filter out bacteria, viruses, organic matter, and inorganic compounds from the source water. For example, systems employing nanofiltration membranes can be positioned at a depth of about 6 to 30 meters or at any other appropriate depth, depending upon the total dissolved solids to be removed and the desired quality of the product water. Systems of preferred embodiments including microfiltration, ultrafiltration, or nanofiltration membranes can also be adapted to produce clean water from a contaminated water supply and configured for placement in ground wells. In freshwater sources with very low levels of dissolved solids, the osmotic pressure of the source water is a less significant factor in the filtration process (generally, every 100 mg/L total dissolved solids in the source water requires 1 pound per square inch (approximately 6.9 kPa) of pressure). Consequently, the transmembrane pressure losses of the membranes become more dominant in determining the required depth for the desired level of treatment.

In certain embodiments, an induced water column can be used to provide pressure to drive the filtration process. Where a stream or river does not have the necessary depth, it can be diverted into an artificial vessel similar to a large, deep pool. The DEMWAX™ water filtration system can be situated in the pool. The pool maintains the flow-through nature of the original water source by flowing the excess water back into the existing river or stream, or into a new location (e.g., diverted for irrigation purposes). Thus, the impurities screened out by the membranes can remain where they were naturally, e.g., in the river or stream. The amount of impurities returned to the river or stream are typically sufficiently small such that their return does not significantly alter the chemistry of the body of water from its natural state. The systems employed in such applications typically necessitate diverting an excess of water; however, the gravity flow of the original water source typically eliminates the need for much (if any) artificial pumping energy. Membrane modules can also be situated within pressure vessels or tanks. A water column can be induced by pumping source water into the tank. In the case of streams that have significant elevation changes (mountainous area), the water can be directed to flow into a feed tank situated at a preselected height above the pressure tank with the modules to induce the desired water column height.

It is preferred to situate the DEMWAX™ water filtration module at a sufficient distance from the floor of the water source so as to avoid membrane fouling by silt, sediments, and other suspended solids typically present at higher concentration near the floor of water bodies. Preferably, the seawater DEMWAX™ water filtration module is situated at least a couple hundred feet from the ocean floor; however, in certain embodiments it can be acceptable to situate the DEMWAX™ water filtration module at depths closer to the ocean floor.

Likewise, if it is desirable to employ the system at a location wherein the ocean is shallow such that a depth of 259 meters cannot be attained (e.g., certain locations proximate to shore), in such preferred embodiments a two-pass system can be employed. By submerging a nanofiltration membrane to shallower depths (e.g., about 152 meters), the systems of preferred embodiments can produce brackish water at about 7,000 ppm salinity. Such brackish water can then be subjected to another reverse osmosis process (e.g., on land, on a platform offshore, or at any other suitable location) at a substantially lower total operating cost than conventional reverse osmosis systems to achieve potable water. Alternatively, the floor of the body of water can be excavated to provide a cavity, chamber or passage permitting situating the membrane module at a desired depth.

In preferred embodiments, the first pass of a two-pass process uses a DEMWAX™ water filtration system with nanofiltration membranes to produce water with an appropriate reduction in salinity. The reduced salinity water is pumped to the shore, where it is subjected to a second pass filtration process to reduce dissolved ion concentrations to those characteristic of potable levels with an approximate 80% recovery rate. The second pass filtration process can employ a conventional spiral wound reverse osmosis or nanofiltration membrane system. The brine generated by this process is as saline as or slightly less saline than the original seawater. Thus it can be disposed of (e.g., back into the ocean) without the environmental concerns associated with the more highly saline brine generated in conventional land-based reverse osmosis systems that can be nearly twice as saline as the original seawater. The two-pass process is also more energy efficient than conventional land based desalination. It only consumes about 7.5 kWh per kgal (about 2 kWh per cubic meter) total for both passes of the process (a first pass through a DEMWAX™ water filtration system at a 500 foot depth and six miles offshore, and a second pass onshore in a conventional desalination process), in contrast to state of the art onshore reverse osmosis plants consuming over 16 kWh per kgal (about 4.2 kWh per cubic meter) or more. Such a system can be used to advantage in, for example, the Red Sea, to produce cleaner feed water (that is, feed water of lower salinity and lower concentration of other undesirable constituents such as calcium) for an existing conventional on-shore RO desalination system, improving efficiency and lowering maintenance costs of the system.

Different seawaters possess different salinities (e.g., the salinity of the Red Sea (40,000 ppm) is higher than the North Atlantic (37,900 ppm), which in turn is higher than the Black Sea (20,000 ppm)). The salt content of the open oceans, free from land influences, is rarely less than 33,000 ppm and seldom more than 38,000 ppm. The methods of preferred embodiments can be adjusted or modified to accommodate seawater of different salinities. For example, the preferred depth for submerging the DEMWAX™ water filtration systems of preferred embodiments is deeper in more saline water (e.g., Red Sea), and is shallower in less saline water (e.g., Black Sea). The depths referred to herein are those preferred for water of average salinity (33,000 to 38,000 ppm, preferably about 35,000 ppm), and can be adjusted to accommodate higher or lower salinity water.

### Spacing Algorithm

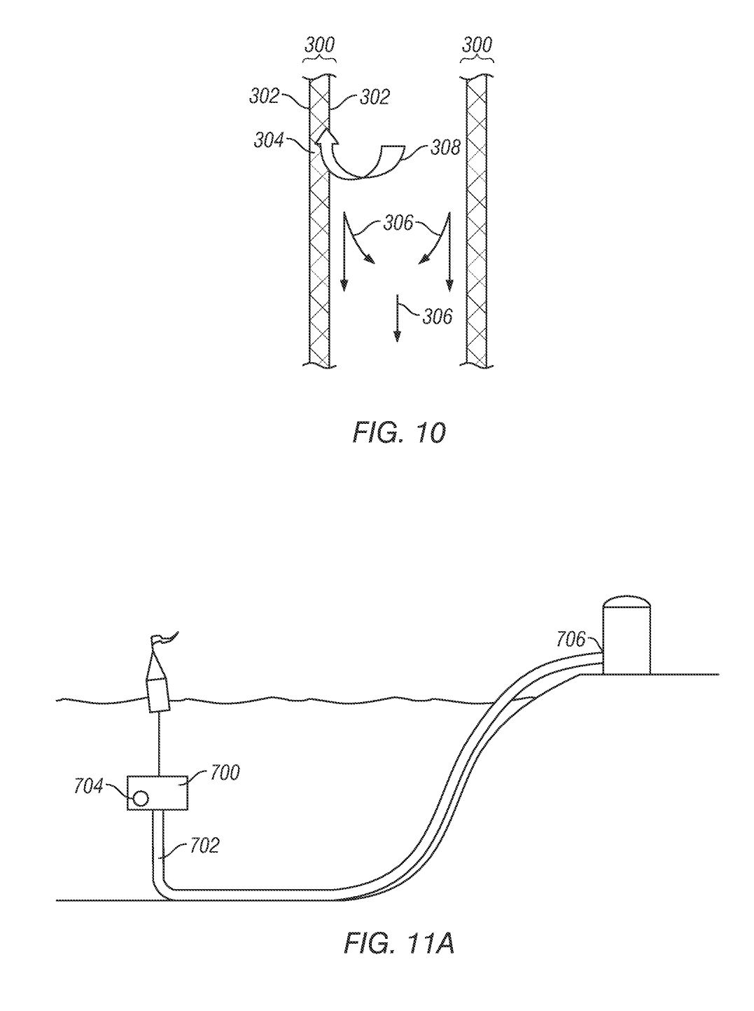

The membrane elements are preferably spaced at a distance that allows the free flow of raw water therebetween, and in the case of high dissolved solids (i.e. seawater), that approximately maintains the osmotic pressure of the feed water throughout the space between the membrane elements. The flow of permeate, feed, and generated concentrate (e.g., brine) in a DEMWAX™ water filtration membrane module of a preferred embodiment is depicted in FIG. 10, which shows two spaced-apart membrane elements 300. Each membrane element 300 comprises two membranes sheets 302 spaced apart by a permeate spacer 304. As discussed above, the space allowed for raw water flow between membranes in conventional desalination pressure vessels is extremely small. The systems of preferred embodiments preferably employ larger spacings to facilitate seawater or other raw water to flow naturally to the membrane surfaces 302 using gravity to draw the higher density saltwater generated at the surfaces down, as indicated by the arrows 306, thereby drawing the ambient-salinity seawater from above. The faster the current to which the membranes 302 are exposed, the faster the concentrate is disposed, allowing greater volumes of feed water to contact the membranes 302. The arrow 308 indicates permeate water penetrating the membrane. The systems of preferred embodiments can also be configured to operate in water with no current, utilizing convection flow generated by denser concentrate pulled downward by gravity.

To maximize plant output per unit of plant ‘footprint’, closer spacing is typically preferred. An algorithm has been developed that takes into consideration several parameters in determining the preferred spacing of the membrane elements, depending upon the conditions present.

The exogenous variables used to determine the preferred spacing include membrane element height, concentrate velocity, flux, recovery, and raw water spacer volume (if any). The distance between the top and the bottom of the membrane element determines how far the brine falls before meeting regular seawater. With no change in velocity, flux or recovery, a taller element is preferably spaced further from a neighboring element than a shorter element. As potable water penetrates the membrane, the remaining brine is heavier due to its higher salinity and gravity causes the heavier brine to fall, drawing more original seawater down from the top of the system. The amount of freshwater that penetrates each unit of membrane surface area varies depending on the flux of the system. Flux is typically measured as gallons of permeate per day per square foot of membrane surface area (or, alternatively, as liters of permeate per day per square meter of membrane surface area), and the higher the flux, the less membrane surface is required per unit of permeate capacity. Flux rates can vary according to membrane materials, seawater salinity and depth (pressure). The percentage of water that is exposed to the membranes that actually penetrates is referred to as the rate of ‘recovery.’ While high recovery rates (on the order of 30% to 50% or more) are typically critical to commercial viability in conventional onshore desalination plants, they are typically only of minor significance in the systems of preferred embodiments. At a 50% recovery rate for an onshore plant, the system must treat, pressurize, or otherwise process twice the volume of saltwater than freshwater produced. The systems of preferred embodiments do not require mechanically produced pressure, feed water pre-treatment or brine disposal as in conventional land-based water treatment and desalination systems, thus a high recovery rate is of lesser significance. According to some embodiments, a lower recovery rate is desirable, as a higher the recovery rate results in higher-salinity feed water contacting the lower portions of the membrane elements. The estimated recovery rate for the seawater DEMWAX™ water filtration systems of preferred embodiments is about two percent (2%). The higher the recovery, the less water that must be exposed to the membrane surface. If a raw water spacer is used, its volume must be considered in the determination of the spacing of the membrane elements.

The membrane spacing algorithm employed in configuring selected systems of preferred embodiments is specified below. While membrane spacings according to this algorithm are particularly preferred, any suitable spacing can be employed.

$$S = \frac{FH}{kRV}$$

wherein S is the space between membrane elements measured in millimeters (or inches); F is the flux of the system measured in liters per square meter per day (or gallons per square foot of membrane surface area per day); H is the height of the membrane elements in meters (or inches); R is the recovery (% of water flow exposed to membranes); V is the velocity of the falling brine between the elements measured in meters per minute (or feet per minute); and k is a constant which is equal to 720 (when flux is measured in liters per square meter per day, height is measured in meters, and velocity is measured in meters per minute) or 5,386 (when flux is measured in gallons per square foot per day and height is measured in inches and velocity is measured in feet per minute).

Thus, for a 36 inch (in height) membrane element with a two percent recovery and flux of two gallons per square foot per day with brine falling at three feet per minute, a preferred spacing is 0.223 inches.

$$0.223 = \frac{2 \times 36}{5 , 386 \times 0.02 \times 3}$$

If a raw water spacer is employed, for example, to maintain structural integrity when the ambient conditions (water currents, etc.) result in disturbance of the membranes, the volume of the spacer preferably proportionately increases the spacing between membrane elements. For example, if a spacer occupies 20% of the volume between membrane elements, the distance between membranes is increased such that the volume between the membranes is increased by 20%.

### Breathing Tube and Holding Vessel

In order for the water to flow through the membranes, a pressure differential across the membranes must be maintained. Preferably, this is accomplished by evacuating the holding vessel with a submersible pump or dry well pump and exposing the vessel to atmospheric pressure using a breathing tube. The preferred approximate size of a breathing tube for use in a five million gallon (nineteen thousand cubic meters) per day module is five inches (12.7 centimeters) in diameter; however, other suitable sizes can be employed. The breathing tube can be fabricated from any suitable material. For example, the breathing tube can be constructed from a polymer, metal, composite, concrete, or the like. The breathing tube is configured to withstand the hydrostatic pressure to which it is exposed during operation without collapsing. Structural integrity can be provided by the material itself, or through the use of reinforcing members (ribs on the interior or exterior of the tube, spacers inside the tube, or the like).

In a preferred embodiment, a breathing tube is connected to the holding vessel under water. One or more submersible pumps, dry well pumps, or the like can be situated in the holding vessel, which can be provided a pipeline to convey the water to its intended destination (e.g., a larger storage vessel). The preferred size of the holding vessel is a function of the pump operational requirements.

### Pumping Energy

The systems of preferred embodiments efficiently use hydrostatic pressure at depth instead of pumps to power the reverse osmosis filtration process, and thus do not require the vast amounts of energy needed in conventional land-based desalination systems. The systems of preferred embodiments employ pumping systems to pump the product water generated to the surface and then to the shore, but such energy requirements are substantially lower than those required to desalinate water in land-based systems. Given the head pressure at depth, far more energy is typically needed to pump water to the surface than to pump water from the surface to the shore. For systems of preferred embodiments employing conventional reverse osmosis polyamide membranes, an operating depth of 850 feet is employed to produce potable water from seawater. For other membrane chemistries or when purifying water of different salinities (freshwater, brackish water, extremely saline water), lower depths or higher depths may be required to obtain water of the same reduced salt content.

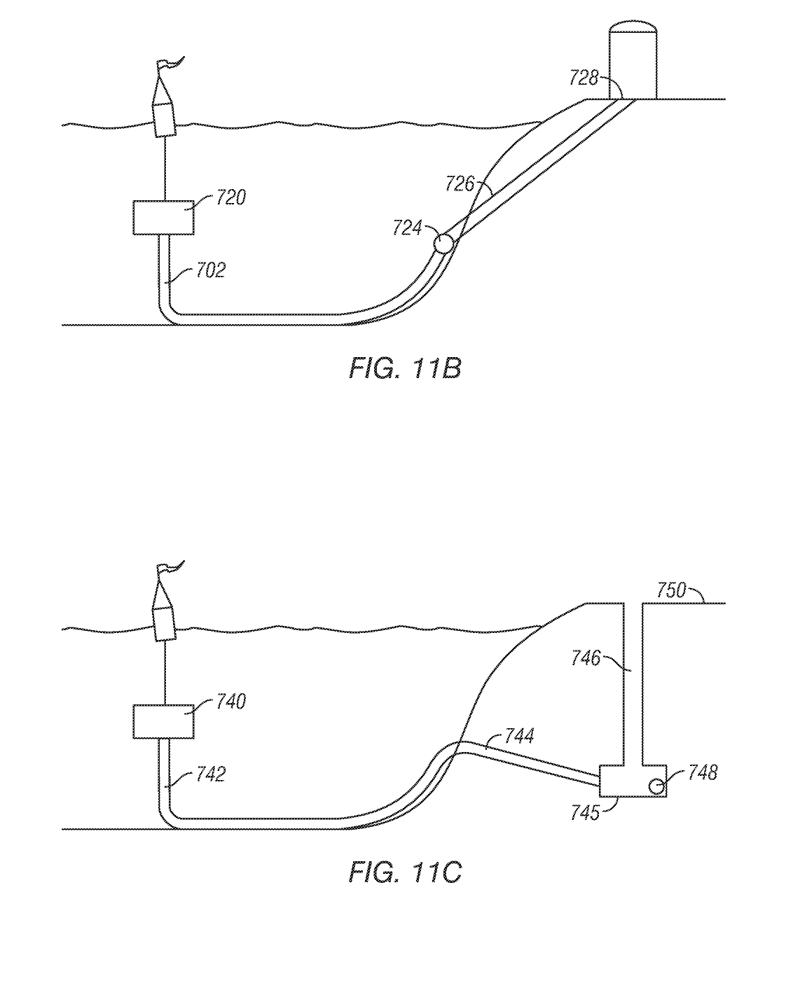

FIGS. 11A through 11C illustrate various configurations for pumping permeate to shore from an offshore DEMWAX™ water filtration system. FIG. 11A shows a DEMWAX™ system 700 suspended at depth. The system 700 includes one or more membrane modules (or arrays of modules) and a collection system exposed to atmospheric pressure via a breathing tube, as described herein. The system 700 is connected to a permeate pipe 702, which can include flexible and/or rigid portions. The permeate pipe 702 can extend from the suspended system 700 down to the ocean floor, then run across the ocean floor and up to shore. The suspended system 700 also includes a pump 704 configured to convey permeate through the pipe 702 and up to shore. Because the collection system in the suspended system 700 is held at atmospheric pressure, the head pressure that the pump 704 must overcome to pump the permeate up to shore in this configuration is a function of the vertical distance between the suspended system 700, the elevation of the permeate pipe outlet, and the system headloss of the pipeline connecting the treatment system to the shore 706.

FIG. 11B shows another DEMWAX™ water filtration system 720 suspended at depth. The system 720 includes one or more membrane modules and a collection system exposed to atmospheric pressure via a breathing tube, as described herein. The system 720 is connected to a permeate pipe 702, which may comprise flexible and/or rigid portions. The permeate pipe 702 can extend from the suspended system 720 down to the ocean floor, then run across the ocean floor and partway up to shore. The permeate pipe 702 enters a tunnel 726 at a location vertically below the suspended system 720. Because the collection system in the suspended system 720 is held at atmospheric pressure, and because the pumping is done from a location vertically below the suspended system 720, the suspended system 720 need not include a permeate pump to transfer the permeate to land. A pump 724 can instead be provided where the permeate pipe 702 enters the tunnel, to pump the permeate up to the surface 728.

FIG. 11C shows another DEMWAX™ water filtration system 740 suspended at depth. The system 740 includes one or more membrane modules and a collection system exposed to atmospheric pressure via a breathing tube, as described herein. The system 740 is connected to a permeate pipe 742, which can include flexible and/or rigid portions. The permeate pipe 742 can extend from the suspended system 700 down to the ocean floor, then run across the ocean floor and partway up to shore. The permeate pipe 742 enters the land at a location vertically below the suspended system 740, at the top of a tunnel 744 which leads to a wet well 745. An access shaft 746 extends from the ground surface 750 down to the wet well 745. Because the collection system in the suspended system 740 is communicated with atmospheric pressure, and because the permeate pipe 742 terminates at a location vertically below the suspended system 740, the suspended system 740 need not include a permeate pump to transfer the permeate to land. In addition, because the permeate pipe 742 enters the land at a location vertically above the well 745, no pump is required at the point of entry into land. The system 740 need only be suspended a short distance (for example, a foot or two (about a third of a meter)) vertically above the well 745 to transport permeate to shore without the use of a pump. A pump 748 can instead be provided in the wet well 745 to pump the permeate up to the surface 750 via the access shaft 746. One advantage of this system is that all moving parts (i.e. pumps) are easily accessible on land or below the earth rather than offshore and at depth.

As discussed above, the systems of preferred embodiments offer substantial energy savings over conventional land-based seawater desalination systems. For example, the energy to bring freshwater from 850 feet below the sea to the surface and the energy to pump the water six miles to shore is calculated as follows, and shows that the vast majority of the energy requirement is in bringing the water to the surface:

$$HP = \frac{HF}{pE}$$

wherein HP=Horsepower; H=Total dynamic head in feet; F=Water flow in gallons per minute; p=Pumping constant=3,960 (for head in feet and flow in gpm); and E=Pump efficiency (assumed at 85% which is typical for large pumps).

To pump five million gallons of potable water per day (or 3,472 gpm) (about 18.9 million liters, or 13,144 liters per minute) to the surface, the horsepower is calculated as follows:

$$HP = \frac{850 feet \times 3 , 472 gpm}{3960 \times 0.85} = 876.8$$

As the desalination industry typically compares system efficiencies using the units of kilowatt-hours per thousand gallons (or kWh per cubic meter), the horsepower is converted to kilowatts using the conversion factor 0.745 kilowatts per horsepower:

876.8 horsepower×0.745=653.2 kilowatts

Thus, 653.2 kilowatts will power a pump with the capacity of 3,472 gallons per minute (5 million gallons per day, 18.9 million liters per day, or 13,144 liters per minute). The energy consumed over that period is 15,677 kilowatt-hours. The ratio of the energy requirement to the water pumped yields a value of 3.14 kilowatt-hours per thousand gallons.

To pump the water to shore, the energy requirement is calculated as follows. The same formula as above is used, but a design value of six feet (1.83 meters) of head pressure loss for each 1,000 feet (305 meters) of horizontal distance is assumed. Assuming a six mile run (9,656 meters), that is equivalent to 190 feet (58 meters) of head loss (5.28 thousand feet per mile×six miles×six feet=190 feet; (9,656 meters+305 meters)×1.83 meters=58 meters). Under these assumptions, an additional 196 horsepower (146 kilowatts) of pumping power is required to pump the water to shore.

$$HP = \frac{190 feet \times 3 , 472 gpm}{3960 \times 0.85} = 196$$

Converting horsepower to energy yields a 146 kilowatt energy requirement. A 146 kilowatt load for 24 hours (3.506 megawatt-hours divided by the five million gallons) yields an energy consumption of 0.70 kilowatt-hours per thousand gallons.

In addition to the pumping energy, the systems of preferred embodiments typically have station and maintenance energy loads estimated at 5% of the pumping power needs. For example, the total energy use for one system of preferred embodiments is provided in Table 1.

TABLE 1

| | Kilowatt-hours per |
|---|---|
| | Thousand Gallons |
| Energy Use | (kWh per Cubic Meter) |
| Pump energy to surface | 3.14 (0.83) |
| Pump energy to shore (6 miles) | 0.70 (0.18) |
| Ancillary energy (5% of pump energy) | 0.19 (0.05) |
| Total energy use | 4.03 (1.06) |

This total energy requirement of just four kilowatt-hours per thousand gallons (about 1.1 kWh per cubic meter) is substantially lower than that of state-of-the-art reverse osmosis systems, which typically consume over sixteen kilowatt-hours per thousand gallons (over 4 kWh per cubic meter). For example, the Tuas desalination plant was completed in Singapore in 2005 and its contractor touts it as “one of the most efficient in the world” needing only 16.2 kilowatt-hours per thousand gallons (about 4.3 kWh per cubic meter). Even conventional water sources often require far more energy than the DEMWAX™ water filtration system for coastal populations. Table 2 provides data demonstrating the superior energy efficiency of the systems of preferred embodiments compared to those of the Tuas desalination plant and two major water resources for a well-known arid coastal region.

TABLE 2

| | Kilowatt-hours per | |
|---|---|---|
| | Thousand Gallons | |
| Water Resource | (kWh per Cubic Meter) | |
| California State Water Project | 9.2 to 13.2 | (2.4 to 3.5) |
| Colorado River Aqueduct | 6.1 | (1.6) |
| Tuas Desalination Plant | 16.2 | (4.3) |
| DEMWAX ™ Sea-Well System of the | 4.0 | (1.1) |
| embodiments disclosed herein | | |

Advantages of DEMWAX™ Water Filtration Systems Disclosed Herein

The DEMWAX™ water filtration systems disclosed herein offer numerous cost advantages over conventional water resources and more specifically over conventional water treatment and desalination technologies. For example, conventional reverse osmosis systems require relatively high operating pressures (on the order of 800 psi (5,516 kPa)) to produce potable water. The DEMWAX™ water filtration system disclosed herein does not require energy to pressurize feed water. As natural pressure at depth is used in the DEMWAX™ water filtration systems disclosed herein, there is no need for pumps to create it artificially.

No source water handling as in conventional water purification or desalination systems is required in the systems of preferred embodiments. As conventional desalination processes take in feed water and then dispose of brine which has twice the salinity, the components of the systems must be engineered to withstand the corrosive effects of the saltwater and brine. The systems of preferred embodiments do not require that any feed water be handled. Only the membranes and casings are exposed to feed water, thus the components are much less expensive to manufacture because special corrosion-resistant materials are not required for transporting source water and brine or concentrate, they require less maintenance, and they have a longer life. In conventional desalination plants the materials used to withstand the corrosive effect of salt exposure are far more expensive to manufacture than the materials used in the systems of preferred embodiments. Also, given the approximate 50% yield of conventional reverse osmosis systems, two gallons of saltwater must be handled for each gallon of freshwater produced. In the systems of preferred embodiments, by comparison, only the single gallon of freshwater must be handled. No special intake and pre-treatment systems are employed in the systems of preferred embodiments. Seawater intake systems in conventional reverse osmosis plants are near the shore and surface and, therefore, take in much suspended matter including organic material. This material contributes to membrane fouling and compaction requiring maintenance and reduction in membrane life. In certain embodiments, DEMWAX™ water filtration membranes disclosed herein are deployed at depths where reduced light minimizes organic growth. This also obviates the need for pre-treatment systems that screen out the larger solids and organic materials.

No brine or concentrate disposal system is employed in the systems of preferred embodiments operated at depth to produce product water. When the systems of preferred embodiments are employed to generate brackish water at a shallower depth to be further purified in a second process, brine generation is significantly lower than in conventional desalination processes. Likewise, when the systems of preferred embodiments are employed to generate potable water at depth in a one step process (or even two or more step process), brine generation is also significantly lower. Disposing the brine byproduct of conventional reverse osmosis processes has a detrimental environmental impact. Disposal of concentrated brine endangers sea life at the point of disposal. Often, environmental authorities require reverse osmosis plants to dilute the brine with more seawater, at additional cost, before returning it to the ocean, adding another significant component, and thus expense, to the plant.

The systems of preferred embodiments do not have significant land requirements, in contrast to the typical large utility-scale plants that require large tracts of land near the shore in populated areas, which are necessarily expensive. The systems of preferred embodiments typically do not require any land, aside from that necessary to provide access to the water generated, or, in certain embodiments, to provide mixing facilities inland if the water must be additized prior to distribution (e.g., chlorination, fluoridation, etc.). Storage tanks to buffer the continuous production against the variable intra-day demand can be large; accordingly, supply buffering is preferably provided by underwater, flexible tanks tethered offshore. These obviate the need for the large rigid onshore tanks and attendant highly engineered foundations; however, the systems of preferred embodiments can be employed with onshore tanks, where desirable (e.g., with existing tanks). Likewise, in certain embodiments it can be desirable to not employ tanks of any kind. Any excess water generated can be discarded, or the entirety of the water produced can be employed as it is generated. An advantage of such a configuration is reduced equipment expense.

Other benefits of the systems of preferred embodiments include the capacity for constant production. The temperature of water affects the flux (rate at which water penetrates the membrane). As near surface water collected for conventional desalination plants varies in temperature throughout the year, conventional reverse osmosis plant output is also variable. The DEMWAX™ water filtration system disclosed herein does not suffer from such fluctuating output since the deep waters to which the membrane is exposed are typically at a relatively constant temperature regardless of the season or weather conditions on the surface.

The systems of preferred embodiments offer superior flexibility when compared to conventional land-based plants. Such conventional plants can be considered hard assets on land that can incur greater risk than the systems of preferred embodiments, which can be employed as a mobile asset at sea and potentially in international waters. The isolation from land and mobility allows the system to be moved to areas of greater need or greater profitability.

The systems of preferred embodiments are conducive to mobile, temporary water production on a large scale for areas affected by natural disasters such as earthquakes and tsunamis that can foul conventional potable water sources. The modular and scalable design of preferred embodiments also lends itself to very large-scale offshore applications. Also, given this modular nature, most of the costs are in the system itself rather than in situ design, engineering, construction and civil work that is subject to far more variables than the controlled factory setting in which the DEMWAX™ water filtration cartridges disclosed herein and other components are manufactured.

In addition to cost advantages, the systems of preferred embodiments have significant environmental and production advantages. Environmental advantages include zero brine creation and therefore disposal. A conventional desalination plant takes in seawater and returns about half of it back (in many cases to locations near to the shore) in the form of brine with twice the salinity. Such higher salinity brine has a detrimental impact on the sea life in the area of the disposal. Through dispersion and mixing, the brine eventually dilutes with the seawater, but because of the continuous desalination process, there is always an area around the discharge pipe of a conventional desalination system where sea life is impacted. The systems of preferred embodiments typically purify about 1 to 3 percent of the water that is exposed to the membranes, thus generating only a slightly higher concentration of seawater in the vicinity of the membranes that is far more quickly diluted by the surrounding seawater. Also, at depths of from about 500 feet to about 1,000 feet, far less sea life is present due to the lack of light.

The systems of preferred embodiments also offer significant flexibility of application. For example, systems of preferred embodiments can be employed in freshwater applications to screen out unwanted constituents such as bacteria viruses, organics, and inorganics from water supplies. For example, systems of preferred embodiments adapted for use with freshwater applications have little or no land requirement, and require no source water intake systems or special disposal of concentrate. Further, systems of preferred embodiments adapted for use with groundwater applications can prevent abandonment of contaminated groundwells, where other methods of water treatment are cost-prohibitive. Systems of preferred embodiments for treating surface, ground, or other freshwater sources offer similar advantages to systems for treating sea or saline water.

Water use has a significant environmental impact. To the extent inexpensive water from the ocean can replace the water taken out of natural water flows, such streams and rivers can be returned to their natural state, or more water can be removed upstream to provide for greater inland water needs. The Colorado River rarely spills into the Sea of Cortez in Northern Mexico due to the withdrawals upstream. The Colorado River Aqueduct provides 1.2 billion gallons (4.5 billion liters) of water a day to Southern California. Twelve desalination systems of preferred embodiments each capable of generating 100 MGD (about 378 million liters per day) can replace the Southern California allotment from the Colorado River.

Energy and water are intimately connected. Vast amounts of energy are used in pumping water to the point of use. The systems of preferred embodiments are much more energy efficient than either conventional desalination plants, or water projects such as the Colorado River Aqueduct and the California State Water Project. As such, the increased efficiencies result in lower energy consumption. As most power generation emits greenhouse gases (e.g., coal fired plants), lower unit energy use for water lowers greenhouse gas emissions proportionately.

An added advantage of the systems of preferred embodiments is that conventional and inexpensive technology and materials can be employed in many components of the systems, for example, membrane materials such as polyamides, HYPERLON™-type material for tanks and tubing for water, polyvinylchloride (PVC) for membrane module casings and holding tanks, conventional submersible pumps or dry well pumps, conventional power generation equipment (e.g., engines, turbines, generators, etc.), and conventional platforms (concrete or other materials as are typically employed in offshore platforms, e.g., in the oil production industry) can be employed. Also, membrane materials used in the systems of preferred embodiments typically have a longer life than those employed in conventional reverse osmosis systems, due to lower flux rate and lower operating pressure; thus, lower maintenance and material costs can result. Platforms or buoys employed to support the membrane modules can conveniently be constructed at low cost from pre-stressed concrete, and can be manufactured in a modular format so that they can be mass produced and configured to a specific project by combining various modules (e.g., suspension modules; power generation modules; fuel storage modules; control room modules; spares storage modules; etc.).

Construction of large infrastructure projects such as desalination or power plants typically occurs largely on site. Consequently, schedule and work flow sequence issues as well as site specific engineering add significantly to complexity and costs of construction as compared to common assembly line manufacturing. In contrast, the systems of preferred embodiments can be constructed at a convenient location off site and transported to the desired location for deployment.

The floating platforms that can be employed in systems of preferred embodiments are mobile and can be produced in a few locations in the world and transported to the location needed. Alternatively, stationary platforms constructed on the seabed can be utilized. The systems of preferred embodiments can be connected to existing land-based water systems, e.g., by using short pipe runs beneath the seafloor and trenching for several hundred yards in a near-shore environment.

### Membrane Module

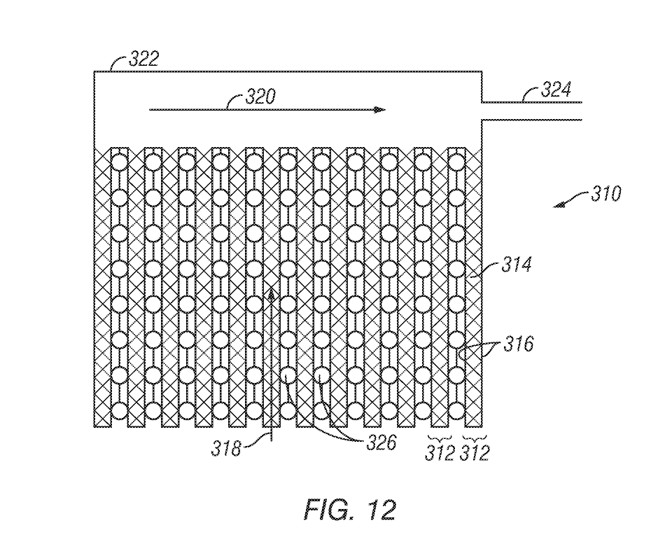

FIGS. 12 to 15 depict various configurations for DEMWAX™ water filtration systems of preferred embodiments. FIG. 12 shows a basic diagram (not to scale) of an exemplary DEMWAX™ membrane module 310 in plan view, illustrating membrane elements 312 having rigid permeate spacers 314. The rigid spacers 314 maintain the membrane faces 316 separated at depth pressures, facilitating collection of fresh potable water (permeate) from between the opposing membrane faces 316 of each membrane element 312. The flow of permeate is indicated by arrows 318, 320. Seawater (saltwater) circulates freely in the spaces between the membrane sheets 312. A rigid PVC casing 322 at one end of the membrane sheets 312 collects permeate and transfers it to a pipe 324 in fluid communication with a collection system. The membrane sheets 312 are maintained in a spaced configuration by optional saltwater spacers 326, which are placed between membrane sheets 312 on the raw feed side.

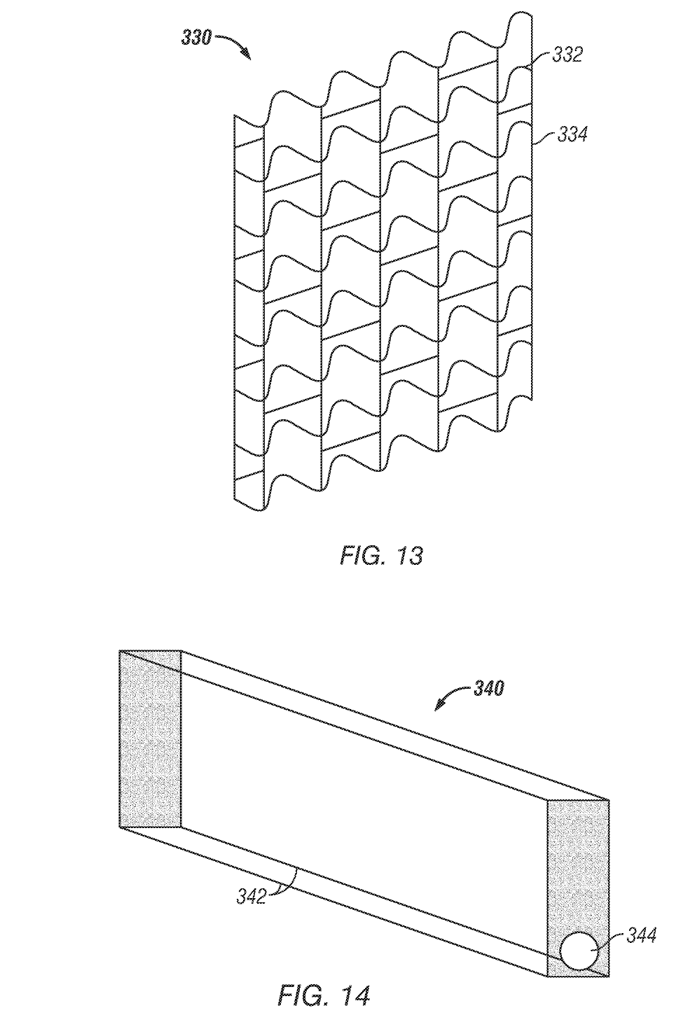

FIG. 13 depicts corrugated woven plastic fibers 330 having corrugated elements 332 and straight elements 334. These fibers are suitable for use as spacers between the membrane units for maintaining sufficient space for the raw water to flow.

FIG. 14 shows a basic diagram (not to scale) of a collector element 340 for use with the DEMWAX™ water filtration systems disclosed herein. Horizontal studs (not depicted) are employed to provide structural integrity to the collector element 340 when exposed to pressures at depth, while permitting permeate to flow through the collector 340. Depending upon the material employed in the construction of the collector element, studs (horizontal, vertical, or other configuration, or monolithic or other porous interior support) may be omitted (e.g., when a high strength material capable of withstanding pressures at depth is employed). The collector element 340 can have sides 342 which are slotted to allow for attachment of membrane cartridges or elements, as well as a connector pipe 344 configured for attachment to a collection system.

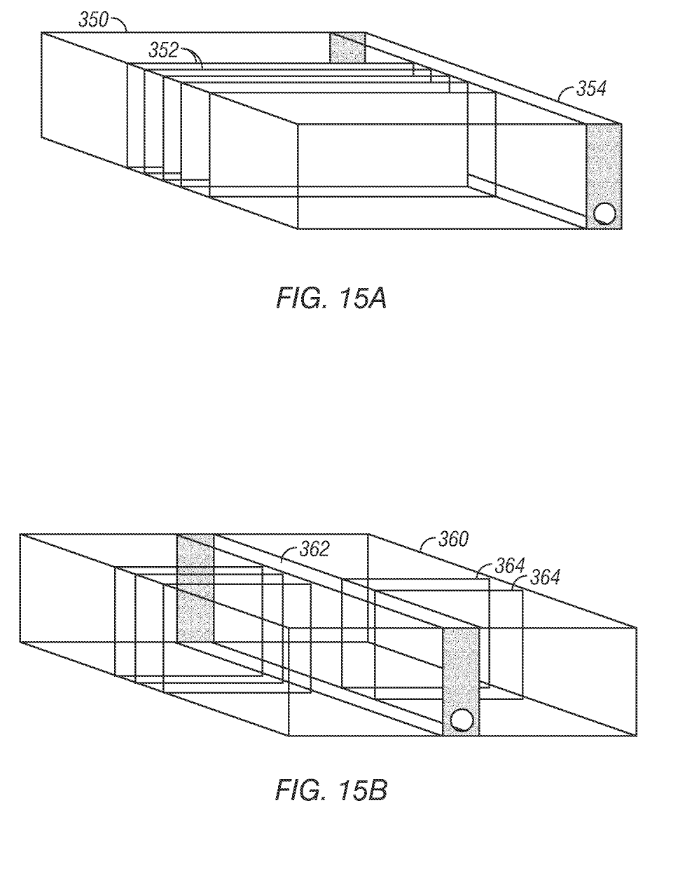

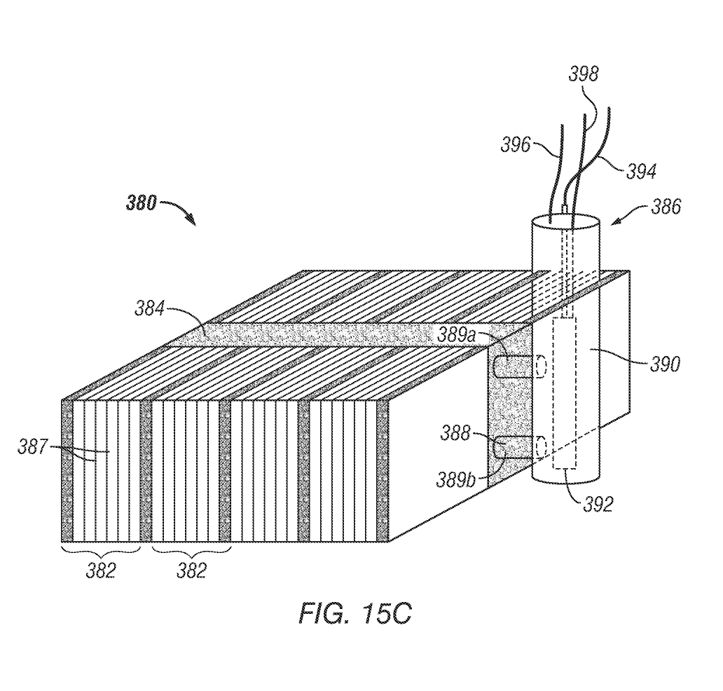

FIG. 15A shows a basic diagram (not to scale) of a casing element 350 for use with the DEMWAX™ water filtration systems disclosed herein. Membrane units or elements 352 are attached at one end to a collector element 354. The casing 350 maintains the membranes 352 in a spaced apart loose lattice, which maintains structural integrity of the membranes 352, spacing of the membranes 352, and free flow of seawater to the membranes 352.

FIG. 15B provides a view of a membrane module 360 for a central collector element 362 with membranes 364 attached on two sides of a central channel. FIG. 15C shows a membrane module 380 according to a further embodiment, with cartridges 382 coupled to a collection channel 384 having an internal channel 388 extending therethrough. Each cartridge 382 can include multiple membrane units 387. The internal channel 388 is separated from the source water but in fluid communication with the permeate side of the membrane units 387. The collection channel 384 is fluidly connected, via outlets 389(a), 389(b), to a wet well portion 390 of the holding tank 386. Providing two outlets 389(a), 389(b) between the collection channel 384 and the wet well 390 allows for release of trapped air during filling of the internal channel 388. A pump 392 can be provided in the wet well portion 390 and configured to pump permeate through a permeate pipe 394 to offshore or onshore storage. The holding tank 386 is exposed to atmospheric pressure by a breathing tube 396. A power cable 398 can also be provided and connected to an offshore or onshore power generation facility to power the pump 392.

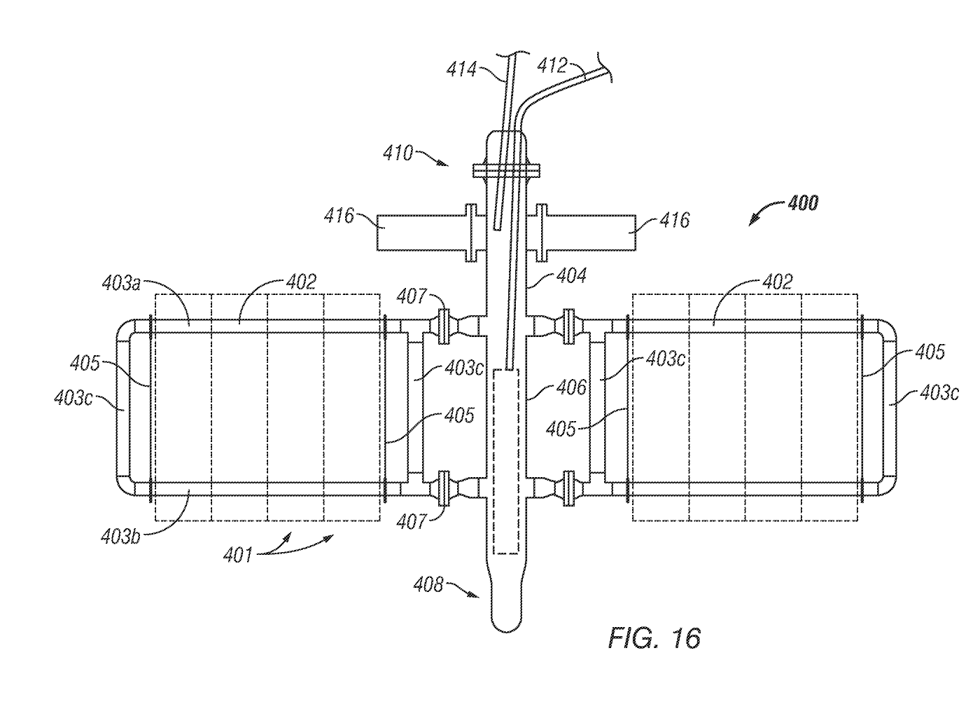

FIG. 16 illustrates a collector system 400 configured according to a preferred embodiment. The system 400 includes two wings 402 comprising pipes or tubes which are formed, bent, connected, or otherwise configured in a frame-like shape to form a collection channel. The placement of membrane cartridges 401 on the wings 402 is illustrated with dashed lines. The top and bottom portions 403(a), 403(b) of the wings 402 can be perforated to allow for permeate to flow from the cartridges 401 into the wings 402. The end portions 403(c) of the wings 402, however, can have solid outer walls, as these portions are exposed to source water. The wings 402 can include end plates 405 which are configured to separate the permeate side of the cartridges 401 from the source water. The wings 402 can also be provided with struts (not shown) for structural reinforcement.

Each wing 402 is fluidly connected, via one or more outlets 407, to a central channel or holding tank 404 which houses a submersible pump 406 (shown in dashed lines). A permeate pipe 412 can extend from the holding tank 404 to temporary storage or all the way to shore. The holding tank 404 can have an enclosed bottom portion 408 which extends below the wings 402. The bottom portion 408 can be configured to house sensing equipment, such as temperature sensing equipment. The holding tank 404 can also have an enclosed upper portion 410 which extends above the wings 402. A breathing tube 414 extends from the upper portion 410 to the surface of the body of water, and is configured to maintain the interior of the collection system 400 at about atmospheric pressure. The upper portion 410 can be provided with sensors (not shown) configured to sense the level of permeate stored in the collection system 400 and regulate the operation of the pump 406 according to demand for product water. The upper portion 410 can optionally include laterally-extending arms 416 configured to provide temporary permeate storage. Temporary storage can also be provided outside the collection system 410, within the path of the permeate pipe 412. The arms 416 can comprise, for example, pipe extensions off the holding tank 404. The wings 402 and the holding tank 404 can have a configuration suitable for their intended purposes. For example, the wings 402 and the holding tank 404 can have a generally circular or generally rectangular cross sectional shape. The wings 402 and the holding tank 404 can also have a continuous or variable cross section. Depending on the depth of the particular application and the conditions to which the collector system 400 will be exposed, the wings 402 and the holding tank 404 can comprise metal, PVC, or any other suitable material. By such a configuration, the collection system 400 can serve the dual functions of collecting permeate and providing the system with structural reinforcement against environmental conditions.

In some embodiments, and as described in further detail below, the wings 402 can be formed from a series of gasketed spacers disposed between each adjacent pair of membrane elements. Each spacer can include a hole that is placed in flow communication with the permeate sides of the adjacent pair of membrane elements. When the series of spacers and membranes are aligned, and compression is applied to the spacers (for example through one or more bolted connections), the spacers define a permeate conduit extending in a generally normal direction to the membrane elements themselves. As will be described in further detail below, such a permeate conduit can extend through the membrane elements themselves, or can be somewhat spaced apart from the stack of membranes.

FIG. 17A shows a partially cut away perspective view of a membrane module comprising a number of membrane cartridges 432 attached to a collection system 430. One of the cartridges 432 has been removed to better illustrate portions of the collection system 430. An end portion of the collection system 430 has also been removed to illustrate an interior channel 431 of the collection system. The collection system 430 has a top portion 434 and a bottom portion 436, and is reinforced by struts 440 extending between the top and bottom portions 434, 436. The membrane cartridges 432 are placed with their front walls 433 (see FIGS. 9A through 9H) in abutting relationship with the collection system 430, on either side of the system 430. Dowels 438 on the front ends of the cartridges 432 sit against the struts 440, allowing the free flow of permeate around the struts 440. The area between the front walls 433 of the cartridges 432 and the top and bottom portions 434, 436 of the collection system 430 is enclosed to separate the permeate side of the membranes from the ambient source water. The top and bottom portions 434, 436 are perforated to receive permeate flowing from the cartridges 432 into the interior channel 431 of the collection system 430. The permeate side of the membranes is kept at about atmospheric pressure by a breathing tube (not shown) in fluid communication with the collection system 430.

When the membrane module is submerged, ambient source water flows substantially freely through the top, bottom, and rear of each cartridge 432. The pressure differential between the source water side of the membranes and the permeate side of the membranes causes permeate to flow to the low pressure (permeate) side of the membranes. Although illustrated in a generally symmetrical configuration with cartridges on either side of a collection system, membrane modules can be configured in any other suitable configuration.

FIG. 17B shows a perspective view (not to scale) of a membrane module 450 configured according to another embodiment. The module 450 includes a number of cartridges 452 attached to a collection framework 451 comprising various interconnected pipes. The collection framework 451 includes four columns 454 situated at the corners of the framework 451. The columns 454 comprise vertically oriented pipes which are connected at two opposing sides of the framework 451 by one or more end pipes 456. At the other two sides of the framework 451, the columns 454 are connected by one or more collection channels 458. The illustrated embodiment includes two upper and two lower collection channels 458, each channel 458 having a top section 460(a) and a bottom section 460(b). Each collection channel 458 is configured to support a set of cartridges 452 and receive permeate flowing through the front walls of the cartridges 452 (that is, the ends of the cartridges abutting the collection channel 458), while preventing the flow of source water into the collection channel 458. Each collection channel 458 can include end plates 462 or other features configured to separate the permeate side of the membranes in the cartridges 452 from the ambient source water. The permeate side of the membranes is kept at about atmospheric pressure by a breathing tube (not shown) in fluid communication with the collection framework 451. The collection channels 458 can be configured substantially as described above in connection with FIG. 17A, or can have any other configuration suitable for their intended purpose. For example, the collection channels 458 can comprise a series of gasketed spacers disposed between adjacent membrane elements, each spacer having a hole that is placed in flow communication with the permeate sides of the membrane elements. The spacers (and the holes provided therein) can define the collection channels 458. By employing such a system of interconnected channels and/or pipes, the collection framework 451 can serve the dual functions of storing permeate and providing the system with structural reinforcement against environmental conditions. One or more pumps (not shown) can be provided in one or more of the columns 454, or anywhere else in the system, to pump the collected permeate to the surface.

The framework 451 can also include one or more reinforcing members 464 configured to provide additional structural support to the module 450. The reinforcing members 464 can be disposed between the columns 454 and the end pipes 456, as shown in the figure. Additionally or alternatively, reinforcing members can be disposed between the end pipes 456 and the collection channels 458, between two or more columns 454, between two or more collection channels 458, and/or in any other suitable configuration. The reinforcing members can comprise solid members, or can comprise hollow pipes to form part of the collection system and provide additional storage within the system. A walkway 466 can optionally be attached at the center of the framework 451 to provide access during construction and maintenance of the module 450.

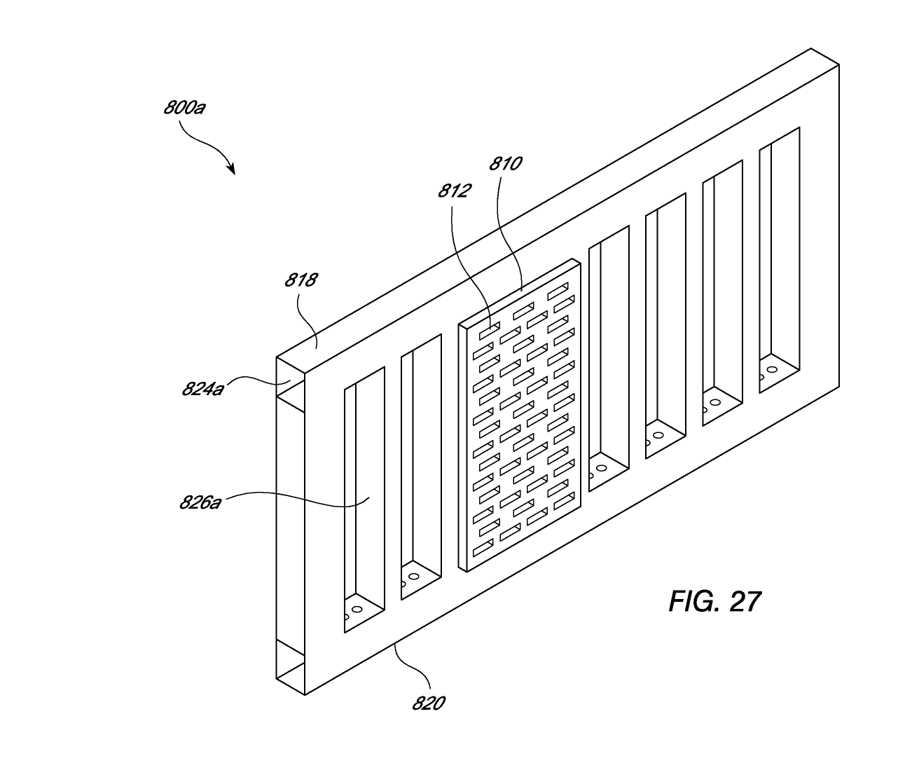

FIG. 27 shows a basic diagram (not to scale) depicting an alternative version of a collector element 800a for use with the systems described herein. The collector element 800a can function as both the support structure for -membrane cartridges 802a and the collection system for the permeate. The collector element 800a can include top and bottom portions 818, 820 comprising pipes or tubes which are configured to form a collection channel 824a, structural supports 826a for structural reinforcement, and collection plates 810a. The top 818 and bottom 820 portion of the collector element 800a can be perforated at the inside edge of the collection channel 824a to allow for the collection of permeate from the collection plates 810a, where it can be channeled to a pump well (not shown) as well as providing fluid communication to atmospheric pressure. The top and bottom portions 818, 820 of the collector element 800a can vary in size and diameter depending on the number of membrane cartridges 802a and the flow from each of the cartridges. The skilled artisan will readily appreciate that the top and bottom portions 818, 820 can be made in any shape and can comprise any material suitable for the intended purpose, e.g., PVC, metal, or the like.

The structural supports 826a of collector element 800a can be tubes, I-beams or can have any other suitable shape. The supports 826a are sized and spaced to carry the force from the pressure differential of the raw water column and the atmospheric pressure conveyed to the product water side of the membrane elements. In a preferred embodiment, the structural supports 826a can be made of a honeycomb-like material, structural foam, or the like to provide positive buoyancy to offset the weight of the membrane cartridge(s) 802a (not shown) and the structural support members of the collector element in the water. In some embodiments, the structural supports 826a can be made from a sealed honeycomb material with holes in areas where the structural support contacts the collection plate 810a or within the space along the inside of the top or bottom elements 818, 820 exposed to permeate water, in order to advantageously allow for passage of the water. This configuration would advantageously facilitate vertical water flow within the collector element 800a.

In the embodiment shown in FIG. 26, the collection plates 810a attach to the left and right surfaces of the top and bottom portions 818, 820. As illustrated in FIG. 26, the membrane cartridges 802a can be mounted on the collection plate 810a with slits 812 or other types of openings (e.g., holes, etc), thus connecting the membrane cartridges 802a to the collection channel 814, using bolts 822, screws, or other appropriate structure. The collection plate 810a advantageously provides a larger surface area for supporting the membrane cartridges 802a, and is designed to withstand the expected pressure differential of the raw water column in which the cartridge is submerged and the atmospheric pressure conveyed to the product water side of the membrane elements. The collection plates 810a advantageously strengthen the membrane cartridge 802a as well as provide support to the top and bottom portions 818, 820 of the collector element 800a.

The collection system 800a components including the top and bottom portions 818, 820, the structural supports 826a and the collecting plates 810a can be made from many different materials, including but not limited to steel, stainless steel, or welded aluminum tubing, molded plastic, ceramic, molded carbon fiber or fiberglass, or any combination thereof in order to achieve a desired strength to weight ratio. Certain components can also be made from sealed honeycomb or structural foam products to reduce the weight of the unit in the water.

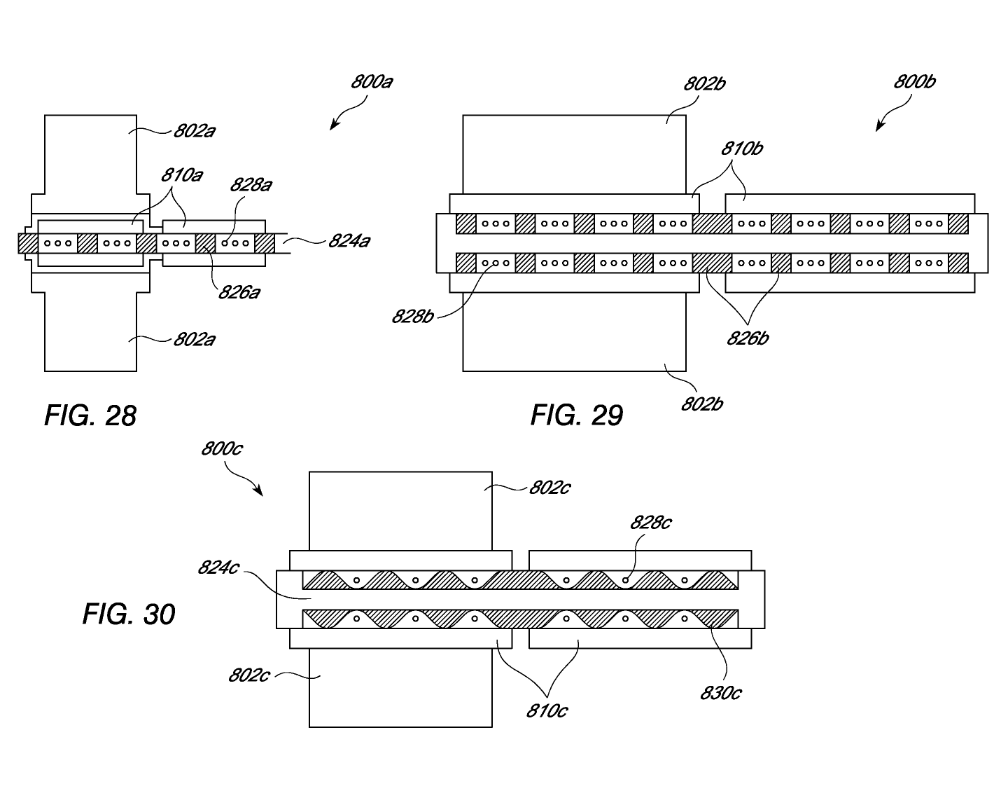

FIG. 28 shows a top view of a cut away portion of the collector element shown in FIG. 27. As shown in FIG. 28, the membrane cartridges 802a abut the collection plates 810a with slits 812 or other openings. The membrane cartridges 802a are attached to the collector collection element 800a, for example using bolts, 822 or other means to fix the membrane cartridge 802a to the collection plate 810a and/or the collection channel 824a. In some embodiments, the cartridge can be attached to the structural supports 826a of the collection element 800a. As shown, the bottom portion 820 (as well as the top portion 818, not shown) of the collection element 800a has holes 828a or perforations to allow for passage of permeate into the collection channel 824a and the for fluid communication of atmospheric pressure through the upper channel.

FIG. 29 shows another embodiment of a collection element 800b in which collection plates 810b abut the collection element 800b, wherein the structural supports 826b are of varying size, with some of the vertical structural supports 826b being made from honeycomb material, structural foam, or the like. As shown, the bottom portion 820b (as well as the top portion 818b, not shown) of the collection element 800b has holes 828b or perforations to allow for passage of permeate into the collection channels 824b and the fluid communication of atmospheric pressure through the upper channel.

FIG. 30 illustrates yet another embodiment of the collection element 800c, in which the collection plates 810c abut corrugated structural plates 830c of the collection element 800c. As shown, the bottom portion 820c (as well as the top portion 818c, not shown) of the collection element 800c has holes 828c or perforations to allow for passage of permeate into the collection channel 824c and the fluid communication of atmospheric pressure through the upper channel.

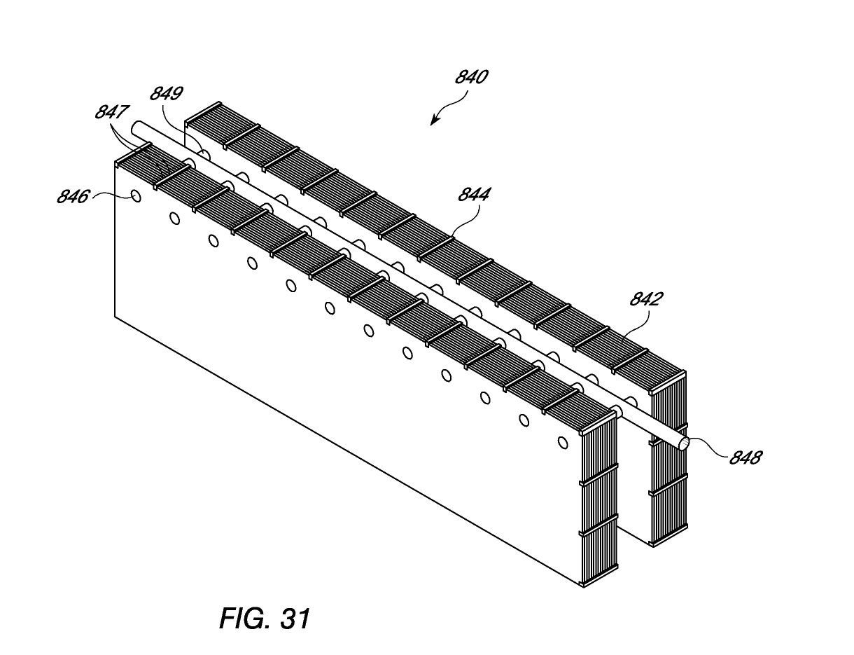

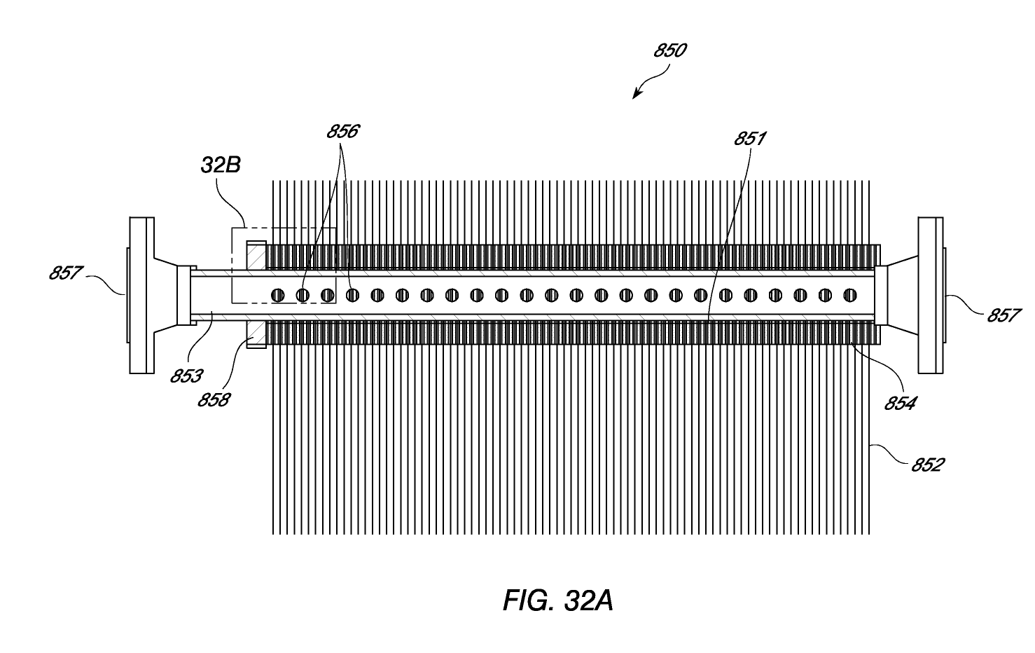

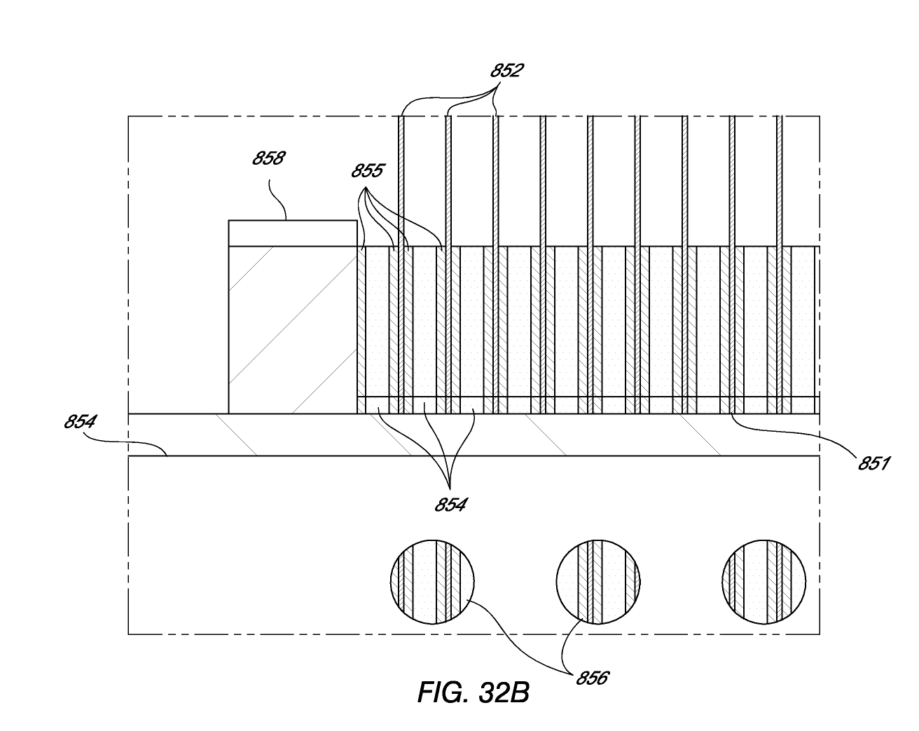

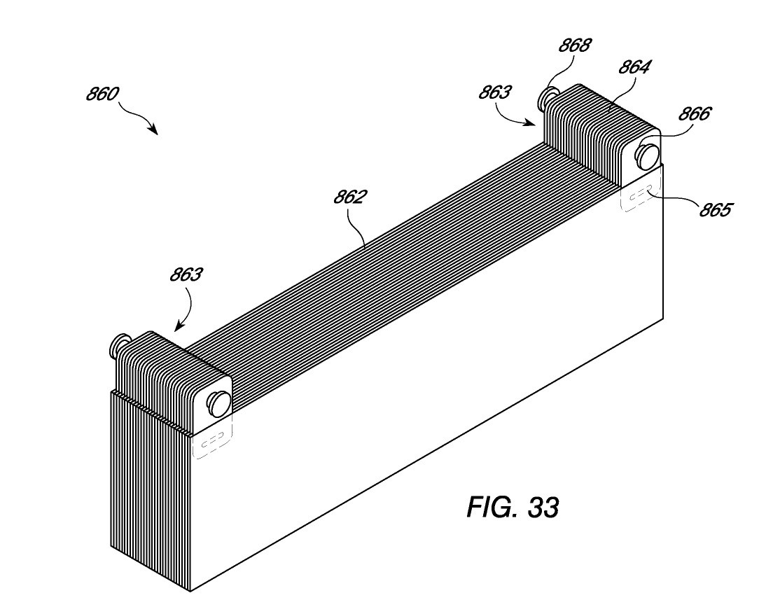

FIG. 31 illustrates a further embodiment of a DEMWAX™ system 840. In the illustrated system, membrane elements 842 are disposed in a generally parallel orientation with respect to a central collection channel 848. Holes 846 are provided on either or both faces of the membrane elements 842 to allow passage of permeate through the holes and to the collection channel 848. In such a system, the membrane elements 842 can be sealed completely on all edges. The holes can be round, as shown in FIG. 31, oblong (see FIG. 33) or can have any other suitable configuration consistent with their intended purpose. The size, shape, and number of holes can be adjusted to allow sufficient flow of permeate for the particular application. In the system illustrated in FIG. 31, donut shaped spacers 847 are stacked between the membrane elements and around the holes 846 in the membrane elements 842, to seal off the holes 846 from those parts of the membrane elements 842 that are exposed to source water and to form one or more conduits extending generally normal to the membrane elements 842 and toward the central collection channel 848. The seal between the spacers 847 and the membrane elements 842 can be achieved using glue, gaskets, and/or any other suitable means. A perforated collection pipe or tube (not shown in FIG. 31, but see FIGS. 32A and 32B), which can be of a slightly smaller diameter than the hole 846, can be placed through each conduit (that is, through each series of holes 846). The tube or tubes can be threaded on each end and the whole assembly can be mechanically compressed to a pressure greater than the external pressure for the application, so as to ensure a positive seal when the system is submerged. Alternatively, the spacers 847 themselves can be compressed to form the permeate conduit or tube. The permeate conduit (and/or perforated collection tube, if present) can be fluidly coupled to the central collection channel 848 by one or more fluid couplings 849, as illustrated in FIG. 31. Optionally, in such a system, additional support can be provided to the stack of membrane elements 842 in the form of one or more dowels 844.

FIGS. 32A and 32B better illustrate an arrangement 850 of membrane elements 852 with a conduit 851 (defined by a series of spacers 854 in combination with a series of openings in the faces of the membrane elements 852) and with a collection tube 853 extending through the conduit 851. The collection tube 853 is provided with a number of perforations 856, to receive permeate from the openings in the faces of the membrane elements 852 into the collection tube 853. FIG. 32B, in particular, illustrates the stacking of membrane elements 852, sealing gaskets 855, and spacers 854 disposed between the gaskets 855. The tube 853 can include one or more threaded regions, which can be provided with a nut 858 which can be tightened to compress the assembly and ensure a positive seal. At the ends of the collection tube 853, one or more end caps 857 can be disposed, and can be configured to either seal the interior of the collection tube 853 from the surrounding source water, or place the collection tube 853 in fluid communication with another portion of the collection system.

FIG. 33 illustrates a still further embodiment of a cartridge 860 comprising a stack of spaced-apart membrane elements 862. In this illustrated system 860, two “sock” assemblies 863 are attached to the stack of membrane elements 862. Each sock assembly 863 comprises a series of plates 864, each plate 864 comprising a pair of non-porous sheets which are spaced apart by one or more permeate spacers. The sheets can comprise plastic, polyethylene, polysulphone, or any other suitable material. The plates 864 are completely sealed around their perimeters to preventingress of raw water into the permeate spacers. The plates 864 extend into the stack of membrane elements 862, between the elements 862, as well as above the stack of membrane elements 862. The plates 864 include a series of holes 866 which are aligned above the stack of membrane elements 862, in a direction generally normal to the stack of socks 863 and elements 862. The plates 864 are sealed off by gaskets to form a conduit for the permeate. Rigid spacers can be disposed between the gaskets. Another series of holes 865 is provided in those portions of the plates 864 that are disposed between the membrane elements 862. These holes 865 are placed in contact with (and sealed with) corresponding holes in the membrane elements. Permeate thus travels through the holes in the membrane elements, into the permeate spacers in each plate 864, and into the conduit formed by the holes 866 at the top of the sock assembly 863. By such a configuration, the permeate conduit formed by the series of plates 864 can be spaced apart from the membrane elements 862 themselves. A perforated collection tube 868 can be placed through the conduit and fluidly connected to a central collection channel (see FIGS. 32A and 32B), or to another membrane element assembly. Such a configuration minimizes the risk of damage to the surfaces of the membrane elements when the spacers are compressed (to form a seal isolating the permeate conduit from the surrounding water) and allows tolerances to be more easily controlled. Although the illustrated embodiment includes two sock assemblies, it will be understood that any appropriate number of such assemblies can be used in embodiments of the invention. In addition, the sock assembly (or assemblies) can be threaded on either end to receive one or more nuts which, when tightened, apply a compressive force to the components of the sock assembly to ensure a positive seal even when the assembly is submerged at depth, for example as described above in connection with FIGS. 32A and 32B. Of course, any other suitable means can be employed to apply a compressive force to a gasket/spacer or other system forming a permeate conduit so as to ensure a secure seal at the application depth.

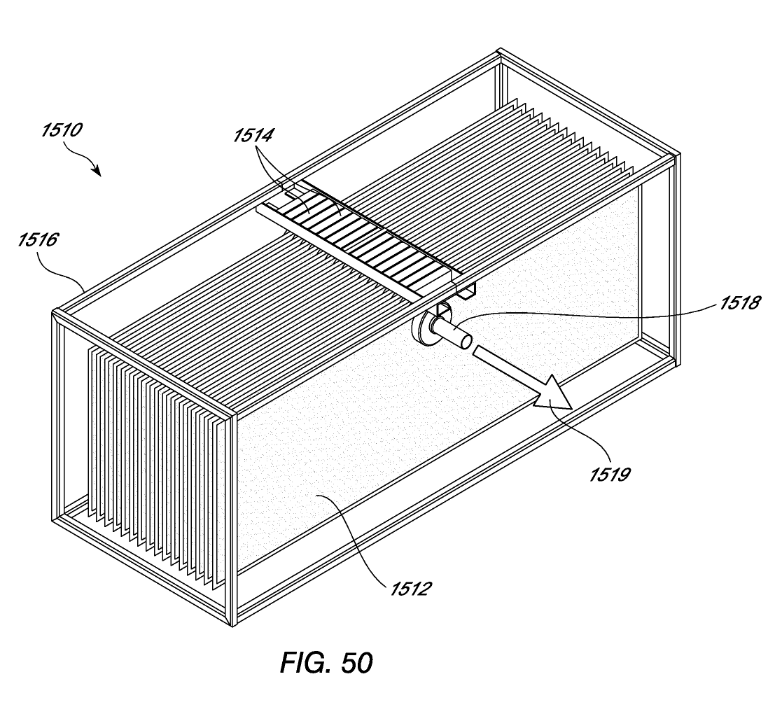

FIG. 49 is a perspective diagram illustrating an arrangement 1500 of membrane elements 1502 with gasketed spacers 1504. The spacers 1504 each have a tee-shaped top for hanging the elements 1502 on a rack or frame (not shown). The gasketed spacers 1504 may be stacked in series to define and create a permeate collection channel 1506, through which permeate can flow, generally in the direction indicated by arrow 1507. In the illustrated embodiment, the collection channel 1506 is located generally at the top and center of the series of elements 1502. In other embodiments, one or more collection channels or points can be disposed at other suitable locations.

FIG. 50 is a perspective diagram illustrating a cartridge 1510 comprising a plurality of membrane elements 1512 spaced apart by a series of gasketed spacers 1514. The series of spacers 1514 are compressed together, by any suitable means, to define a permeate conduit. A collection pipe 1518 comprising perforations or slits can be disposed inside the conduit to receive and convey the permeate, generally in the direction indicated by arrow 1519. The spacers 1514 can each have generally tee-shaped tops, so that the spacers 1514 (and thus, the elements 1512 connected to the spacers) can be supported on a frame 1516. The dimensions of the frame 1516 can vary depending on required capacity, shipping constraints, weight and other factors. Suitable frame materials can include metal, plastic, fiberglass or other materials with an appropriate strength and corrosion resistance for the particular application.

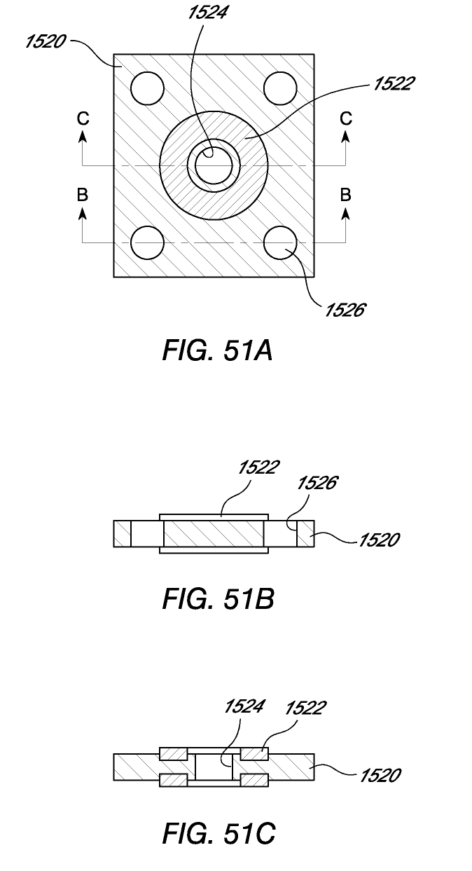

FIG. 51A is a plan view of one example of a gasketed spacer 1520, configured in accordance with an embodiment. The spacer 1520 comprises a suitably rigid material for maintaining the spacing between adjacent membrane elements. The spacer 1520 can be provided with any suitable number of holes 1526 for receiving one or more fasteners or connectors, such as a rigid bolt or dowel, which will extend through a stacked series of spacers 1520 and membrane elements. The spacer 1520 is also provided with a conduit hole 1524 configured to allow permeate to pass from the permeate side of the membrane element, into the hole 1524. The illustrated spacer 1520 has a generally rectangular shape; however, spacers can have any other suitable shape, including a generally annular shape, and can also include any desired extension shape, such as, for example, a tee-shaped extension as illustrated in FIG. 50. FIGS. 51B and 51C are side cross-sectional views better illustrating the fastener holes 1526, the gaskets 1522 on each opposing face of the spacer 1520, and the permeate conduit hole 1524 of the spacer 1520. The spacer 1520 can comprise plastic, fiberglass, or any other suitably rigid material to maintain the spacing between adjacent membrane elements and withstand the pressures to which the spacer will be exposed. The gaskets 1522 can comprise any elastomeric material with sufficient compressibility to create a watertight seal when compressed.

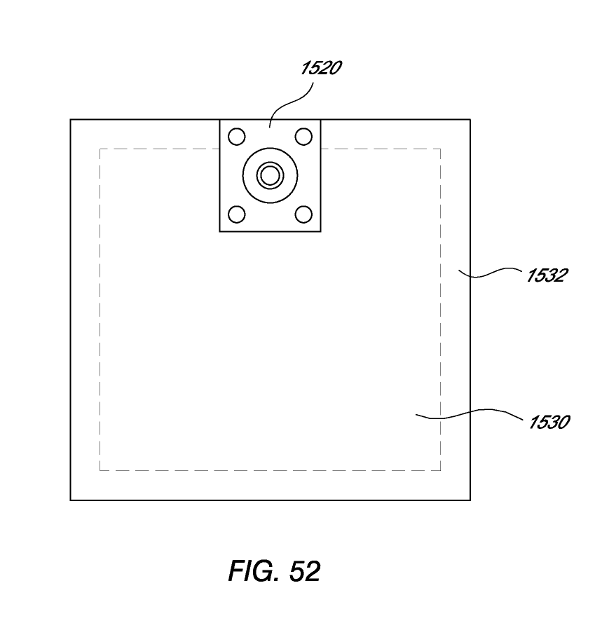

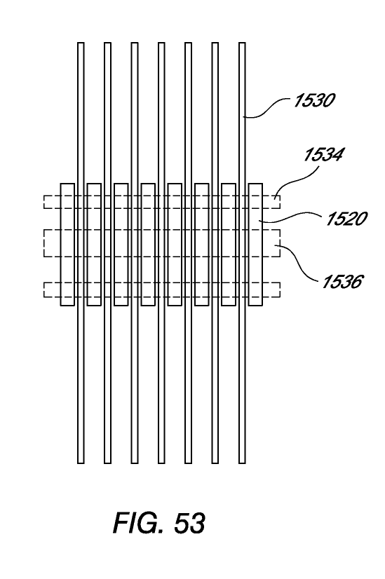

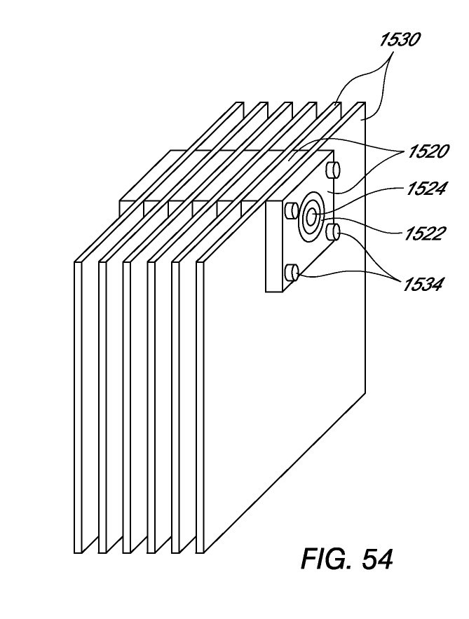

FIG. 52 is a plan view of a membrane element 1530 configured in accordance with an embodiment and shown with the gasketed spacer 1520 of FIG. 51 positioned on the element. As illustrated in FIG. 53, a series of membrane elements 1530 and gasketed spacers 1520 can be stacked together to form a membrane cartridge. To make such a cartridge, the gasketed spacers 1520 are aligned with holes in the membrane faces of the membrane elements 1530, and are also aligned with one another, so that the conduit holes 1524 and fastener holes 1526 of each spacer 1520 are aligned. In such a configuration, each series of holes 1524 defines a receiving space for a fastener or dowel 1534 (indicated in dashed lines). The series of holes 1526 defines a permeate conduit 1536 (also illustrated in dashed lines). The structure forming the permeate conduit 1536 can be sealed in any suitable manner to isolate the interior of the permeate conduit 1536 from the surrounding source water. In one embodiment, the series of spacers 1520 can be mechanically compressed, so that the gaskets 1522 can form an effective seal against the membrane faces. Then, the stack can be secured in the compressed position by one or more rigid members, such as, for example, one or more rigid dowels. The dowels can be glued to the stack of spacers in the compressed position. Once the glue has dried, the stack can be released from the external compression. FIG. 54 is a perspective view of a portion of a membrane cartridge formed in the manner illustrated in FIG. 53. In another embodiment, threaded fasteners can be deployed through each series of holes, and tightened to compress the stack of spacers until the gaskets form a watertight seal against the membrane faces. In still other embodiments, each spacer can include one or more clips or other structure configured to mate with corresponding structure on a second spacer, to thereby provide the required compression of the gaskets. In some embodiments, each spacer can include one or more abutment surfaces, or stops, configured to abut against corresponding structure on a second spacer when the spacers are moved toward one another, to maintain at least a minimal spacing between adjacent spacers even when compressed.

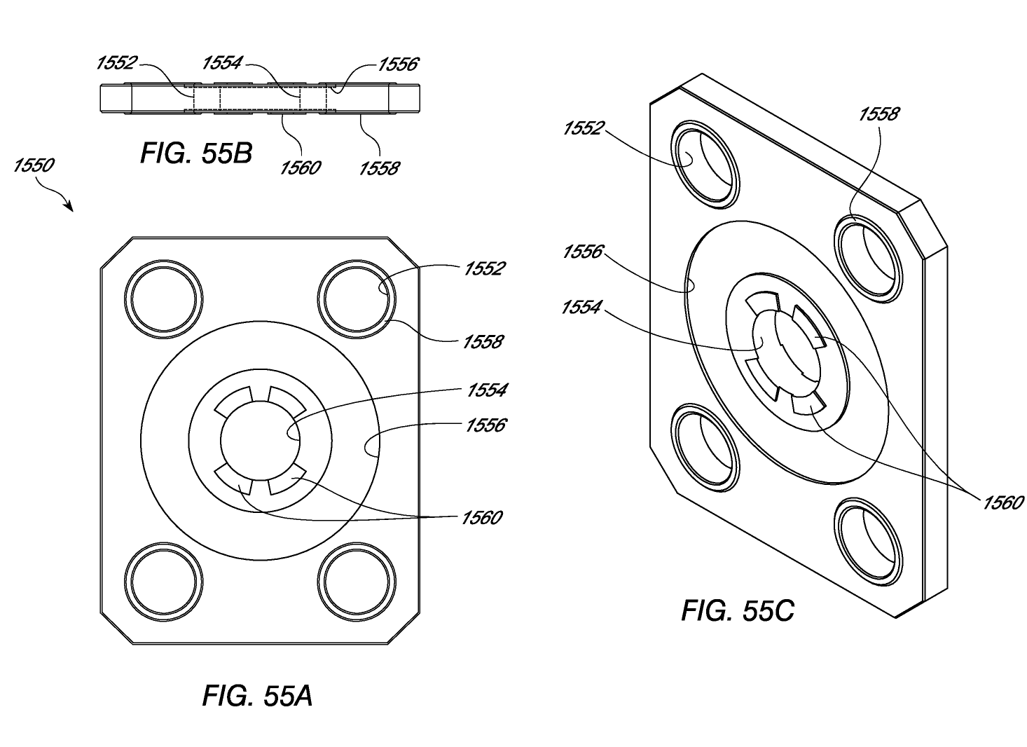

FIG. 55A is a plan view of a spacer 1550, configured in accordance with another embodiment. The spacer 1550 includes four holes 1552 that extend through the thickness of the spacer 1550. The holes 1552 are configured to receive a rod, bolt, or other member configured to extend through a stack of spacers 1550 (with membrane elements disposed between each spacer 1550) and maintain the stack of spacers 1550 under compression. As better illustrated in FIGS. 55B and 55C, the spacers 1550 include an annular protruding portion 1558 around each of the holes 1552. When the spacers 1550 are aligned in a stack (with membrane elements disposed between each spacer), the protruding portions 1558 (as well as the rod, bolt, or other compressive member) extend through a corresponding hole in the membrane elements and abut against corresponding portions 1558 of an adjacent spacer 1550. By such a configuration, the protruding portions 1558 serve to maintain at least a minimal spacing between the spacers 1550 even when compression is applied to the stack, and prevent damage to the membrane elements.

The spacer 1550 also includes a permeate opening 1554 that extends through the thickness of the spacer 1550. The permeate opening 1554 is configured to be placed in fluid communication with the permeate side of a membrane element (or a pair of membrane elements disposed on either side of the spacer 1550). When a series of spacers 1550 are aligned in a stack (of alternating spacers and membrane elements), the permeate openings 1554 align to form a permeate conduit extending through the elements. In some embodiments (see, e.g., FIG. 49), the permeate openings can be directly aligned with openings in the membrane faces (and thus, can be in direct fluid communication with the permeate sides of the membranes). In other embodiments (see, e.g., FIG. 33), the permeate openings can be disposed in a region of the spacer which is spaced apart from the membrane elements (and thus, can be in indirect fluid communication with the permeate sides of the membranes through, for example, a second opening or perforation in the surface of the spacer).

The spacer 1550 also includes a groove 1556 configured to receive a sealing member such as a gasket. When a stack of alternating spacers and membrane elements is placed under compression, the gaskets form a watertight seal that separates the permeate openings 1554 from the source water sides of the membrane.

As better illustrated in FIGS. 55B and 55C, the spacer 1550 can also include one or more protruding portions 1560 disposed generally around the permeate opening 1554, without continuously encircling the permeate opening 1554. The protruding portions 1560 can be configured to serve the same function as the protruding portions 1558, without cutting off the flow of permeate from the permeate side of adjacent elements into the permeate conduit.

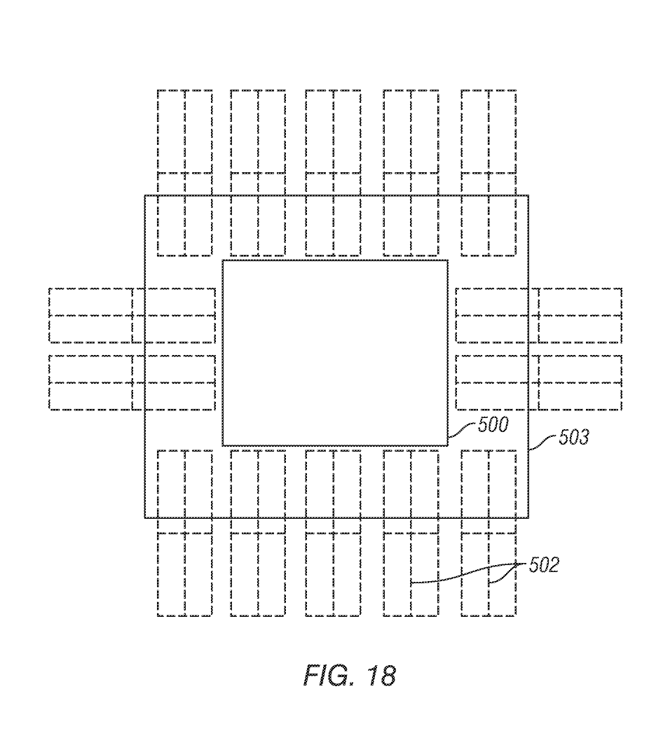

FIG. 18 shows a basic diagram (not to scale) depicting a top view of a DEMWAX™ water filtration plant including an offshore platform 500 and several submerged membrane modules 502. The modules 502 are configured in different banks and connected to a permeate collector line 503. The platform can support the equipment for operation of the system (power generation, pumping, etc.).

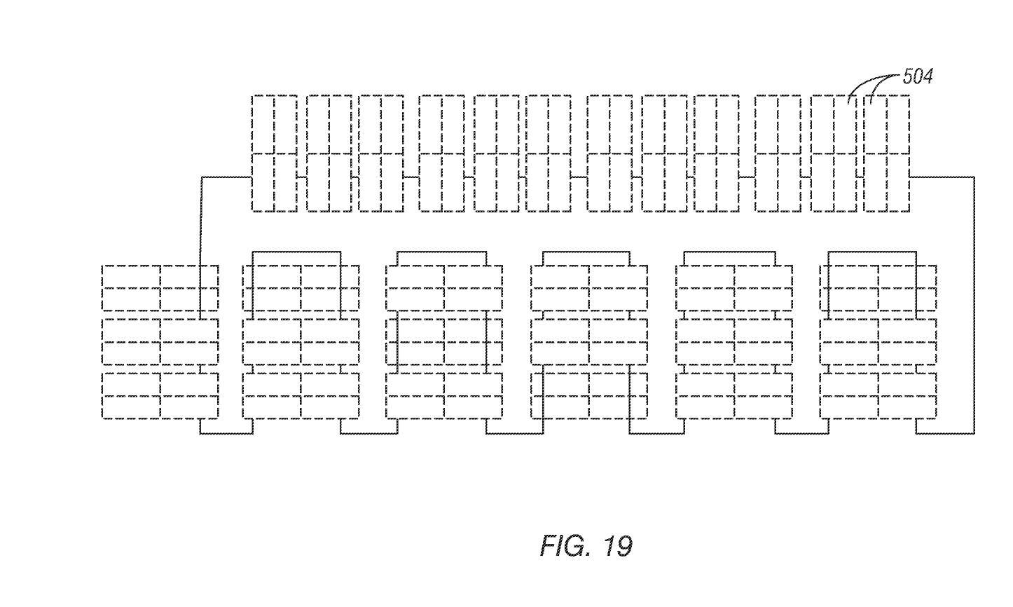

FIG. 19 shows a basic diagram (not to scale) depicting a top view of submerged DEMWAX™ water filtration modules 504 arranged in parallel and serial configurations.

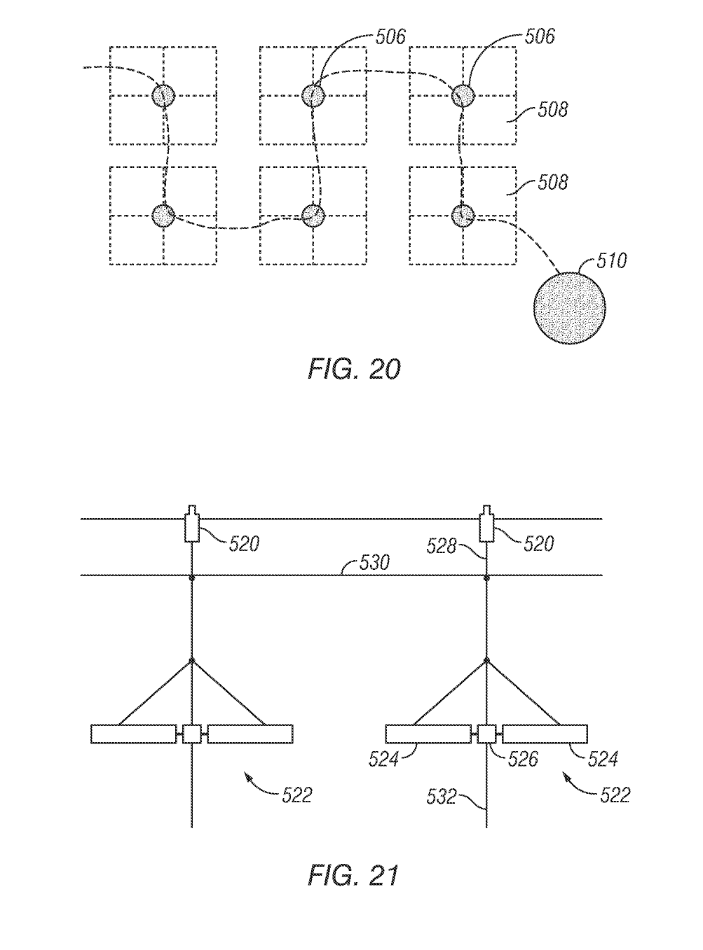

FIG. 20 shows a plan view of an array system of buoys 506 supporting DEMWAX™ water filtration modules 508. Power cables connect the buoy/module stations to a power generation platform 510, and water pipes connect the collection systems of each buoy/module station to offshore or onshore storage.

FIG. 21 shows a side view of array system configuration of buoys 520 supporting DEMWAX™ water filtration modules 522. Each module 522 includes one or more membrane modules 524 fluidly connected to a collector system 526. The collector system 526 is exposed to atmospheric pressure via a breathing tube 528. Power cables and permeate pipes 530 (situated deep enough to avoid surface traffic) connect the buoy/module stations to offshore or onshore power generation and water storage. Each buoy/module station is anchored to the ocean floor by a tether 532.

To minimize the footprint of multi-bank arrays, banks of modules can be stacked on top of one another in layers. The layers can be vertically spaced to allow for mixing to occur between the heavier concentrate falling from the membrane modules of an upper layer and the ambient seawater. Any suitable configuration can be employed, and banks of modules can be added or removed as desired, e.g., to increase or decrease permeate production, to replace damaged modules, to clean modules, or to break down part of the system for transport elsewhere.

### Reverse Osmosis Membrane Systems and Configurations

As discussed above, any suitable configuration can be employed for the reverse osmosis membranes used in the systems of preferred embodiments. These include loose spiral-wound configurations, wherein flat sheet membranes are wrapped around a center collection pipe. The density of such systems is typically from about 200 to 1,000 m²/m³. Module diameters typically are up to 40 cm or more. Feed flows axially on a cylindrical module and permeate flows into the central pipe. Spiral wound systems exhibit high pressure durability, are compact, exhibit a low permeate pressure drop and low membrane concentration, and exhibit a minimum concentration polarization. Preferably, the spiral wound modules are situated in a vertical configuration, to facilitate transfer of denser concentrate away from the membrane surfaces.

Another configuration that can be employed in systems of preferred embodiments is commonly referred to as plate and frame. Membrane sheets are placed in a sandwich style configuration with feed sides facing each other. Feed flows from the sides of the sandwich and permeate is collected from the frame (e.g., on one or more sides). The membranes are typically held apart by a corrugated spacer. The density is typically from about 100 to about 400 m²/m³. Such configurations are advantageous in that the structure and membrane replacement are relatively simple. In a plate and frame configuration, as in other configurations, the membranes are preferably spaced sufficiently far apart such that surface tension does not interfere with convection currents transferring the more dense concentrate down and away from the membrane surface.

Another membrane type that can advantageously be employed in systems of preferred embodiments is a hollow fiber membrane. A large number of these hollow fibers, e.g., hundreds or thousands, are bundled together and housed in modules. In operation, pressure at depth is applied to the exterior of the fibers, forcing potable water into the central channel, or lumen, of each of the fibers while dissolved ions remain outside. The potable water collects inside the fibers and is drawn off through the ends.

The fiber module configuration is a highly desirable one as it enables the modules to achieve a very high surface area per unit volume. The density is typically up to about 30,000 m²/m³. The fibers are typically arranged in bundles or loops which are potted on the ends, with the ends of fibers open on one end to withdraw permeate. The packing density of the fiber membranes in a membrane module is defined as the cross-sectional potted area taken up by the fiber. In preferred embodiments, the membranes are in a spaced apart (e.g., at low packing densities), for example, a spacing between fiber walls of from about 1 mm or less to about 10 mm or more is typically employed.

Typically, the fibers within the module have a packing density (as defined above) of from about 5% or less to about 75% or more, preferably from about 10% to about 60%, and more preferably from about 20% to about 50%. Any suitable inner diameter can be employed for the fibers of preferred embodiments. Due to the high pressures at depth that the fibers are exposed to, it is preferred to employ a small inner diameter for greater structural integrity, e.g., from about 0.05 mm or less to about 1 mm or more, preferably from about 0.10, 0.20, 0.30, 0.40, or 0.50 mm to about 0.6, 0.7, 0.8, or 0.9 mm. The fiber's wall thickness can be selected based on balancing materials used and strength required with filtration efficiency. Typically, a wall thickness of from about 0.1 mm or less to about 3 mm or more, preferably from about 1.1, 1.2, 1.3, 1.4, 1.5, 1.6, 1.7, 1.8, or 1.9 mm to about 2.0, 2.1, 2.2, 2.3, 2.4, 2.5, 2.6, 2.7, 2.8, or 2.9 mm can be employed in certain embodiments. It can be desirable to employ a porous support or packing material in the fiber, e.g., when the fibers have a relatively large diameter or a relatively thin wall, to prevent collapse under pressure at depth. A preferred support is cellulose acetate; however, any suitable support can be employed.

The length of the fibers is preferably relatively short, to overcome the resistance to flow. If exposed to relatively fast-moving currents, then longer fibers can be employed.

In certain embodiments, it can be advantageous to provide a source of aeration and/or liquid flow (e.g., pressurized water, or pressurized water containing entrained air) to the membrane module beneath the fibers, such that bubbles or liquid can pass along the exterior of the fibers to provide a scrubbing action to reduce fouling and increase membrane life, or to reduce concentration polarization at the membrane surface. Similarly, the membranes can be vibrated (e.g., mechanically) to produce a similar effect. It is generally preferred to allow the membranes to function under ambient conditions without introducing mechanically generated currents or flow into the membranes (e.g., fibers or sheets), so as to minimize energy consumption. However, in certain embodiments (e.g., water with a high degree of turbidity or organics content) it can be desirable to provide such currents or flow so as to increase membrane life by reducing fouling.

The fibers are preferably arranged in cylindrical arrays or bundles, however other configurations can also be employed, e.g., square, hexagonal, triangular, irregular, and the like. It is preferred that the membranes are maintained in an open spaced apart configuration so as to facilitate the flow of seawater and concentrate therethrough; however, in certain embodiments it can be desirable to bundle together fibers or groups of fibers, to partition the fibers, or to enclose the fibers within a protective screen, cage or other configuration to protect the membranes from mechanical forces (e.g., during handling) and to maintain their spacing. Preferably, the partitions or spacers are formed by a spacing between respective fiber groups, however porous (e.g., a screen, clip, or ring) or solid partitions or spacers can also be employed. The fiber bundles can be protected by a support screen which has both vertical and horizontal elements appropriately spaced to provide unrestricted seawater flow around the fibers.

In certain preferred embodiments, it can be desirable to enclose the membranes within a vessel or other enclosure, which can provide protection against mechanical forces (e.g., as in a conventional spiral-wound membrane encased within a protective tube), and to continuously or intermittently introduce seawater into (and remove concentrated brine from) the vessel containing the membranes. However, it is generally preferred to have the membranes either partially or wholly uncontained so that they are directly exposed to ambient source water.

The membranes of any particular configuration (sheet, spiral wound, or fiber) are advantageously provided in cartridge form. The cartridge form permits a desired number of cartridges to be joined to a permeate withdrawal system so as to generate the desired volume of permeate. A cartridge system is also advantageous in facilitating removal and replacement of a cartridge with fouled or leaking membranes.

Over time the membrane's efficiency decreases due to adsorption of impurities on the membrane surface. Scaling reduces efficiency of membranes by suspended inorganic particles, such as calcium carbonate, barium sulfate and iron compounds blocking filtration capacity and/or increasing operation pressure. Fouling occurs when organic, colloidal and suspended particles block filtration capacity. Membranes can be cleaned using conventional anti-scalants and anti-foulants to regenerate filtration capacity and increase membrane life. Physical cleaning methods, such as backwashing, can also be effective in regenerating a membrane to increase membrane life. In backwashing, permeate is forced back through the membrane. The membranes employed in the systems of preferred embodiments can be placed on a regular cleaning schedule for preventative maintenance, or a regular membrane replacement schedule. Alternatively, systems can be employed to detect when cleaning or replacement is necessary (e.g., when permeate flow rate decreases by a preselected amount, or when pressure necessary to maintain a permeate flow rate increases to a preselected amount).

### Support Structure

Offshore platforms suitable for use with the systems of preferred embodiments include those typically employed in offshore oil drilling and oil production. Fixed offshore platforms are constructed in an assortment of structural configurations, and include any structure founded on the seafloor and extending from the seafloor through the water surface. The portion of the platform housing equipment supporting the desalination process is typically referred to as the platform topsides or deck. The portion of the platform extending from the seafloor through the water surface and supporting the topsides is typically of a type referred to as a jacket (tubular space frame), guyed platform, or tension leg platform. Platforms include tension leg platforms wherein a floating platform is connected to the ocean floor via tendons such as steel cables.

Another type of floating platform is the spar platform which generally is a floating cylindrical structure that is anchored to the ocean floor with steel cables. The platform can be rigid, or include articulation of a rigidly framed structure. Guyed platforms are typically supported vertically and laterally at the base while free to rotate out of vertical about the base. Stability is supplied to the platform by an array of guy lines attached towards the platform top and anchored to the seafloor some distance away from the platform base. The platform is restored to a vertical position after being deflected horizontally by tension forces within the attached guys. Gravity based structures are large structures designed to be towed to the installation location, where they are ballasted down and held in place on the sea floor by the force of gravity. Gravity based structures have a large capacity for carrying large deck payloads during the ocean tow to the installation site, and decks are transferred to the structure once it is in place. Other platforms, commonly referred to as semi-submersible platforms, include generally rectangular or cylindrical pontoons, often in excess of 20,000 tons displacement, that provide stability during extreme weather events.

Alternatively, a vessel can be used to support the systems of preferred embodiments, e.g., a barge, tanker, or a spar platform. Spar platforms generally have an elongated caisson hull having an extremely deep keel draft, typically greater than 500 feet. The spar supports an upper deck above the ocean surface and is moored using catenary anchor lines attached to the hull and to seabed anchors. Risers generally extend down from a moon pool in the hull of the spar platform to the ocean floor. The hull of the typical spar platform is generally cylindrically shaped, typically formed of a large series of curved plates positioned in a circular fashion and having a perpendicular radial plane which passes through the isocenter of the hull to form a cylindrical structure. This cylindrical design is used to reduce the severity of the shedding of vortices caused by the ocean currents and to more efficiently resist the hydrostatic pressures.

In shallower water, sea floor supported platforms can advantageously be used. Platforms located in shallower waters are designed for static wind and wave loadings.

In another configuration, a buoyant structure such as a balloon (e.g., a concrete shell enclosing air, or other such configuration) can be employed to suspend a DEMWAX™ water filtration module above at depth. The buoyant structure can be tethered to the ocean floor, or can be equipped with a propulsion device to maintain the module at a desired location (depth and/or latitude and longitude). In such a configuration, the buoyant structure can be at the surface, or submerged. If the buoyant structure is submerged, a buoy or other surface structure can be employed to support a breathing tube, if present. Buoyant structures can be employed to support any other component(s) of the system, as desired, or can be used in combination with other supporting systems. A system of buoys to support DEMWAX™ water filtration modules is depicted in FIGS. 20 and 21.

A deck structure can be provided to support personnel and equipment for operation of the systems of preferred embodiments (e.g., electrical power generators or engine-driven hydraulic motors, pumps, crew housing, etc.). Offshore platforms can be either manned, or (preferably) unmanned. Unmanned offshore platforms require periodic maintenance; however, for which purpose a maintenance crew has to visit the platform to carry out the necessary maintenance work. Access to offshore platforms can be provided, e.g., by helicopter or ship. Accordingly, it can be advantageous to provide the platform with a helideck or other structures supporting transfer of crew and equipment on and off the platform. Energy generators, such as electrical power generators or engine-driven hydraulic motors, can be provided on board the platform for use when maintenance is to be carried out. This also adds to the cost of the platform where such generators or motors for maintenance use are permanently installed on the platform. If instead they are transported in the support craft, this is inconvenient for the crew, particularly when transporting such equipment from the craft to the platform. In certain embodiments, it can be desired to generate power at depth (e.g., submarine power generation). In such a configuration, it can be desired to situate all components except for the breathing tube (if employed) at depth.

In an alternative configuration, a single DEMWAX™ water filtration module or small group of modules can be suspended from a buoy or tethered directly to the bottom. Several such modules can be strung together to yield a larger plant, which can eliminate the need for a large platform in those areas where a platform is undesirable (e.g., for reasons of esthetics, or environmental impact). The buoy unit can incorporate a small generator and fuel tank, or an underwater transmission cable. Alternatively, a larger buoy or small platform or the like can be employed to house power generation for several smaller buoys with DEMWAX™ water filtration modules suspended from them. In a preferred configuration, the buoys are situated around a permeate storage tank or structure.

Membrane collection systems of preferred embodiments can be employed in any suitable configuration, for example, in a concentric circle configuration, or other configurations (e.g., a ‘closest packed’ hexagonal configuration, concentric octagonal arrays with eight trapezoidal membrane modules feeding into radial collectors, or a series of collectors in any configuration that feed into a central collector. In addition to horizontally spaced arrays or modules, vertically spaced arrays or modules can also be employed.

### Alternative Power Supplies

Because the DEMWAX™ water filtration systems disclosed herein have much lower energy requirements than conventional desalination systems, it is particularly suitable for integration with renewable power resources such as wind generators or solar photovoltaic to serve small, remote water loads. Likewise, if the DEMWAX™ water filtration system is situated in an area that experiences very high and very low tides, tidal energy can be advantageously employed to generate power for the system. If local, abundant, and/or low cost fuel sources are available (e.g., biodiesel, methane, natural gas, biogas, ethanol, methanol, diesel, gasoline, bunker fuel, coal, or other hydrocarbonaceous fuels), it can be desirable to select power generators that can take advantage of these fuel sources. Alternatively, if electricity is conveniently available from an onshore site, a power cable to the DEMWAX™ platform comprising the membrane module can be provided for power needs. Other energy generation systems can include wave surge and tidal surge systems, or nuclear (land-based or submarine).

### Umbilical Lines

As described herein, DEMWAX™ water treatment systems include a breathing tube and a permeate pipe, that physically connect a membrane module or some other submerged portion of a DEMWAX™ system to the surface. The DEMWAX™ water treatment systems can also include one or more power cables, communication cables, and/or structural support cables that connect a membrane module to the surface. Components which physically connect a membrane module or some other submerged portion of a DEMWAX™ system to the surface are referred to as “umbilicals”. Accordingly, as used herein, the term “umbilical” refers to a structure that physically connects a submerged structure or system to a structure or system at the surface of the water, such as a floating platform, a buoy, or the like. As described above, the structure or system at the surface can include, for example, a power source, a storage vessel to house the treated water, or the like.

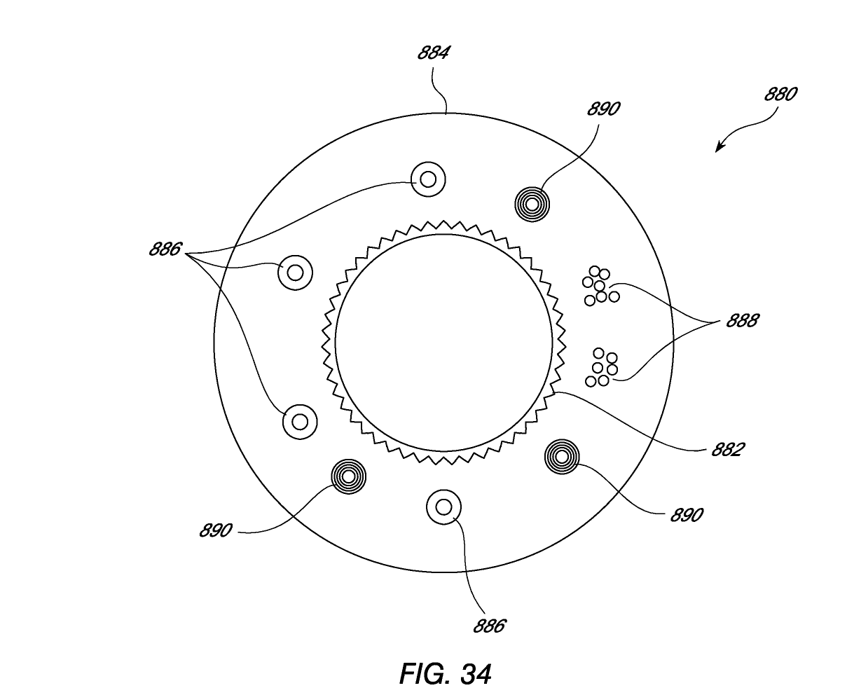

As shown in FIG. 34, in embodiments of the invention, multiple umbilicals can be combined together in a bundle 880. As shown in the figure, the bundle 880 includes a breathing tube 882 surrounded by a bundling layer 884 in which power cables 886, communications cables 888, and structural support cables 890 are disposed. Although not illustrated, a permeate pipe can also be incorporated into the bundle 880, if desired. The bundling layer 884 can comprise any suitable material, such as, for example, rubber or plastic. The bundling layer 884 can be configured to be abrasion and corrosion resistant, and can also be configured to withstand the pressures (and pressure differentials) to which it will be exposed when submerged. In some embodiments, the bundle 880 and/or the breathing tube 882 can comprise a reinforced rubber or plastic core. In some embodiments, the bundle 880 can be reinforced, for example, with braided stainless steel or other suitable material that provides flexibility and strength to the bundle 880. In the illustrated embodiment, the power cables 886, communication cables 888, and structural support cables 890 are embedded in the bundling layer 884 which surrounds a centrally located breathing tube 882. Such a configuration can protect the lines 886, 888, and 890 from moisture and environmental conditions. Of course, alternative configurations are also possible, such as configurations in which the lines 886, 888, and 890 are bundled together and then bundled together with or otherwise attached to the breathing tube 882 as a unit. As will be recognized by one skilled in the art, the thickness of the bundling layer 884 and the number of lines included therein can vary depending upon the installation and conditions at that installation. For example, the diameter, thickness, and/or density of the bundling layer 884 can be advantageously altered to affect the buoyancy of the bundle 880, so as to offset the weight of the lines 886, 888, and 890 in the water and facilitate installation and deployment of the system. For example, in some embodiments, the thickness of the bundling layer can range between about 0.5 mm, 1 mm, 2 mm, 3 mm, 4 mm, 5 mm, 6 mm, 7 mm, 8 mm, 9 mm, 10 mm, or more, or any fraction in between.

In embodiments of the invention, a bundled umbilical can be manufactured using any material and manufacturing technique capable of withstanding the environment conditions in which the DEMWAX™ system will operate. In some embodiments, the permeate pipe, which is exposed to only a small pressure differential, can comprise materials such as rigid steel pipe, rigid concrete pipe, fiberglass reinforced pipe, flexible high density polyethylene, or the like. In some embodiments, the permeate pipe can comprise a flexible fabric pipe or hose. For example, in some embodiments, the permeate pipe and or breathing tube can comprise braided steel surrounding a plastic or rubber core. Likewise, umbilicals such as power cables, communications cables and structural support cables can also be manufactured from diverse materials.

In some embodiments, more than one umbilical can be combined into a single physical structure, or a bundle 880 as shown in FIG. 34. As with the individual umbilicals, the bundle 880 can be created through the use of any combination of materials and manufacturing that enable the bundle 880 to withstand the environment in which it will be placed. For example, a bundle 880 can be manufactured by individually wrapping each separate umbilical around a structural support and then coating or wrapping the bundle 880 with corrosion/abrasion resistant material. One skilled in the art will further recognize that abrasion and corrosion resistant coatings may be added to individual umbilicals or to bundles of umbilicals.

### Alternative Embodiments

Although described herein above with particular reference to reverse osmosis membranes and ocean desalination applications, embodiments can be used to advantage with other types of membranes and in numerous other applications, for example as described below.

### Freshwater Applications

Water from lakes, reservoirs and rivers accrues contamination from sources such as wildlife, urban runoff and organic growth. The most common method of treatment is a three-step process including chemical enhanced clarification, filtration, and disinfection. The conventional clarification process typically uses costly chemicals to coagulate the organic contaminants producing a sludge that must be disposed to a landfill. Sand or membrane filtration steps are capital and space intensive. Embodiments of the DEMWAX™ water filtration system disclosed herein can be used to advantage to replace the first two of these processes more efficiently than conventional systems, with no chemicals, with reduced complexity, at far less capital cost, and with better product water quality, by using the natural pressure exerted by the water column in a body of water to drive the treatment process.

Systems of preferred embodiments adapted for treating surface water for potable uses typically utilize membrane modules including nanofiltration membrane units. The smaller pore size of nanofiltration membranes produces water that far exceeds current EPA surface water treatment requirements, and the low flux (˜5 to 10 gfd) makes maintenance simpler as the impurities do not readily attach to the smaller pores of the nanofiltration membrane as compared to currently-available microfiltration (MF) membrane systems. When microfiltration membranes are employed instead of nanofiltration membranes, silts can be lodged in their larger pores requiring much more comprehensive and frequent cleaning. DEMWAX™ systems of preferred embodiments of the water filtration system disclosed herein reduce or eliminate the requirement of frequent backwashing and its attendant complexities (valves and pumps). The maintenance regimen for microfiltration systems therefore requires more complex systems and hardware. The nanofiltration systems of preferred embodiments have a low maintenance barrier and keep microbes, viruses, organics, and other unwanted constituents out of the water supply. By lowering the membrane modules to a depth of from about 6 meters to about 200 meters, depending on the precise membrane and source water quality, the water is naturally at high enough continuous pressure to drive the filter process. Of course, embodiments using reverse osmosis membranes can also be used in freshwater applications. For example, embodiments using reverse osmosis membranes can be deployed at about 15 meters of depth (or deeper) and used to produce ultrapure water.

Systems of preferred embodiments adapted for use in freshwater applications can be configured essentially as described above in connection with ocean applications, for example with one or more membrane modules and a collection system suspended at depth, and a breathing tube extending upward from the collection system to the surface. Certain systems of preferred embodiments can be anchored to the bottom of the body of water via one or more tethers, although tethering is not a requirement unless the system is buoyant.

Membrane modules of preferred embodiments can include one or more membrane units, and can be configured in any suitable fashion allowing the source water to flow substantially freely in the spaces between the membrane units. The spacing algorithm described for ocean applications is modified slightly for freshwater treatment applications. In freshwater applications, the limiting factor in the spacing between the membrane units is surface tension. As dissolved solids are generally not present in high concentrations in surface water sources, overcoming osmotic pressure does not require the high pressures associated with desalination. As such, slightly concentrating feed water may not raise the pressure requirements if spacing is insufficient, unlike in seawater applications. Accordingly, systems of preferred embodiments adapted for use with freshwater applications can utilize a narrower spacing (about 3 millimeters or about ⅛ inch spacing) than is typically employed in seawater applications.

Each membrane element can include two membrane sheets with a separator (e.g., polymer, composite, metal, etc.) disposed between the two layers, to allow the permeate (treated potable water) to flow between them. The two plies can be rectangular sheets of membrane that filter out the impurities and pass the clean water through the separator to a collector. The membrane layers and separator layer can be joined and sealed at the edges on the sides with a passageway or other opening provided to remove permeate. Preferably, they are joined on three sides, with the fourth side as the opening provided to remove permeate. The open (unsealed) edge or unsealed portion of an edge is placed in fluid communication with the collection system. The collection system can include a collection channel adapted to provide structural support to the system. Waves and currents are not present to the same extent in freshwater applications as in ocean applications, and appropriate materials and structure can be selected with this in mind.

The collection system preferably contains a submersible pump, and is connected to two pipes (or tubes, passageways, openings, or other flow directing means): one through which the permeate is pumped to the shore, and a pipe or breathing tube adapted to communicate atmospheric pressure from the surface of the body of water to the treated water side of the membranes, thereby providing the necessary pressure differential to drive the treatment process. The diameter of the breathing tube is selected to avoid the occurrence of air binding or excessive velocity during pump operation. From the collection system, the permeate is pumped to the final treatment facility. In many freshwater applications, the pumping distance to shore is typically relatively short, as many reservoirs and lakes have at least 6 meters of depth rather close to the shore.

Storage can be provided within the system or onshore to buffer the continuous filtration process against the uneven hourly demand for water. For example, temporary storage can be provided within a collection channel or system as described above in connection with FIG. 16. Additionally or alternatively, embodiments can create virtual water storage by placing the membranes at greater depths, where higher flux rates can be induced by turning on more pump capacity. When the membrane modules are submerged to a greater depth than required for the base load design capacity, the constant base load pumping speed induces backpressure in the system because the membranes is producing more water than the pump can vacate. In times of high demand, increasing the flow rate of the permeate pumps lessens the back-pressure in the system, increasing the pressure differential across the membranes and increasing permeate production rates.

In freshwater applications, accumulation of organic growth such as algae can impede water production and necessitate periodic cleaning. Accordingly, systems of preferred embodiments can be designed to loosen the algae and other contaminants from the membranes. Automatic systems can be provided which force compressed air or water through an array of nozzles located below the membranes, or even ultrasonic vibration devices. Fiber agitators can also be provided which assist in loosening any solids from the membrane face. Such cleaning systems can be deployed at daily intervals, and can be supplemented with a perhaps less frequent, more thorough (for example bi-annual, or as necessary), cleaning process that involves removing the membrane cartridges from the water. As such, systems of preferred embodiments can include an automated system for raising and lowering the modules, e.g., through the use of ballast tanks, flotation devices with moored pulleys, or the like.

Power is transmitted to the DEMWAX™ water filtration system to pump the product water. There are many ways to accomplish this and the method selected can depend on the size of the system and the availability of power near the unit. Considerations for the power provision include the distance the site is from the shore (line losses and cabling costs) as well as the intrusion (visual and navigational) of power located on the surface of the water source (floating on a buoy).

### Groundwater Applications

Heavy metal and volatile organic compounds often contaminate groundwater supplies. Conventional methods of removal are expensive and require disposal of the resulting toxic waste, with attendant liabilities. DEMWAX™ systems of preferred embodiments can be advantageously used to produce clean water from contaminated wells for which other types of treatment might be cost-prohibitive.

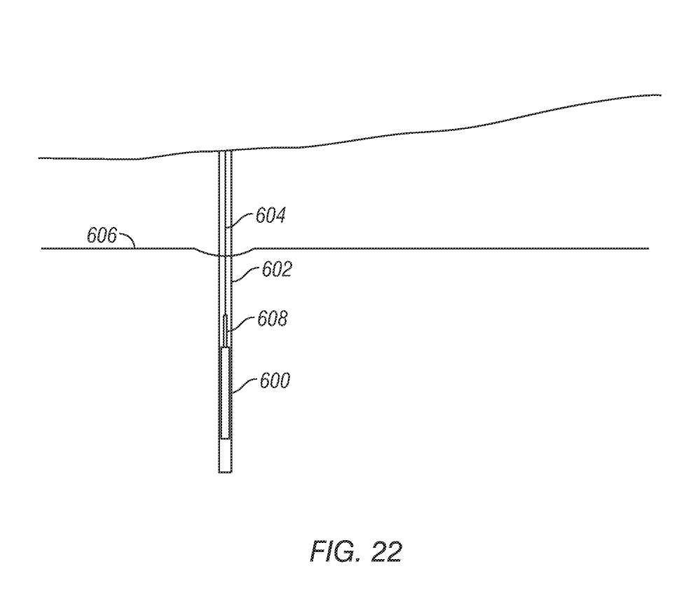

FIG. 22 illustrates an example of a DEMWAX™ water filtration system adapted for use in groundwater applications. The system includes a cylindrical membrane cartridge 600 comprising one or more nanofiltration membranes, submerged in an existing well 602. The membranes surround a central collection chamber, with the permeate side of the membranes in fluid communication with the chamber. The chamber is maintained at atmospheric pressure by a breathing tube 604 which extends to at least the top of the water table 606, which, as shown in the figure, may be drawn down somewhat in the region of the well 602. By submerging the cartridge 600 below the well pump 608 to a depth of about 33 feet (10 meters) below the top of the water table 606, clean water can be produced and pumped out of the well 602, leaving the contaminants in the ground. Movement and recharge of underground aquifers can keep these contaminants from building up in the area around the well.

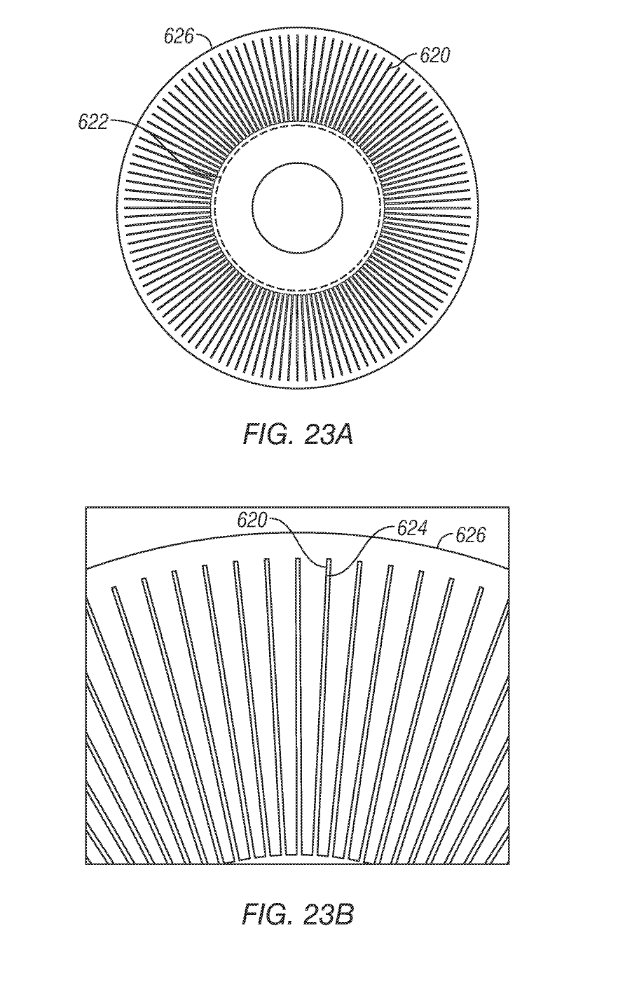

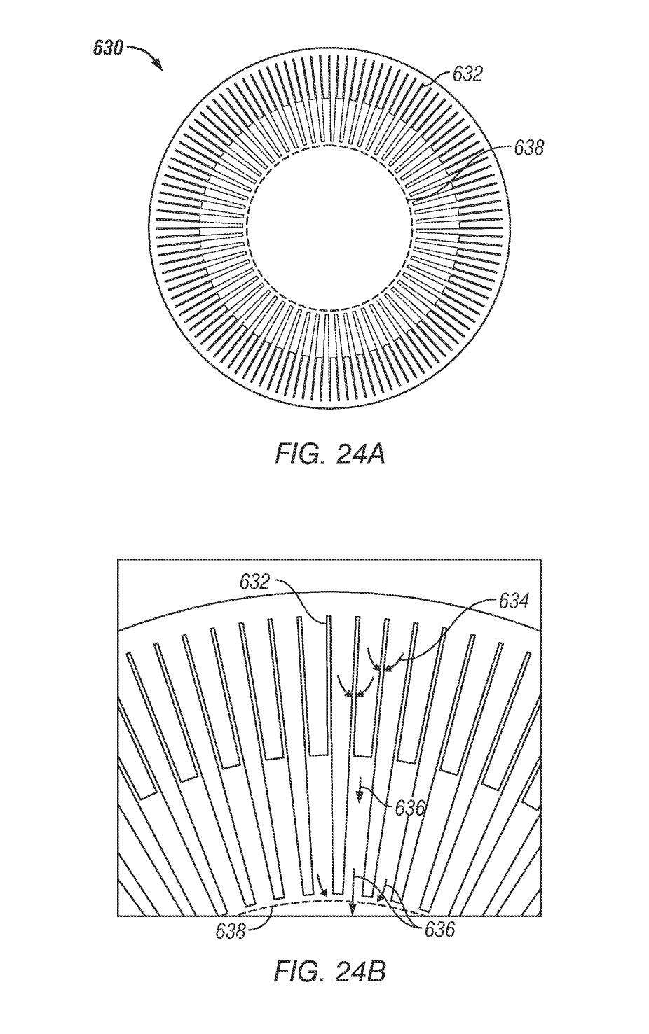

FIGS. 23A-23B and 24A-24B illustrate various configurations of a cylindrical membrane cartridge adapted for groundwater applications. A cylindrical membrane cartridge typically includes a membrane surrounding a central collection channel. In preferred embodiments, the membrane is configured in such a way as to maximize the membrane surface area within the cylindrical constraint of a groundwell. For example, as illustrated in FIGS. 23A and 23B, a membrane 620 is arranged in an accordion fold in a cylindrical configuration around a central collection channel 622. One or more permeate spacers 624 are disposed inside each fold, either continuously or at discrete locations, to prevent the membrane folds from collapsing on themselves. The dashed line in the figure indicates perforations in the central collection channel 622, which are provided to allow the passage of permeate through the spacers 624 and into the channel 622. When submerged in a well casing 626, the outer surfaces of the membrane 620 are exposed to ambient groundwater in the well, so that permeate can pass through to the central collection channel 622. A frame (not shown), for example comprising ribs and struts, can optionally be provided around the folded membrane to provide structural support for the system. Systems employing multiple cartridges in a stacked configuration can include a connector pipe 628 to connect the collection channels 622 of each cartridge. In some embodiments, as shown in FIGS. 24A and 24B, a cylindrical cartridge 630 can include a membrane 632 with folds that double back on each other at the outer circumference of the cylinder so as to maintain similar spacing between the folds from the center of the cartridge to the periphery. The folded membrane 632 surrounds a perforated central collection channel 638. The flow of source water against the membranes 632 is indicated by arrows 634. The flow of permeate into the collection channel 638 is indicated by arrows 636. In embodiments configured for groundwater applications, the membrane folds can be spaced closer together than in seawater applications; but preferably not so close that surface tension inhibits the flow of feed water between the membranes.

### Mobile Filtration Systems

Systems and methods for the purification of surface and groundwater are also provided. In preferred embodiments, one or more membrane units are arranged in a pressure vessel configured to hold source water to be treated. The membrane units are disposed in a spaced-apart configuration so as to allow substantially free flow of water between the units. Each membrane unit has a source water side and a permeate side. The source water side is exposed to the pressure of the vessel and the permeate side is exposed to atmospheric pressure. The pressure differential between the vessel pressure and atmospheric pressure drives a filtration process across the membranes.

The systems are advantageous in that they simplify or eliminate certain process steps that would be otherwise necessary in a conventional water treatment plant, such as a plant employing conventional spiral-wound membrane systems. In addition, the systems described herein can be mounted and/or transported in a vehicle and deployed in emergency situations to remove, e.g., dissolved salts or other unwanted constituents such as viruses and bacteria to produce potable water from a contaminated or otherwise non-potable water supply.

The systems involve exposure of one or more membranes, such as nanofiltration (NF) or reverse osmosis (RO) membranes, to a volume of water held at pressure in a pressure vessel. The vessel pressure is sufficient to overcome the sum of the osmotic pressure of the source water (or raw water) that exists on the first side of the membrane and the transmembrane pressure loss of the membrane itself. For seawater or other water containing higher amounts of dissolved salts, transmembrane pressure losses are typically much smaller than the osmotic pressure. Thus, in some applications, osmotic pressure is a more significant driver than transmembrane pressure losses in determining the required pressure (and thus, the required depth). In treatment of fresh surface water or water containing lower amounts of dissolved salts, osmotic pressures tend to be lower, and the transmembrane pressure losses become a more significant factor in determining the required pressure (and thus, the required depth). Typically, systems adapted for desalinating seawater require greater pressures than do systems for treating freshwater.

The systems of preferred embodiments utilize membrane modules of various configurations. In a preferred configuration, the membrane module employs a membrane system wherein two parallel membrane sheets are held apart by permeate spacers, and wherein the volume between the membrane sheets is enclosed. Permeate water passes through the membranes and into the enclosed volume, where it is collected. Particularly preferred embodiments employ rigid separators to maintain spacing between the membranes on the low pressure (permeate) side; however, any suitable permeate spacer configuration (e.g., spacers having some degree of flexibility or deformability) can be employed which is capable of maintaining a separation of the two membrane sheets. The spacers can have any suitable shape, form, or structure capable of maintaining a separation between membrane sheets, e.g., square, rectangular, or polygonal cross section (solid or at least partially hollow), circular cross section, I-beams, and the like. Spacers can be employed to maintain a separation between membrane sheets in the space in which permeate is collected (permeate spacers), and spacers can maintain a separation between membrane sheets in the area exposed to raw or untreated water (e.g., raw water spacers). Alternatively, configurations can be employed that do not utilize raw water spacers. Instead, separation can be provided by the structure that holds the membranes in place, e.g., the supporting frame. Separation can also be provided by, e.g., a series of spaced expanded plastic media (e.g., spheres), corrugated woven plastic fibers, porous monoliths, nonwoven fibrous sheets, or the like. In addition, separation can be achieved by weaving the membrane unit or units through a series of supports. Similarly, the spacer can be fabricated from any suitable material. Suitable materials can include rigid polymers, ceramics, stainless steel, composites, polymer coated metal, and the like. As discussed above, spacers or other structures providing spacing are employed within the space between the two membrane surfaces where permeate is collected (e.g., permeate spacers), or between membrane surfaces exposed to raw water (e.g., raw water spacers).

Alternatively, one or more spiral-wound membrane units can be employed in a loosely rolled configuration wherein gravity or water currents can move higher density concentrate through the configuration and away from the membrane surfaces. The membrane elements can alternatively be arrayed in various other configurations (planar, spiral, curved, corrugated, etc.) which maximize surface exposure and minimize space requirements. In a preferred configuration, these elements are arrayed vertically, spaced slightly, and are submerged in the source water in the pressure vessel. The induced vessel pressure forces water through the membrane, and a gathering system collects the treated water and releases it to a location outside of the pressure vessel. If a spiral-wound configuration is employed, the membranes are preferably spaced farther apart than in a conventional reverse osmosis system, e.g., about 0.25 inches or more (about 6 millimeters or more), and the configuration is preferably in an “open” module (that is, configured to expose the membranes directly to the source water in the vessel and allow substantially uninhibited flow of source water past the membranes). Such a configuration facilitates the flow of feed water past the membranes, and especially facilitates the ability of gravity to draw down the higher density concentrate generated at the surface of the membrane by the filtration process. While an open configuration is typically preferred, in certain embodiments a configuration other than an open configuration can be desirable. Any suitable permeate collection configuration can be employed in the systems of preferred embodiments. For example, one configuration employs a central collector with membrane units or cartridges adjoining the collector from either side. Another configuration employs membrane units in concentric circles with radial collectors moving the potable water to the central collector. Still another configuration employs membrane units extending between collection tubes. In such a configuration, the collection tubes can be configured to support the membrane units, hold them spaced apart from one another, and collect permeate as well.

In preferred embodiments of the invention, a membrane module as described herein can be submerged in a pressure vessel and used to produce potable water from a non-potable supply. The permeate side of the membranes is kept at about atmospheric pressure by a port (not shown) placing the collection system in fluid communication with the atmosphere outside the pressure vessel, via a pipe, tube or other means of transmitting the product water through the side of the pressure vessel to a storage tank or distribution point. The membrane module(s) can include one or more cartridges, which can be configured to withstand the vessel pressure to which they will be exposed during operation, and which can comprise materials suitable for the particular application.

When the membrane module is submerged, pressurized source water in the pressure vessel flows substantially freely through the top, bottom, and rear of each cartridge. The pressure differential between the source water side of the membranes and the permeate side of the membranes causes permeate to flow to the low pressure (permeate) side of the membranes. Although the illustrated embodiments show a generally symmetrical configuration with cartridges on either side of a collection system, membrane modules can be configured in any other suitable configuration. One such configuration could be to cap the end of an individual cartridge and connect the membrane cartridges together with a series of collection pipes or tubes.

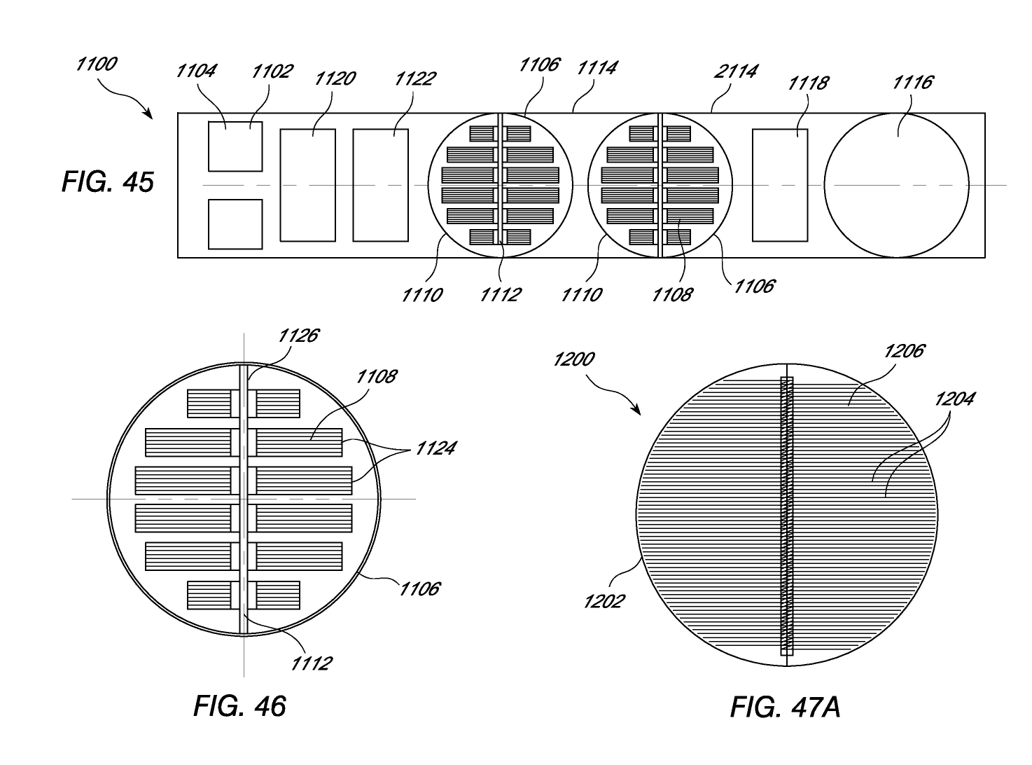

FIG. 45 shows an arrangement for a mobile treatment system 1100 according to a preferred embodiment of the invention. The system 1100 comprises a pumping system 1102 configured to extract water from a contaminated freshwater source 1104 and feed it to the treatment system at pressures ranging from about 20 psi to and 100 psi. The pressure used can vary depending on the particular membranes used, and can be about 20 psi, 30 psi, 40 psi, 50 psi, 60 psi, 70 psi, 80 psi, 90 psi, 100 psi, or in a range defined by any of these two numbers. The system 1100 also includes one or more pressure vessels 1106 having one or more membrane units 1108 disposed therein. The pressure vessels 1106 receive source water from the pump or pumps 1102 through one or more inlets 1110 and hold the water at pressure. The membrane units 1108 are disposed within the vessel 1106 such that the source water can flow substantially freely past the membranes. The membrane units 1108 have a permeate side configured to direct the flow of permeate into a collection system 1112. The collection system 1112 is in fluid communication with atmospheric pressure. The collection system 1112 can be placed in communication with atmospheric pressure in any suitable manner, such as, for example, piping transporting the water through the side of the pressure vessel 1106, a tube extending through the top of the pressure vessel 1106, or any other appropriate method. The collection system 1112 has an outlet 1114 through which permeate can travel out of the pressure vessel 1106. The outlet can also provide fluid communication to the atmospheric pressure outside the vessel 1106. The system 1100 can also include a storage tank 1116 configured to receive permeate from the collection system 1112 and store the permeate for later usage. Of course, in some embodiments, permeate can be supplied from the collection system 1112 to a separate storage unit, disposed outside of the system 1100.

In some embodiments, the system 1100 includes a disinfection system 1118, such as an ultraviolet light disinfection system, disposed downstream of the pressure vessels 1106. The system 1100 can also include one or more pump or pumps configured to pump permeate from the collection system 1112 to the disinfection system 1118, and/or from the disinfection system to the storage tank 1116. The system 1100 includes an electrical panel 1120 configured to control the pump or pumps 1102 and the disinfection system 1118 (if any). The system 1100 further includes a portable generator and fuel tank 1122 configured to supply power to the pumps 1102 and the disinfection system 1118 (if any). Optionally, the system 1100 can also employ some pretreatment methods, which may include coarse filters or the like, to protect pumps and membranes from damage due to large particles.

Embodiments of the invention can be mounted on a vehicle, such as a semi-truck, and transported to an area where treatment is needed. Embodiments can be rapidly deployed, used as required, and then moved to another area when desired. Systems configured in accordance with preferred embodiments offer ease of operation, with minimal pretreatment requirements (coarse filter only) and no process chemical requirements. Embodiments comprising tight nanofiltration membranes can be configured to provide an exceptional quality of product water.

FIG. 46 better illustrates a configuration of membrane units 1108 in the pressure vessel 1106. The membrane units 1108 are spaced apart in cartridges 1124 and mounted on either side of a central collection channel 1112. The cartridges 1124 are variously sized so as to maximize usage of space within the pressure vessel 1106. At least a portion of the collection channel 1112 is placed in communication with atmospheric pressure via a breathing tube or port 1126 extending from the channel to outside of the pressure vessel 1106, thereby allowing the vessel pressure to drive a filtration process across the membrane units 1108.

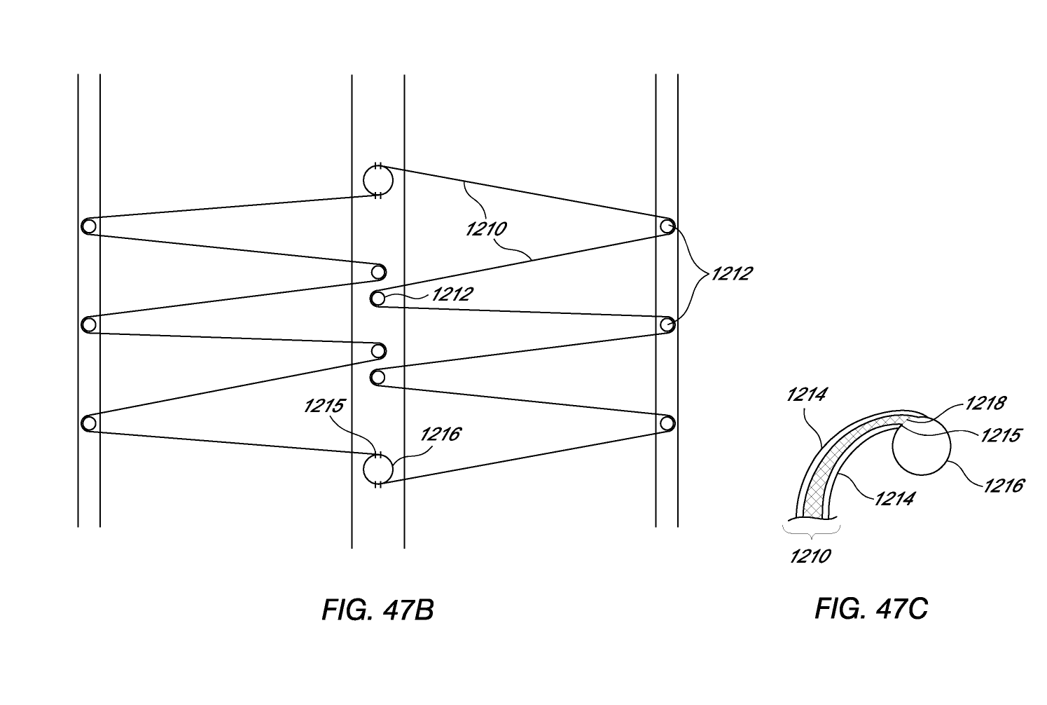

Of course, the membrane units and collection system can have any other suitable configuration consistent with their intended purpose. FIG. 47A, for example, illustrates a membrane system 1200 arranged inside a pressure vessel 1202. The membrane system 1200 includes one or more membrane units 1204 which are woven back and forth through a series of supports disposed around the perimeter of the vessel 1202 and/or along a center channel 1206. The membrane units 1204 are also connected at one or more points to one or more collection tubes, such that a permeate side of the membrane units 1204 is disposed in fluid communication with an interior of the collection tube or tubes. FIG. 47B illustrates (with exaggerated spacing) an example of membrane units 1210 which are woven around supports 1212 and connected at their ends to one or more collection tubes 1216. The supports 1212 and/or the collection tubes 1216 can be disposed in any suitable configuration. For example, the supports 1212 and/or the collection tubes 1216 can be disposed in a roughly perpendicular orientation to the orientation of the membrane units 1204. As better illustrated in FIG. 47C, the membrane unit 1210 has a source water side 1214 which is exposed to pressurized source water held in the vessel 1202. The membrane unit 1210 is also connected at one or more points to a perforation 1215 in one or more collection tubes 1216, such that a permeate side 1218 of the membrane unit 1210 is disposed in fluid communication with an interior of the collection tube 1216. Although not illustrated, in some embodiments, the collection tube or tubes 1216 can interconnect and flow into a central channel. In other embodiments, a network of collection tubes can comprise the collection system. The collection tubes and/or the collection system can be exposed to atmospheric pressure, for example via a port or breathing tube extending through the pressure vessel, such that the vessel pressure drives a filtration process across the membrane units and into the collection tubes.

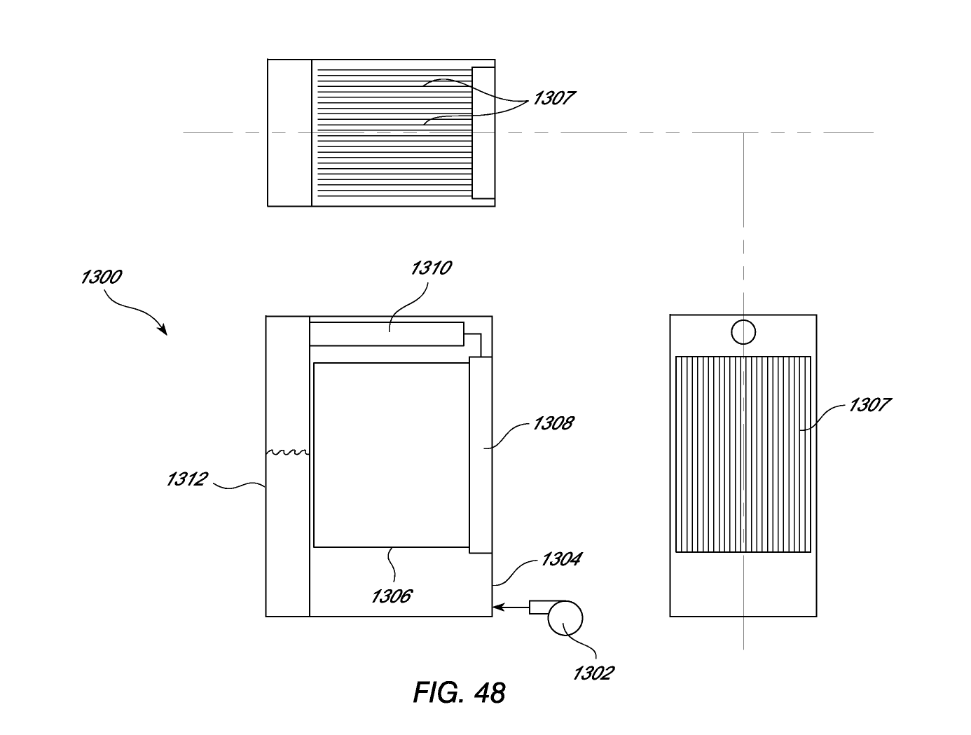

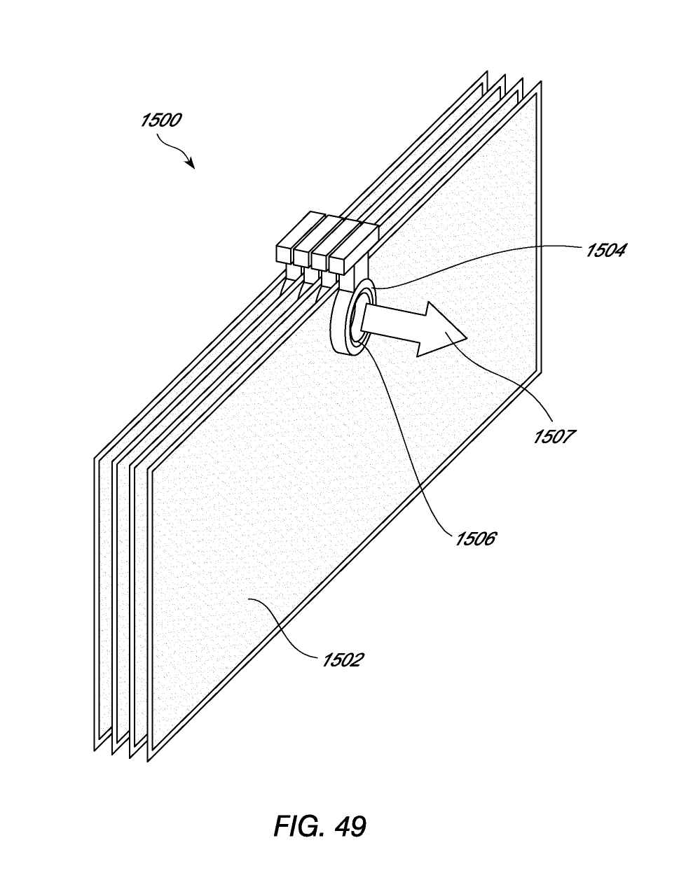

With reference now to FIG. 48, a smaller mobile filtration system 1300 according to another embodiment is illustrated. The system 1300 includes an external ump 1302 configured to provide source water, at pressure, into a container 1304. The container 1304 includes one or more membrane cartridges 1306 or membrane systems, including one or more membranes 1307 which are configured to produce permeate when exposed to the pressurized source water. The membrane cartridges 1306 are configured to direct the flow of permeate into a collection channel 1308 which is exposed to atmospheric pressure. The system 1300 can also include a disinfection system 310, such as an ultraviolet disinfection system, configured to disinfect product water collected in the collection channel 1308. The system 1300 can also include a product water storage unit 1312 disposed downstream of the collection channel 1308. Such a system can be configured at a very small scale if desired. For example, such a system can be configured for use in one or more standard 5-gallon cans or storage containers. Such a system can also be configured in smaller or larger sizes, and/or can be used in “under-the-sink” models.

### Sulfate Removal Applications

Removal of sulfate from seawater used in injection systems in offshore oil production facilities is desirable in many situations to prevent adverse reactions with calcium, barium, and strontium within the oil producing rock formations, which can result in scaling in the production equipment.

DEMWAX™ systems as described herein can be configured with nanofiltration membranes and adapted for use in conjunction with offshore oil and gas production facilities to efficiently produce low-sulfate seawater for use as injection water. Given the high molecular weight and charge of sulfate ions, nanofiltration membranes can provide an efficient, removal of sulfates without unnecessary removal of salt at a high energy cost. In some embodiments, the system can be operated at low flux and low recovery rates. In other embodiments, the system can be configured for higher flux rates to make the process more economically efficient for oilfield applications.

One advantage of using a DEMWAX™ membrane system to produce low-sulfate seawater for an offshore oil production facility is that the submerged system has little or no above-water footprint, thus freeing space on the platform deck. In addition, the system uses less energy, and is less maintenance intensive than existing sulfate-removal systems. Embodiments adapted for use with oil and gas production platforms can be configured to utilize the platform's superstructure to provide anchoring, structural support, power, and/or venting for the systems. For example, in embodiments of the invention, the system can be suspended at depth from the platform itself and/or tethered (or otherwise attached) to the platform's moorings. In some embodiments, the system can be configured such that the underwater platform superstructure provides support for the submerged DEMWAX™ modules or cartridges. In some embodiments, the treated water can be transported from a permeate collection channel up to the platform. In other embodiments, the permeate collection channel can be directly coupled to the injection piping, avoiding headloss and limiting piping requirements. In some embodiments, the system can be powered by the platform's existing electrical generation facility.

In systems of preferred embodiments, one or more tight NF membranes or specialty NF membranes, such as a FILMTEC™ SR90 membrane manufactured by Dow Chemical Corporation, are deployed in one or more submersible cartridges or modules and configured to produce low-sulfate seawater suitable for use as injection water. The system can be submerged at any suitable depth for the particular application. As an example, depending on the flux requirements of the particular application, such systems can achieve sulfate removal of between about 97 and 99 percent at depths ranging from about 650 to about 900 feet.

Alternative embodiments employ a dual-pass system, with looser NF membranes providing the first pass filtration step. In such an embodiment, the second pass of the system can comprise one or more standard spiral-wound NF cartridges in pressure vessels. The pressure vessels can be located on the oil platform, or can be coupled to the DEMWAX™ system at depth. A DEMWAX™ product water pump can be configured to supply sufficient pressure to the vessel for the second-pass process. The concentrate can be expelled from the vessel into the surrounding seawater through a pressure relief valve. The product water can be pumped to the platform or directly to the well injection piping. As an example, depending on the flux requirements of the particular application, such systems can achieve sulfate removal of between about 95 and 99 percent at depths ranging from about 100 to about 400 feet. One advantage of a two stage system is that it involves the removal of less salt and, thus, requires a lesser expenditure of energy in the removal of the sulfate. Further, embodiments in which the second-pass pressure vessels are submerged at depth along with the first-pass modules offer the additional advantage of having little or no footprint on the platform.

Some embodiments can also include a seawater reverse-osmosis system configured to produce process water for other systems on the platform, or potable water for the oil rig crew, is desired.

Apparatus and methods suitable for use in connection with the systems of preferred embodiments are described in the following references, each of which is incorporated by reference herein in its entirety: Pacenti et al., “Submarine seawater reverse osmosis desalination system”, Desalination 126 (1999) 213-218; U.S. Pat. No. 5,229,005; U.S. Pat. No. 3,060,119; Colombo et al., “An energy-efficient submarine desalination plant”, Desalination 122 (1999) 171-176; U.S. Pat. No. 6,656,352; U.S. Pat. No. 5,366,635; U.S. Pat. No. 4,770,775; U.S. Pat. No. 3,456,802; and U.S. Patent Publication No. US-2004-0108272-A1.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A water treatment and conveyance system comprising:
a plurality of substantially planar membrane elements, each membrane element extending generally in a first direction, the plurality of membrane elements generally aligned in a second direction normal to the first direction, each membrane element having a source water side and a permeate side, the source water side configured to be submerged to a depth in a body of water to be treated and exposed to a hydrostatic pressure characteristic of the body of water at the submerged depth, the permeate side configured to be exposed to atmospheric pressure when the source water side is submerged;
a plurality of element spacers, the element spacers being generally aligned with one another, each element spacer configured to maintain a spacing between a pair of adjacent membrane elements, each element spacer having a first opening in fluid communication with the permeate sides of the adjacent membrane elements, wherein the plurality of element spacers defines a permeate conduit; and
a plurality of sealing members, each sealing member configured to seal the first openings of the element spacers from the source water sides of the adjacent membrane elements.

2. The system of claim 1, wherein each membrane element comprises a pair of substantially planar membranes and a permeate spacer disposed between the membranes.

3. The system of claim 1, wherein the permeate conduit extends generally in the second direction.

4. The system of claim 1, wherein the permeate conduit extends through the plurality of membrane elements.

5. The system of claim 1, wherein the permeate conduit is spaced apart from the plurality of membrane elements.

6. The system of claim 1, further comprising a compression member configured to maintain the sealing members in a compressed state.

7. The system of claim 6, wherein the compression member comprises at least one rod extending in the second direction.

8. The system of claim 7, wherein the rod extends through the plurality of element spacers.

9. The system of claim 7, wherein the rod is spaced apart from the permeate conduit.

10. The system of claim 6, wherein the compression member comprises an epoxy.

11. The system of claim 1, further comprising a collection tube extending through the permeate conduit, wherein the collection tube is configured to receive and convey permeate.

12. The system of claim 11, wherein the collection tube comprises a plurality of openings configured to receive permeate from the permeate conduit.

13. The system of claim 12, wherein the openings are slits.

14. The system of claim 12, wherein the openings are holes.

15. The system of claim 11, wherein the collection tube is configured to apply a compressive force to the plurality of element spacers.

16. The system of claim 11, wherein the collection tube has at least one threaded region.

17. The system of claim 16, further comprising a nut configured to cooperate with the threaded region of the collection tube to apply a compressive force to the plurality of element spacers.

18. The system of claim 1, wherein each of the element spacers includes at least one abutment configured to maintain a minimal spacing from an adjacent element spacer.

19. A water treatment system comprising:
means for filtering source water to produce product water, the filtering means having a source water side and a product water side, the filtering means comprising a series of substantially planar membrane elements arranged in parallel;
means for maintaining a spacing between adjacent membrane elements, wherein at least a first portion of the spacing means is configured for exposure to the source water side, and wherein at least a second portion of the spacing means is configured for exposure to the product water side; and
means for conveying product water, the conveying means extending through the filtering means in a direction normal to the membrane elements.

20. The water treatment system of claim 19, wherein the spacing means defines the conveying means.

21. A method of treating and conveying water, the method comprising:
providing the water treatment and conveyance system of claim 1;
submerging the water treatment and conveyance system in the body of water to the submerged depth; and
conveying permeate through the permeate conduit.

22. A method of manufacturing the water treatment and conveyance system of claim 1, the method comprising:
providing a first membrane element;
positioning a first element spacer on the first membrane element with the first opening of the first element spacer in fluid communication with the permeate side of the first membrane element;
positioning a second membrane element on the first element spacer in general alignment with the first membrane element, with the first opening of the first element spacer in fluid communication with the permeate side of the second membrane element; and
positioning a second element spacer on the second membrane element in general alignment with the first element spacer, with the first opening of the second element spacer in fluid communication with the permeate side of the second membrane element.

23. A method for producing product water from a sulfate-containing body of water, the method comprising:
submerging a first membrane module to a submerged depth in a sulfate-containing body of water, the first membrane module comprising a plurality of substantially planar polyamide nanofiltration membrane elements, each membrane element extending generally vertically and having a first side and a second side, the first sides of two adjacent membrane elements being sufficiently spaced apart to prevent surface tension from inhibiting substantially free flow of feed water between the elements, the second sides being in fluid communication with a collector, wherein the first sides are exposed to the source water at a first pressure characteristic of the submerged depth;
exposing the collector to a second pressure, wherein the second pressure is sufficient to induce permeate to cross from the first side to the second side without requiring a mechanical device to influence the first pressure; and
collecting permeate of a reduced sulfate concentration in the collector.

24. The method of claim 23, wherein the second pressure is characteristic of atmospheric pressure at a surface of the body of water or at an elevation higher than the surface of the body of water.

25. The method of claim 23, wherein each membrane element comprises a pair of substantially planar polyamide nanofiltration membranes spaced apart by a permeate spacer.

26. The method of claim 23, wherein the first membrane module is configured to be submerged to a depth of from about 100 feet to about 400 feet.

27. The method of claim 23, wherein the first membrane module is configured to be submerged to a depth of from about 650 feet to about 900 feet.

28. The method of claim 23, further comprising passing the permeate of a reduced sulfate concentration through a second membrane module, the second membrane module comprising at least one nanofiltration membrane module.

29. The method of claim 23, further comprising passing the permeate of a reduced sulfate concentration through a second membrane module, the second membrane module comprising at least one reverse osmosis membrane module.

30. The method of claim 23, wherein the body of water is a body of saltwater.

31. The method of claim 23, wherein the body of water is a body of brackish water.

32. The method of claim 23, further comprising conveying the permeate of a reduced sulfate concentration to an injection system of an offshore oil production system.

33. A mobile filtration system comprising:
a pressure vessel for holding water to be treated;
a plurality of substantially planar and generally parallel membrane units disposed inside the pressure vessel, each membrane unit having a raw water side and a permeate side, the membrane units being spaced apart from one another by a distance sufficient to allow substantially free flow of water between the membrane units, wherein the permeate side is configured for exposure to atmospheric pressure, and wherein the raw water side is configured for exposure to a vessel pressure sufficient to drive a filtration process from the raw water side to the permeate side.

34. The mobile filtration system of claim 33, wherein the vessel pressure is from about 20 psi to about 100 psi.
